(19) United States
(12) Patent Application Publication
(10) Pub. No.: US 2025/0113415 A1
(43) Pub. Date: Apr. 3, 2025

(54) INTELLIGENT COOKING SYSTEM WITH ACOUSTIC SENSING

(71) Applicant: One Hearth, Inc., Sunnyvale, CA (US)

(72) Inventors: Gregory Russ Goddard, Kenmore, WA (US); Peng Chau Quah, Kirkland, WA (US); Michael Hanuschik, Sunnyvale, CA (US)

(21) Appl. No.: 18/900,055

(22) Filed: Sep. 27, 2024

Related U.S. Application Data
(63) Continuation-in-part of application No. 18/640,998, filed on Apr. 19, 2024, now Pat. No. 12,193,120.
(60) Provisional application No. 63/541,619, filed on Sep. 29, 2023.
(60) Provisional application No. 63/604,771, filed on Nov. 30, 2023.

(51) Int. Cl. H05B 6/12; A47J 36/32; G01H 13/00

(52) U.S. Cl. CPC H05B 6/1209; A47J 36/32; G01H 13/00; H05B 2213/05

(57) ABSTRACT

Cookware identification includes exciting a cooking vessel using an excitation component. It further includes sensing an acoustic response of the cooking vessel to the excitation using a sensor. It further includes determining a type of the cooking vessel based at least in part on the acoustic response of the cooking vessel to the excitation that is sensed via the sensor.

Ingredient state detection includes sensing, using an acoustic sensor, vibrations pertaining to cooking of an ingredient in a cooking vessel. It further includes monitoring, over time, a signal that is based on the vibrations sensed by the acoustic sensor. It further includes, based on detecting a change in the signal that is based on the vibrations sensed by the acoustic sensor, determining a state of the ingredient.

### CROSS REFERENCE TO OTHER APPLICATIONS

This application claims priority to U.S. Provisional Patent Application No. 63/541,619 entitled INTELLIGENT INDUCTION COOKING SYSTEM filed Sep. 29, 2023 which is incorporated herein by reference for all purposes; and claims priority to U.S. Provisional Patent Application No. 63/604,771 entitled SENSING SYSTEM FOR COOKWARE AND COOKWARE CONTENT filed Nov. 30, 2023 which is incorporated herein by reference for all purposes.

This application is a continuation in part of U.S. patent application Ser. No. 18/640,998 entitled UNIVERSAL APPLIANCE INTERFACE filed Apr. 19, 2024, which is incorporated herein by reference for all purposes.

### BACKGROUND OF THE INVENTION

Cooking is a complex process that involves a large number of variables and dependencies to consider and keep track of in order to achieve a desired cooking result. Thus, it can be challenging to have insight into, and control of, the cooking process.

### BRIEF DESCRIPTION OF THE DRAWINGS

Various embodiments of the invention are disclosed in the following detailed description and the accompanying drawings.

FIG. 1 illustrates an embodiment of an induction cooking device.

FIG. 2 illustrates an embodiment of an induction cooking system.

FIG. 3 illustrates an embodiment of an induction cooking system control architecture.

FIG. 4A illustrates an embodiment of a weighing scale.

FIG. 4B illustrates an embodiment of a weighing scale.

FIG. 5 illustrates an embodiment of a temperature sensor.

FIG. 6A illustrates an embodiment of a light ring.

FIG. 6B illustrates a cutaway view of a light ring.

FIG. 6C illustrates a cutaway view of a portion of a light ring.

FIG. 7A illustrates an embodiment of a user interface element.

FIG. 7B illustrates embodiments of a cooking system in left and right-hand configurations.

FIG. 7C illustrates an embodiment of a removable dial.

FIGS. 7D and 7E illustrate examples of connection shapes for a removable smart dial.

FIG. 8A illustrates an embodiment of a smart dial display.

FIG. 8B illustrates an embodiment of a timer function.

FIG. 8C illustrates an embodiment of a probe temperature function.

FIG. 9 is a flow diagram illustrating an embodiment of a process for cooking system parameter adaptation based on recognized cookware.

FIG. 10 illustrates an embodiment of a weighing scale function.

FIG. 11A illustrates an embodiment of cooking technique selection.

FIG. 11B illustrates an embodiment of contextual technique guidance and doneness selection user interfaces adapted for a waffle iron.

FIG. 11C illustrates an embodiment of contextual technique guidance and doneness selection user interfaces adapted for an egg cooker.

FIG. 11D illustrates an embodiment of a contextual user interface for pan maintenance guidance adapted for a carbon steel pan.

FIG. 12 illustrates an embodiment of a multi-function cooker with a smart lid.

FIG. 13 illustrates an embodiment of a system for cooking system adaptation based on recognized cookware.

FIG. 14A illustrates an embodiment of available cooking techniques for a non-stick pan.

FIG. 14B illustrates an embodiment of available cooking techniques for a multi-cooker.

FIG. 14C illustrates an embodiment of a rice cooking menu.

FIG. 14D illustrates an embodiment of a default cooking technique menu configuration profile for non-registered cookware.

FIG. 15A illustrates an embodiment of insights determined from input sensor data.

FIG. 15B illustrates examples of cooking insights derived from user interface measurements.

FIG. 15C illustrates embodiments of cooking insights derived from measurements collected by an external device.

FIG. 16 is a flow diagram illustrating an embodiment of a process for providing a contextual cooking user interface.

FIGS. 17A and 17B illustrate embodiments of cookware temperature behavior.

FIG. 18 illustrates an embodiment of an adaptive closed-loop temperature control system.

FIG. 19 illustrates examples of control loop parameters customized for different types of cookware.

FIG. 20 illustrates an embodiment of a process for temperature control based on cookware recognition.

FIG. 21 illustrates an embodiment of acoustic sensing in an intelligent cooking system.

FIG. 22A illustrates an embodiment of an intelligent cooking system with contact acoustic sensors.

FIGS. 22B and 22C illustrate embodiments of a contact sensor assembly.

FIG. 22D illustrates an embodiment of a contact sensor.

FIG. 22E illustrates embodiments of contact sensors.

FIG. 22F illustrates embodiments of contact sensors.

FIG. 22G illustrates embodiments of contact sensors.

FIG. 22H illustrates embodiments of contact sensors.

FIG. 22I illustrates embodiments of contact sensors.

FIG. 23 illustrates an embodiment of acoustic sensing using contact transducers and microphones.

FIG. 24 illustrates an embodiment of an acoustic sensing system.

FIG. 25 illustrates an embodiment of cookware with features to facilitate cookware signatures.

FIG. 26A illustrates an embodiment of patterns of frequency response for different cooking vessels with coil excitation and piezoelectric listening.

FIG. 26B illustrates an embodiment of patterns of frequency response using contact acoustics.

FIG. 27 illustrates an embodiment of cooking vessel discrimination based on frequency response.

FIG. 28 is a flow diagram illustrating an embodiment of a process for acoustic sensing-based cookware identification.

FIG. 29A illustrates an embodiment of passive sound sensing of the state of food being cooked in a cooking vessel.

FIG. 29B illustrates an embodiment of passive sound sensing of the state of food being cooked in a cooking vessel.

FIGS. 30A and 30B illustrate an embodiment of acoustics-based detecting of states of frying an egg.

FIGS. 31A and 31B illustrate an embodiment of acoustics-based detecting of states of pan-frying chicken.

FIGS. 32A and 32B illustrate an embodiment of acoustics-based detecting of states of pan-frying tofu.

FIGS. 33A and 33B illustrate an embodiment of acoustics-based detecting of states of pan-frying onions.

FIG. 34 illustrates an embodiment of detecting different stages of boiling via acoustic sensing.

FIG. 35 is a flow diagram illustrating an embodiment of acoustically sensing ingredient state.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The following are embodiments of an intelligent induction cooking system. Embodiments of the intelligent induction cooking system described herein provide an integrated cooking system that integrates induction heating, detection of cookware, sensor measurements, app control, etc. to optimize the cooking experience. For example, compared to existing cooking systems, embodiments of the integrated induction cooking system described herein provide an improved cooking user experience by integrating cookware detection to determine dynamic, contextual user interfaces (UIs) to provide users information and prompts (e.g., what type of cooking techniques are available, available results of the food being cooked, etc.) that adapt to the type of cookware being used. This includes generating user interfaces customized for the type of cookware that is detected as being present. As another example, the integrated system, by integrating cookware detection with various sensor measurements and induction coil control, provides closed loop temperature control that both accurately and efficiently modulates power delivery from the induction coil to the cookware to provide predictable and repeatable cooking results and user experiences.

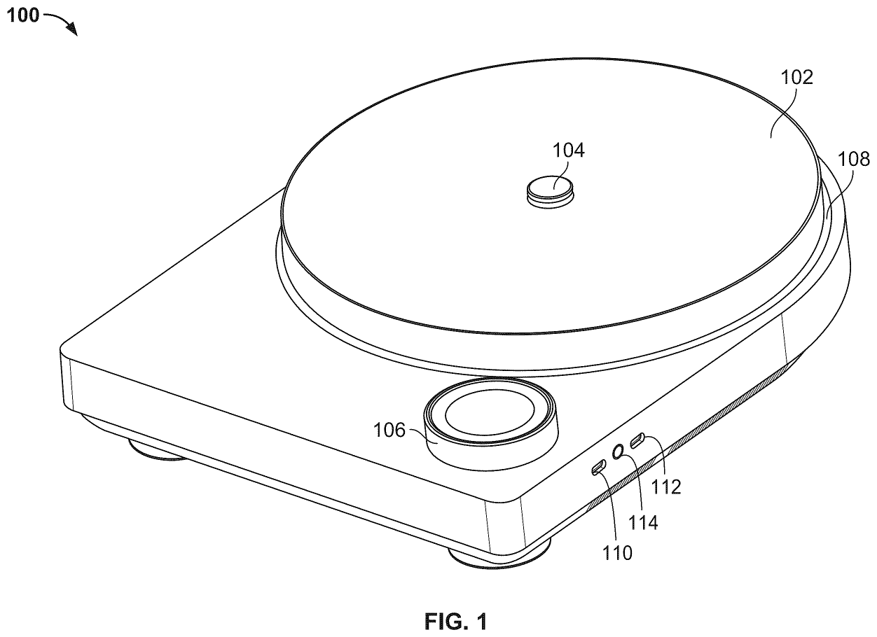

FIG. 1 illustrates an embodiment of an induction cooking device. In some embodiments, induction cooking system 100 includes one or more induction coils. In some embodiments, the induction cooking device includes multiple rings of coils with independent control. While embodiments involving an induction cooktop system are shown and described herein for illustrative purposes, the induction system described herein can also take other forms, such as a built-in induction cooking system.

In this example, the induction coils are located under top plate 102. As one example, the top plate is made of a material such as glass ceramic. Cookware, when being used, is placed on top plate 102. In some embodiments, the system includes cookware alignment, centering, or securing features (e.g., dimples, rings, etc.). Examples of such alignment, centering, and securing features include recesses in the top plate to accept protruding dimples on the bottom of cookware, a protruding ring on cookware that slots into a corresponding recessed ring in the top plate, a combination of rings/dimples/recesses, dimples with electrical connections, dimples/rings with electrical and/or magnetic connections, etc.

In some embodiments, induction cooking device 100 further includes multiple sensors, such as integrated or onboard sensors. Examples of sensors include temperature sensors and weight sensors. In this example, a temperature probe or sensor protruding from the center of the top plate is shown at 104. Further embodiments and details regarding sensors are described below. In some embodiments, the system includes an integrated accurate weighing scale. As one example, the weighing scale is integrated with the top plate of the system. Further details regarding temperature and weighing sensors are described below.

In some embodiments, induction cooking device 100 includes a variety of interfaces, such as those to provide or receive information. As one example, the induction cooking device includes dial 106. In this example, the dial is an example of a physical interface by which a user can control the operation of the cooking device. While an example of a dial is described herein for illustrative purposes, the cooking system can be adapted to accommodate other types of user controls, such as sliders, knobs, etc.

In some embodiments, the dial includes a screen via which information pertaining to cooking is presented, and via which user inputs can also be received. In some embodiments, the dial includes various mechanisms and controls via which the user can make selections to control the operation of the cooking device. As one example, the screen of the dial is a touchscreen (e.g., capacitive touchscreen). In some embodiments, the dial includes a rotational ring, which a user can rotate to adjust their selection of an item presented in the user interface (displayed in the screen of the dial). In some embodiments the dial can be pushed down to make a selection.

In some embodiments, the dial is an intelligent dial that is used as a main or primary control element of the induction cooking system. For example, as described above, input is provided via rotating the ring, pressing down on the dial, touching on the touch screen display, etc. In other embodiments, the system is also controllable via voice commands with voice feedback through an integrated microphone and speaker.

Further details regarding the physical design of the dial are described below. As will be described in further detail below, in some embodiments, the user interface provided via the display of the dial is a contextual user interface that adapts to various contexts. For example, the user interfaces displayed via the dial are adapted to the type of cookware that is being detected as being utilized. In this way, a universal interface is provided in which the user interface automatically adapts to what cookware is being utilized (rather than requiring each different type of cookware to have its own interface). This allows the system to be used to replace multiple standalone kitchen and cooking appliances (e.g., slow cooker, instant pot, rice cooker, etc.). Further details regarding embodiments of such a contextual user interface are described below.

In the example of FIG. 1, the induction cooking device further includes a light ring 108. For example, the light ring is a ring of lights (e.g., LED (light-emitting diode) ring) that is used to produce light of various color and intensity. As one example, the color and intensity of the light is controlled to visually present an indication of temperature (e.g., of the cookware). As another example, the color and intensity of the light produced by the light ring is controlled to emulate a look and feel of a radiant heating source such as a flame of a gas stove. For example, having the light ring on generates a glowing effect with reflection on cookware that is on the cooking system.

Other example interfaces shown in FIG. 1 include various ports, such as USB-C ports 110 and 112, as well as a 3.5 mm audio jack 114. The device may include any other number of ports or interfaces as appropriate. In some embodiments, the system includes built in or integrated speakers and microphones. In some embodiments, microphones of the system are also usable as acoustic sensors.

The following are embodiments of a housing for the induction cooking system described herein. In some embodiments, the housing is designed for service and refurbishment (and is robust for disassembly). In some embodiments, the housing is recyclable. In some embodiments, the housing is made from a single material. In some embodiments, the housing and overall dimensions of the system are compact, stable, and are designed for desirable acoustic properties, such as when used in conjunction with fans (e.g., internal cooling fans, further details of which are described below).

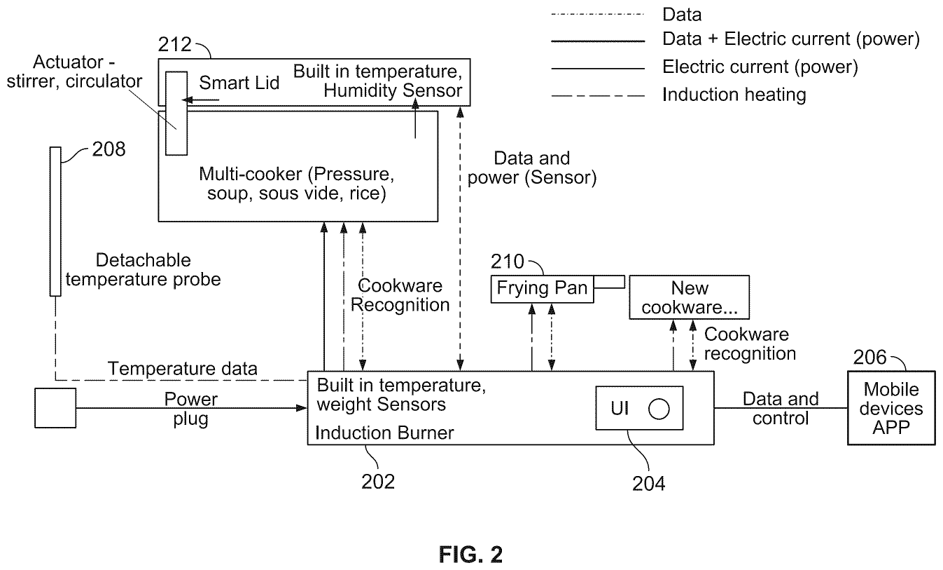

FIG. 2 illustrates an embodiment of an induction cooking system. In this example, induction burner 202 is a system diagram of an induction cooking device such as induction cooking device 100. As shown in this example, the cooking system is an integrated cooking system that includes induction burner(s), sensors, external control (e.g., via a mobile app), etc.

In this example, the induction burner 202 includes user interface (204), such as that provided by dial 106 of device 100 of FIG. 1.

As shown in this example, induction burner system 202 further supports various types of connectivity/communications interfaces, such as Wi-Fi, Bluetooth, etc. Hardware for such wireless connectivity may be upgradeable. As another example, the device includes a hardwire network connection, such as Ethernet. In this example, the induction system 202 further supports connectivity with an external application or device, such as an app installed on a mobile device 206. The connectivity between the induction burner system 202 and the mobile device 206 can be both wireless and/or wired, such as over Wi-Fi, via a direct connection such as Bluetooth, over a wired connection such as USB-C, etc.

In various embodiments, the system connects with the mobile app installed on the mobile device (e.g., smartphone) to expand control options and automation, including OTA (over-the-air) updates, recipe download, additional customization and control, changing burner settings, registering new third-party cookware, etc.

In some embodiments, the mobile app is a ChatGPT (or any other chatbot, as appropriate) powered app. In some embodiments, the mobile app is configured to, in conjunction with the mobile device hardware and capabilities, perform remote monitoring and control of the induction cooking system. The mobile app is configured to provide guided recipes. The mobile app is also configured to record recipes. In some embodiments, users are able to browse feeds via the mobile app.

In some embodiments, the mobile app facilitates user input. In some embodiments, the mobile app accesses or interfaces with hardware capabilities and functionality of the hardware device on which it is running, such as cameras, speakers, microphones, etc.

In some embodiments, a mobile app is installed on a mobile device such as a smartphone, where the mobile app is configured to utilize sensors such as cameras of the mobile device. In some embodiments, a stand is utilized in conjunction with the cooking system to facilitate positioning of the mobile device. In various embodiments, the mobile app, using hardware (e.g., camera, speaker, microphone, etc.) of the mobile device, as well as artificial intelligence, facilitates:
guided recipe assistance (to understand where the user is in the cooking process and guide them along)
recipe recording
automated recipe creation
determining when cooking of ingredients is complete (e.g., pancakes, steak, grilled cheese, boiling water, etc.)
seasoning of the pan
safety issue detection (e.g., smoke, flame, etc.)

In this example, the induction burner includes various built-in temperature and weight sensors. For example, the induction cooking system includes multiple temperature sensors to measure the temperature of the cookware being utilized (e.g., to measure cookware surface temperature). In some embodiments, the induction burner system 202 further supports connection to other sensors, such as detachable temperature probe 208 (which can be plugged in via the USB-C connections described above). One example of such a detachable/attachable temperature probe is a meat probe. In some embodiments, the induction cooking system includes integrated weight sensors, which can be used to measure the weight of cookware, changes in weight (e.g., due to addition/removal of food content in the cookware), etc. Further embodiments regarding weight sensors are described below. Another example of a sensor is an air pressure sensor, which can be used to detect the state (e.g., doneness) of ingredients being cooked.

In the example of FIG. 2, use of the induction cooking system with various different types of cookware is shown. For example, the induction cooking system is able to accommodate different types of cookware such as frying pan 210, multi-cooker 212, as well as other types of cookware. In this example, multi-cooker 212 includes an intelligent lid with built in temperature and humidity sensors. The multi-cooker also includes components such as an actuator-stirrer, circulator, etc. The multi-cooker may be used to perform multiple cooking techniques or cooking functions, such as pressure cooking, soup making, sous-vide, rice cooking, etc.

In some embodiments, the induction cooking system is configured to perform cookware recognition to detect a type of cookware being utilized. Further embodiments regarding cookware recognition are described below.

In some embodiments, user interface 204 is adapted based on the detected type of cookware. For example, the information that is presented, the options that are available to a user for selection, etc. are configured based on the context of what type of cookware has been detected as being in use. Further embodiments of adaptive user interfaces based on detected types of cookware are described below.

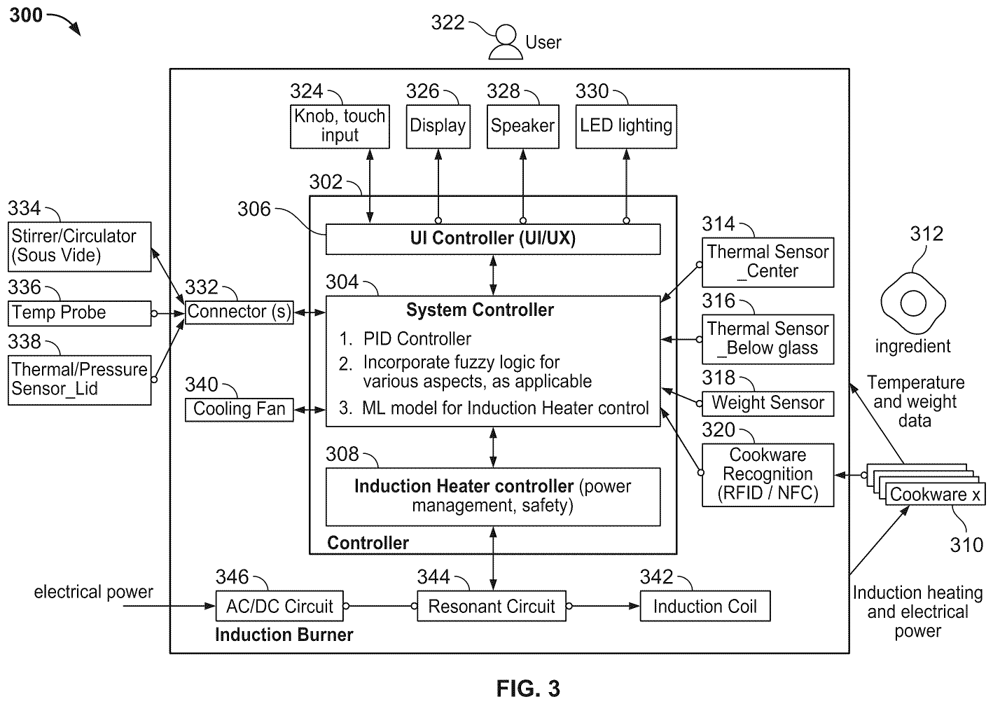

FIG. 3 illustrates an embodiment of an induction cooking system control architecture. In some embodiments, architecture 300 is an example of a control architecture for controlling the components of induction cooking system 202 and induction cooking device 100.

As shown in this example, the control architecture 300 includes controller 302. In this example, controller 302 further includes system controller 304, UI/UX controller 306, and induction heater controller 308.

In some embodiments, system controller 304 is configured to receive information from various components and interfaces and provide various commands to control hardware associated with the induction cooking system.

As one example, the system controller receives information and measurements from various sensors pertaining to the cookware (310) and ingredients (312) in the cookware, such as temperature and weight measurement data from temperature sensors, weight sensors, cookware detection sensors, etc. Examples of integrated temperature sensors include a thermal sensor 314 in the center of the top plate, such as temperature sensor 104. Another example sensor that the system controller receives temperature measurements from is one or more thermal sensors 316 that are below the top plate. The system also receives weight information from weight sensor 318. In some embodiments, measurements usable for cookware detection are received from cookware recognition sensors 320. Examples of such cookware recognition data include RFID (Radio Frequency Identification) data, NFC (Near Field Communication), etc. Cookware recognition can also be performed via signature identification using sensors of the system described herein. Further details regarding cookware recognition are described below.

In some embodiments, system controller 304 is configured to receive information from, and provide commands to UI (user interface)/UX (user experience) controller 306. For example, UI controller 306 is configured to receive information from, and/or provide information to various user interfaces via which user 322 interacts, such as a knob or touch input 324 (e.g., knob or touch screen of dial 106), display 326 (e.g., of dial 106), audio speaker 328, and lighting ring 330 (e.g., lighting ring 108).

In some embodiments, in addition to speaker(s) 328, the system also includes one or more microphones. In some embodiments, the microphones are used to facilitate voice control and voice command as an input. In some embodiments, the system responds with voice/audio feedback (e.g., via speakers integrated into the system, or via an external device such as a speaker or mobile device).

In some embodiments, the system/induction stove is turned on by turning the dial or pressing on the dial, with visual (e.g., light ring) and audio (e.g., sound from the system, including cooling fan) feedback next to the active display of the intelligent dial to show various information such as the heat/temperature/power setting selected by the user. The system can be turned on whether or not cookware is in the presence of the system (e.g., on the top plate). This is similar to user experience of a gas stove, where the user can always turn on the stove before or after placing the cookware.

In this example, the system controller further receives information from, and/or controls, components connected to the device (e.g., via connectors 332 such as USB-C connections, or as part of an integrated multi-cooker that is controllable by the system, or any other type of port, as appropriate). Examples of such connected components include stirrer/circulator 334 (e.g., used when performing sous vide), external temperature probe 336, external thermal/pressure sensor 338 (which, as one example, is part of a sensor of a multi-function cookware that is being utilized in conjunction with the induction cooking system). In some embodiments, power to a cookware device is provided via the induction coils, and/or a power connection such as USB-C. For example, a multi-cooker can be connected to and powered by the system. The cooking system also has control over the components of the multi-cooker.

In this example, the system controller is also configured to control cooling fan 340. This includes receiving fan information (e.g., fan speed), as well as providing controls (e.g., to adjust fan speed). In some embodiments, the system includes one or more fans to provide internal cooling. For example, fan 340 is a compact fan (e.g., laptop fan) that can be adjusted to perform various types of sound adjustment, such as noise cancelling, creation of desirable acoustics, etc. For example, the fan can be controlled by the system controller to suppress certain acoustic frequencies, as well as enhance certain frequencies to create an appropriate sound level and quality. In some embodiments, the system uses the noise level of the fan (e.g., as measured by a microphone integrated in the system) as acoustic feedback on the power level of the system. The system may include multiple fans, such as fans for cooling the power supply, fans for cooling the induction coil 342, etc.

The following are further embodiments of noise cancelling (e.g., cancelling of fan and all other sources of noise in the system). For example, as described above, certain acoustic frequencies can be suppressed or enhanced to create the appropriate sound level and quality. In some embodiments, the noise level is used as acoustic feedback on power level. Multiple fans may be used for cooling, where noise cancelling may be implemented on the fans to create desired sounds. As another example, the fan can be controlled to optimize the sound that is generated to emulate the sound of cooking with a gas stove. As one example, the sound of cooking with gas is characterized (e.g., as (1) Brown noise-spectral density drops 6 dB per octave, and (2) Gray noise-white noise (all frequencies randomly) convolved with A-weighting of human car perception). The electronic noise and harmonics of the induction system are characterized. The system performs optimization (e.g., component selection, control algorithm changes, air flow optimization of the cooling fan) in order for the sound being generated by the induction cooking system (e.g., as characterized by amplitudes as a function of frequency) to emulate the profile of a gas stove (e.g., to emulate higher pitch “whistling” sounds in typical gas stoves).

In this example, system controller 304 interacts with induction heater controller 308. Induction heater controller 308 is configured to perform power management pertaining to the induction coil 342. In some embodiments, the induction coil is controlled by the induction heater controller via control commands issued by system controller 304. For example, system controller 304 is configured with logic to determine how and when to adjust the power delivered to the induction coil, such as to control the temperature of the cookware (as monitored, for example, by the various sensors of the system). For example, the system controller includes a PID (proportional-integral-derivative) controller. The PID controller is used to control the resonant circuit 344, which in turn controls the induction coil.

The following are further embodiments of heating control. As one example, the heating control is implemented by system controller 304. For example, as described above, system controller 304 is configured to collect various sensor measurements, such as temperature, weight, induction power being delivered, etc. The system controller then processes the information and uses it (e.g., as feedback) to determine how to control the cooking process.

The following is an example of heating control. In some embodiments, the system measures temperature of the cookware, including rate of change of temperature. In some embodiments, the system measures weight of the cookware, including changes and rate of change (e.g., due to liquids evaporating, the addition of ingredients, etc.). Examples of weight sensors include load cells and strain gauges, which may be placed below the top plate or under the appliance. In some embodiments, the system measures the level of induction power being delivered to the cookware, including the rate of change in power. In some embodiments, measurement of temperature of ingredients is performed with a probe (e.g., probe 208).

In some embodiments, based on all the input and output information, the system predicts the state (e.g., temperature, pressure, moisture, doneness, crispness, etc.) of the ingredients in the cookware. For example, a closed-loop control algorithm takes into account all the sensor data input, user input, derived cookware or foodstuffs state, etc., modulates the power delivery to the cookware, and delivers predictable and repeatable cooking results and user experience.

The following are further embodiments of heating control. In some embodiments, the intelligent cooking system includes a control system to perform automated cooking routines or functions with different combinations of cookware and accessories, such as the following:
Frying Pan (regular or non-stick): Assisted pan cooking (searing, frying, sauté)
Multi-cooker (pot): Pressure cooking, Rice cooking, Sous vide, yogurt making, braising, slow cooking, etc.
Ceramic/clay pot: rice cooking, slow cooking
Waffle pan: waffle making
Kettle: water boiling, including temperature control
Carbon Steel pan:
   automated pan maintenance guidance (e.g., remind user to “wipe out the pan”, “dry the pan and lightly oil before storage”, etc.)
   automated seasoning program (e.g., the system prompts the user to oil the pan accordingly, and then heat up the pan to seasoning temperature, hold, and turn off automatically)
   safety detection and warping prevention to ensure limiting of the heating rate and temperature set point when the pan is empty or left unattended, to protect the pan from being damaged and overheating.

The following are further embodiments and features of the intelligent cooking system and heating control. As one example, suppose that a user chooses a cooking technique of searing. In this example, the system heats the pan up to 425° F. (218° C.) and holds, prompts the user to add oil, and prompts the user again to add the protein (steak, pork, etc.). With the weight input and temperature drops (due to adding of an ingredient), the system estimates the time required, and prompts the user to flip the protein.

As another example, when a user uses a non-stick pan, the system limits the maximum permitted temperature as a safety measure to prevent disintegration of the non-stick coating.

The following are further embodiments of heating control functionality:
heater stays on when lifting pan during cooking
heater stays on when tilting pan-support basting
temperature ramps up without overshoot even at high-speed mode
temperature control at 1 degree Celsius or Fahrenheit accuracy, incremented from 80-450 F
consistent temp across cooking surface

In some embodiments, temperature control involves monitoring of multiple sensor inputs to deliver temperature accuracy. In some embodiments, heating control includes controlling multiple coils for equal temperature across the cookware. In some embodiments, each of the inductions coils is independently controllable. For example, suppose an inner coil and an outer coil (where the outer coil has a larger diameter and encompasses the inner coil). The inner and outer coils may support the same, or different maximum power ratings. Total provided power can be distributed between the two different coils in various scenarios. For example, if even heating is desired, the total power can be divided evenly between the inner coil and the outer coil. If it is desired for the center of the cookware to be hotter, more power is provided to the inner coil as compared to the outer coil. If small cookware is to be used, then all of the available power can be provided to the inner coil (and none to the outer coil). If it is desired that the outer portions of the cookware are to be hotter (e.g., hotter away from the center of a pan), then more power is distributed to the outer coil as compared to the inner coil.

In some embodiments, heating control is based on a profile of the cookware that is detected as being in use. In some embodiments, a profile of the cookware includes characterization of cookware material and thermal properties, weight of the cookware, etc. Further embodiments of adaptive heating control based on identified or recognized cookware are described below.

Induction heater controller 308 is also configured to perform safety control pertaining to the induction coil 342. As one example, controller 308 only permits the induction coil to be turned on/energized once the cookware is placed on the system to ensure safety.

In this example, power for the resonant circuit is provided from electrical power, such as that converted via AC (alternating current)/DC (direct current) circuit 346 from AC power (e.g., from a wall plug) to DC power. The following are further embodiments of a power supply of an induction cooking system. In some embodiments, the power supply is configured to provide continuous power delivery, cyclic power delivery, etc. In some embodiments, the power supply provides low, consistent power delivery. In some embodiments, the power supply is configured for closed loop control. In some embodiments, the power supply supports power boosting with a battery or other type of energy storage (e.g., capacitors). In various embodiments, the power supply is selected or designed for robustness, efficiency, and silent operation (e.g., with minimal humming). In some embodiments, the power supply includes a detachable power cable (e.g., for plugging into a wall outlet).

The following are embodiments of induction coils of the induction cooking system described herein. In some embodiments, a high-performance induction burner module delivers induction heating and/or electric current to the cookware and/or electric appliance placed on top of the coil.

As one example, the induction coil has a diameter between 260-300 mm. Other coil diameters may be utilized, as appropriate. In some embodiments, the induction cooking system includes a multiple coil configuration, such as two coils with independent control, where, for example, an inner coil is 6-7″ 1800 W coil, and an outer coil is 10″ 900 W coil. A multi-coil arrangement facilitates consistent temperature across cooking surfaces of different types of cookware (which may vary in size). In some embodiments, the induction coil(s) are high efficiency with minimum eddy current losses. In some embodiments, the coil is selected for strong inductance with minimum lost inductance over height. In some embodiments, alignment of assembly of the coil is performed for equal power density in height and surface area.

The following are further embodiments of the construction and design of components of the induction cooking system described herein.

The following are further embodiments of sensors of an induction cooking device.

### Weighing Scale

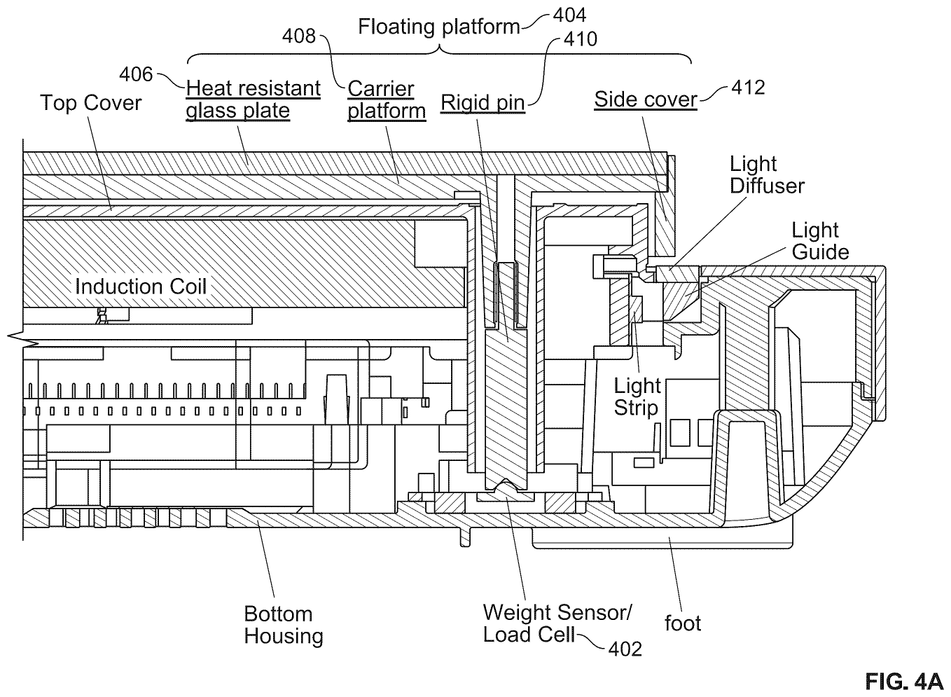

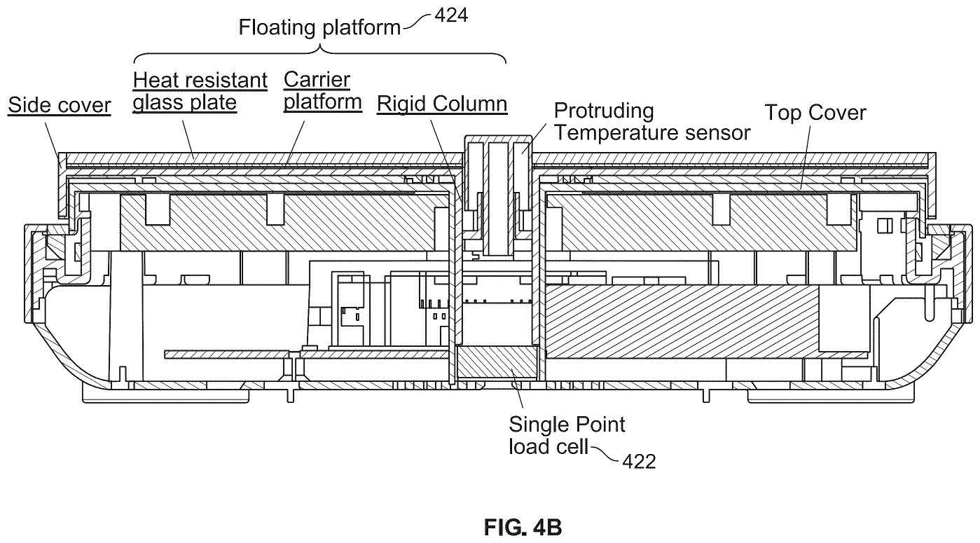

The following are further embodiments of a weighing scale for an induction cooking device. FIG. 4A illustrates an embodiment of a weighing scale. In this example, embodiments of weighing scale functionality through a floating platform are shown. In the example of FIG. 4A, a portion of an induction cooking device (such as device 100) is shown.

Some existing cooking systems with weighing scales install the weight sensor at the foot of the unit. This results in less consistency due to, for example, the influence of the power cord on the weight of the system.

In the example of FIG. 4A, a floating platform 404 rests directly on the weight sensor 402 (examples of which include load cells, strain gauges, etc.). This isolates the weighing function from the movement of the system, providing more accurate and consistent weight measurements. As shown in this example, floating platform 404 further includes heat resistant glass plate 406 (an example of top plate 102), carrier platform 408, rigid pin 410, and side cover 412. In some embodiments, the side cover is a sliding cover.

FIG. 4B illustrates an alternative embodiment of a weighing scale for an induction cooking device. In this example, a cutaway view showing an interior view of the induction cooking system is shown. In this example, rather than having multiple pins and load cells, a single point load cell (422) in the middle of the system is utilized. In this example, the floating platform (424) rests directly on the single point load cell.

The example construction of the induction cooking device shown in FIG. 4B is efficient. For example, the center or middle of the induction coil is typically empty, and the use of a single point load cell positioned as shown in FIG. 4B is space effective. In some embodiments, if multiple pins are used, space in between the induction coil is created to allow pins to pass through.

### Temperature Sensor

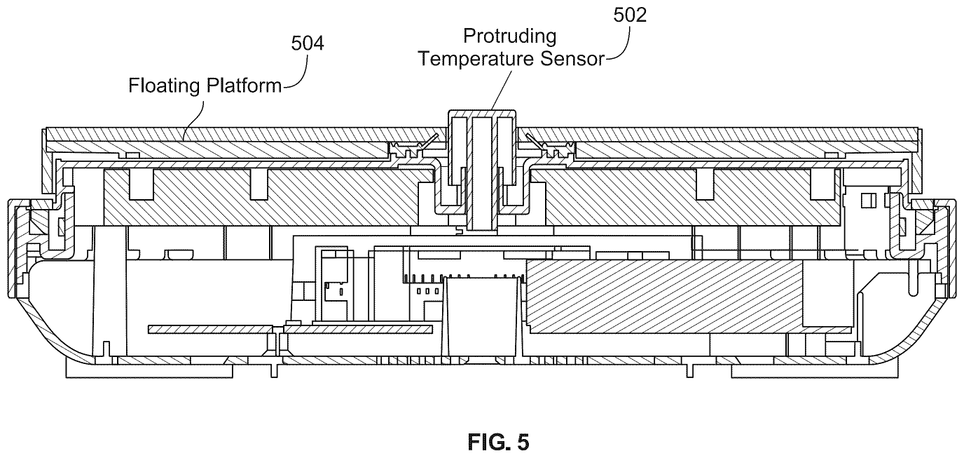

The following are further embodiments of a temperature sensor for an induction cooking device. FIG. 5 illustrates an embodiment of a temperature sensor protruding through a moving or floating platform. In this example, protruding temperature sensor 502 is an example of temperature sensor 104.

In the example of FIG. 5 involving a floating platform 504, a spring-loaded mechanism is utilized for the protruding temperature sensor to ensure that the spring force of the temperature sensor does not affect weight measurements.

The following are further embodiments of hardware interfaces of the induction cooking system.

Light Display Function with LED Strip

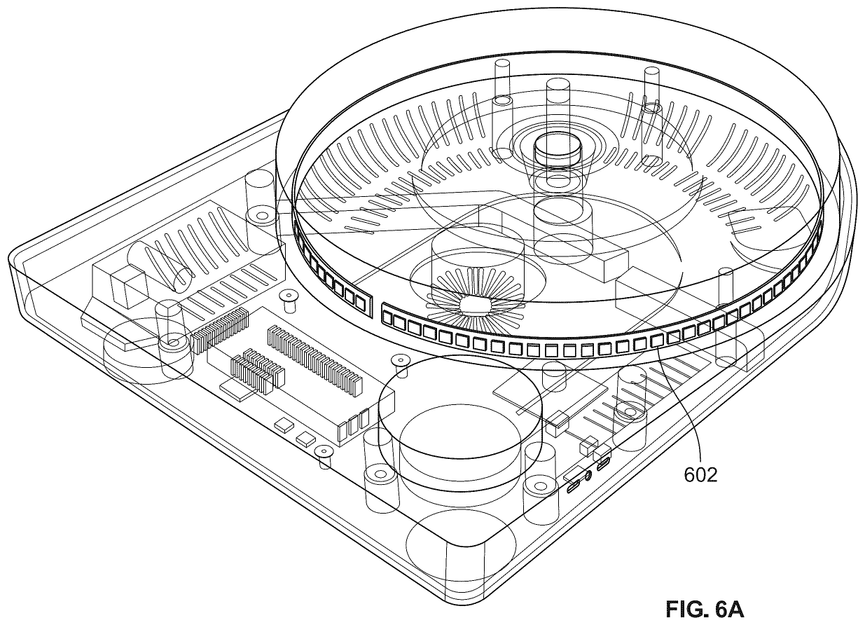

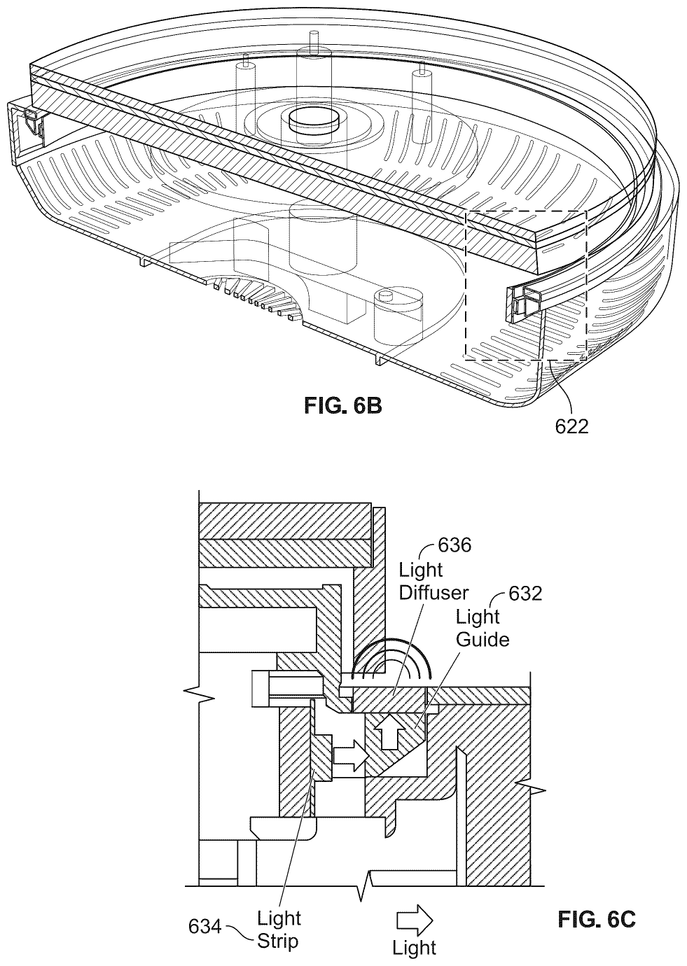

The following are further embodiments of a lighting display for an induction cooking device. FIG. 6A illustrates an embodiment of a light ring. In this example, the light display is a flat, flexible LED (light-emitting diode) strip, which is curved to form a circular-shaped light strip. Such a light ring configuration provides a uniform light around the cooking platform.

FIG. 6B illustrates a cutaway view of a light ring for an induction cooking system. In this example, an enlarged view of portion 622 is shown in FIG. 6C. In the example of FIG. 6C, an angular light guide 632 redirects light (from light strip 634) 90 degrees upward. The light may be redirected at any other angle, as appropriate. In some embodiments, the light diffuser rim 636 diffuses the light to create a homogeneous light display effect.

### Dial Control Knob

The following are further embodiments of a dial for an induction cooking device. Embodiments of the physical design of the dial, as well as embodiments of the user interface provided by the dial, are described below.

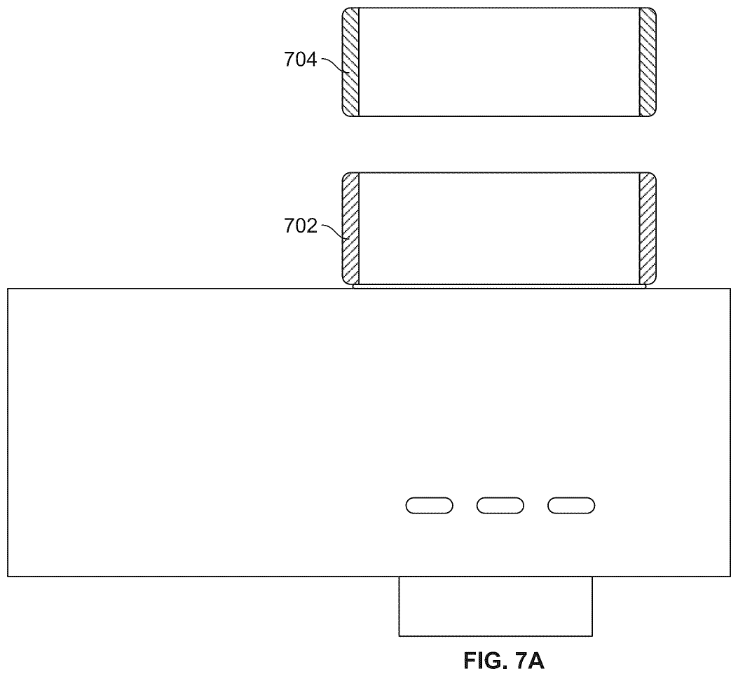

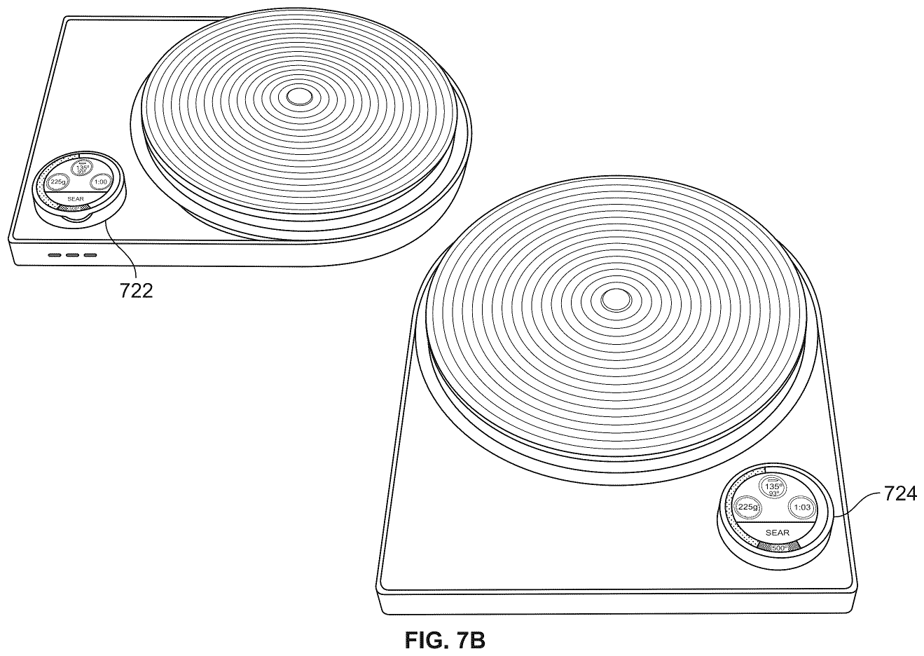

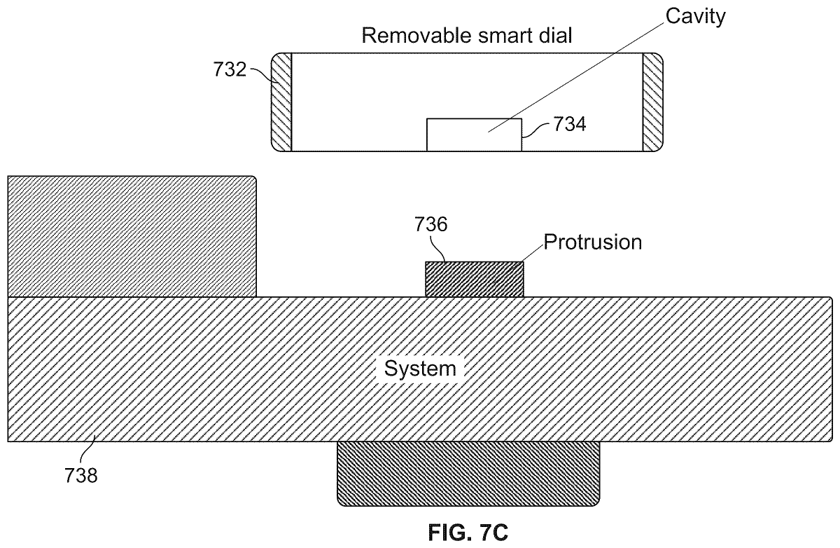

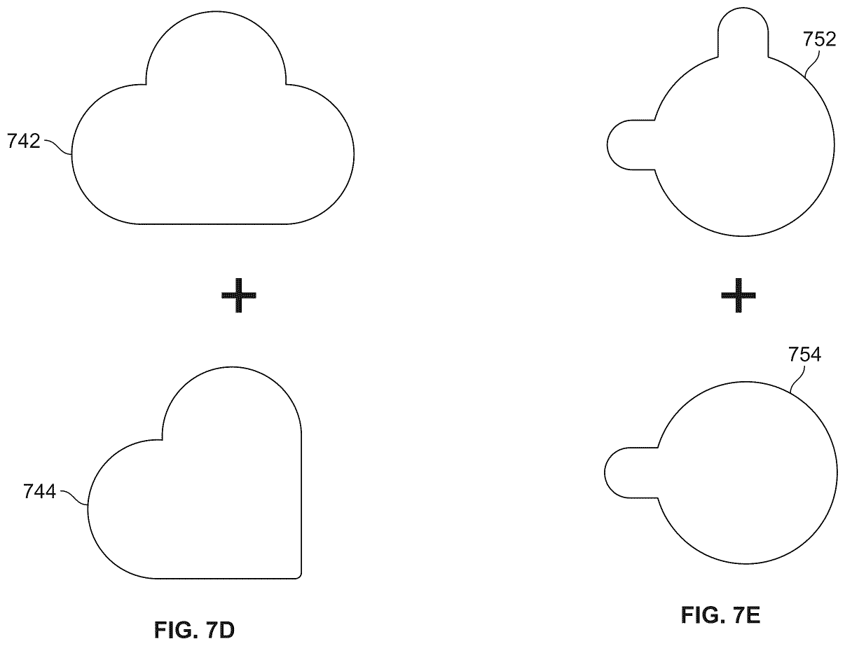

FIG. 7A illustrates an embodiment of a knob/dial user interface element. In this example, a knob/dial 702 with detachable ring 704 is shown (where the ring is shown to be detached at 704). In some embodiments, dial 702 is an example of dial 106. In some embodiments, dial 702 is a high tactile quality knob. In some embodiments, the knob includes a display. In some embodiments, the display is a touch screen. In some embodiments, the display is easily serviceable (e.g., to clean). In some embodiments, the knob includes an integrated touch screen. In some embodiments, a removable ring is used for cleanability.

The following are further examples of a dial specification. The dial may be constructed to other specifications, as appropriate. As one example, the dial has a 2.1″ touchscreen, where the display is 480×480 resolution (circle) with a glass lens. The screen of the dial may be in other dimensions and resolutions, with different shapes and different lens materials. While a touchscreen is shown for illustrative purposes, in other embodiments, the screen need not be a touchscreen. As another example, the dial has a 2.9″ outer diameter (other diameters may be utilized, as appropriate).

In some embodiments, the knob provides a smooth, high-quality feel. As one example, the outer bezel of the dial is made of polished stainless steel. The outer bezel may be made of other materials, as appropriate. In some embodiments, the knob has infinite ROM (range of motion). In some embodiments, the knob has haptic feedback for push, as well as rotary detents. In some embodiments, the knob is press-able as a button. In some embodiments, the dial includes a microphone/speaker for voice control and voice feedback. In various embodiments, the dial includes sensors, such as light, proximity, temperature and humidity, etc. In some embodiments, the dial has integrated or built-in connectivity (e.g., Wi-Fi, Bluetooth, etc.). In some embodiments, the dial is waterproof (e.g., IP54 waterproof rating).

In some embodiments, the rotating dial, in conjunction with the design of the induction cooking device, facilitates both left and right-hand use. FIG. 7B illustrates embodiments of a cooking system in left and right-hand configurations.

In some embodiments, and as shown in the example of FIG. 7B, the display on the smart dial is rotated 90 degrees for left-handed (722) or right-handed use (724). The rotation of the user interface of the dial may be initiated in various ways. As one example, a physical button or element is used to toggle the orientation of the screen via software. As another example, an on-screen selection element in the touch screen display is usable to select the orientation of the screen via a software setting.

In some embodiments, along with use of the intelligent cooking device in left- and right-hand orientations, the induction cooking system also includes multi-orientation cable management. In some embodiments, the burner includes a built-in cord storage winder at the bottom of the burner.

In another embodiment, the smart dial is removable. FIG. 7C illustrates an embodiment of a removable dial. A removable dial is shown at 732. In this example, the removable dial connects to the base induction cooking system via a connector. For example, the removable smart dial includes a cavity 734 that connects to protrusion 736 in the base system 738. In some embodiments, the removable dial connects to the system with a specific-shaped connector. In some embodiments, the shape of the cavity and protrusion limits allowed orientations, such as only allowing connection of the smart dial in two specific orientations, as shown in the example of FIG. 7B.

FIGS. 7D and 7E illustrate examples of connection shapes for a removable smart dial of an induction cooking system. In the following examples, pairs of dial cavities and system protrusions are shown that allow for two orientations. In the example of FIG. 7D, smart dial cavity 742 pairs with base system protrusion 744. In the example of FIG. 7E, smart dial cavity 752 pairs with base protrusion 754.

### Example Intelligent Dial User Interface

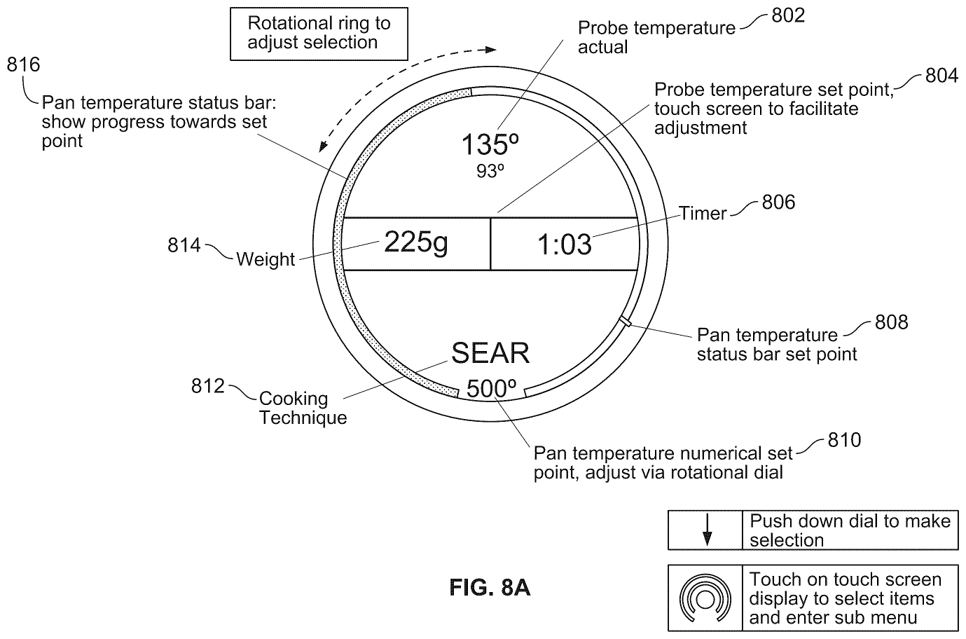

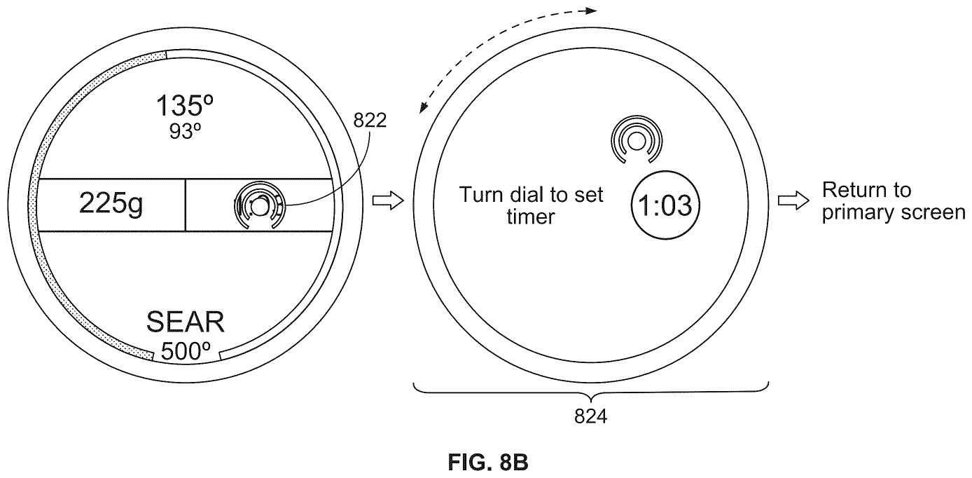

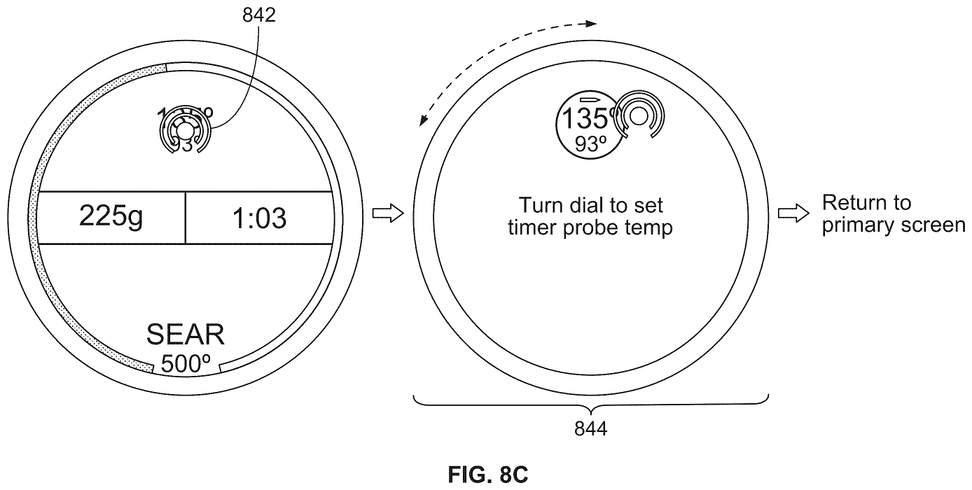

FIG. 8A illustrates an embodiment of a smart dial display. In some embodiments, the interface of FIG. 8A is provided via the display of a smart dial such as smart dial 106 of FIG. 1. In one example implementation, the user interfaces shown are supported by a web UI react framework.

In the example of FIG. 8A, a smart dial primary display is shown. Various types of information are shown in the user interface. Examples of information presented include probe temperature 802. In some embodiments, a set point of the probe temperature can be adjusted, as shown at 804. Timer information is shown at 806. A pan temperature status bar set point is shown at 808. A cookware (pan in this example) temperature set point is shown at 810, which can be adjusted via the rotational dial. A cookware (pan in this example) temperature status bar is presented at 816, which in some embodiments displays progress towards a set point.

The cooking technique being utilized (which is used to control the parameters of the induction cooking system) is presented at 812. In some embodiments, a user can enter a technique selection sub-menu by interacting with region 812 of the display (e.g., via touch input, rotational dial/push down selection, etc.). In some embodiments, techniques are associated with automated cooking modes, where the performing of a technique is implemented in an automated or semi-automated manner. For example, in response to selection of a cooking technique, the system automatically loads device settings and guided technique user interfaces for the selected technique. As used herein, a (cooking) technique refers to a technique, way, or process in which food or ingredients or foodstuffs are prepared or cooked. Examples of cooking techniques include frying, rice-cooking, caramelization, etc. As used herein, a cooking technique also refers to relevant sub-technique end-state selection such as a degree of doneness or end-state for a cooking technique, such as soft-ball or hard crack for caramelization, or medium-rare or medium for a fry chop. In some embodiments, allowable or selectable end states are technique dependent, cookware-type dependent, or both.

The weight of the cookware (plus contents in the cookware) is shown at 814. In some embodiments, the user can enter a weighing scale selection menu by interacting with region 814 of the display. The user can also perform taring by interacting with region 814 of the display (e.g., shorter touch for taring function, longer held touch for entering weighing scale selection sub-menu).

The user can interact with the smart dial in a variety of ways. For example, the user can rotate the rotational ring to adjust selection. As another example, the user can push down on the dial to make a selection. As another example, the user can touch the touch screen display to select items and enter a sub-menu.

FIG. 8B illustrates an embodiment of a timer function. In this example, a user touches the touch screen at 822 to enter a timer setting menu, as shown at 824. When at the timer setting menu, the user can physically rotate the ring of the dial and push down on the dial or use the touch interface to scroll and make a selection of an amount of time for the timer. The user can then return to the primary screen.

As one example, the timer can be set at 30 sec increments (or any other increment as appropriate), and the countdown by the second. In some embodiments, once the countdown is completed, the system notifies the user with the combination of sound, light, and/or screen information.

In other embodiments, the timer functionality is set via voice commands. In various embodiments, further customization may be added to the timer setting menu, such as determining system settings after completion of timer countdown.

FIG. 8C illustrates an embodiment of a probe temperature function. In this example, the user interacts with the primary display at 842 (e.g., via touch screen input) to enter the probe temperature setting sub-menu. The display then updates to the probe temperature setting menu 844. In this example, the user can rotate the ring of the dial to scroll through options presented in the interface. The user can make a selection by pushing down on the dial or touching the touchscreen interface. After setting the probe temperature function, the user can then return to the primary screen.

In some embodiments, the probe temperature display appears when a detachable probe is plugged into the base system, such as through a USB-C port, as described above. In some embodiments, the probe temperature can be set via voice commands as well. In various embodiments, further customization may be added to the probe setting menu, such as for adjusting settings of circulator functionality.

In some embodiments, the induction cooking system described herein is a base system that can be used with multiple types of cookware. The system then adapts its settings and parameters (e.g., UI, heating control, etc.) based on the type of detected cookware. The following are embodiments of recognizing cookware and adapting components of the cookware based on the recognized cookware.

### Cookware Detection and Recognition

In some embodiments, the induction cooking system adapts to the type of cookware being utilized. This includes providing contextual user interfaces, heating control, etc. that are adapted to the characteristics of the cookware being utilized. In some embodiments, the adaptation is based on identification or recognition of the type of cookware being utilized. The following are embodiments of cookware detection and recognition.

In some embodiments, cookware recognition is facilitated by including tags embedded within cookware used in conjunction with the induction cooking system described herein. In some embodiments, the cookware has minimal electronics to ensure robustness, long product lifetime over daily home use, etc. In some embodiments, the system recognizes which cookware is placed on the burner with wireless tags (e.g., RFID/NFC). In some embodiments, the tag includes an identifier of the cookware (e.g., identifier of a type of the cookware). In some embodiments, the tag includes additional information pertaining to the cookware, such as its weight or other characteristics. In some embodiments, the induction cooking system includes a tag reader or scanner, such as an RFID or NFC tag reader.

The following are embodiments of a cookware tag for cookware recognition. In this example, an RFID implementation is described for illustrative purposes. As one example, the tag is a high temperature RFID tag. As one example, the tag is installed or placed in a portion of the cookware such as a handle. In some embodiments, the tag is robust and durable against dishwashers, drops, daily uses, heat, etc.

In some embodiments, the induction coil of the induction cooking system is used as a digital antenna for reading and detecting the RFID tag. For example, the induction coil is configured to detect the location of the RFID tag. If the location of the RFID tag is known (e.g., in the handle), then the system can also identify the position and orientation of the cookware. In some embodiments, the use of the coil as an antenna for reading/detecting cookware prevents false detection of other nearby cookware. In other embodiments, an external RFID chip and reader are used to connect to the system controller (e.g., controller 304).

In some embodiments, third party cookware can be integrated with the system. One example of registering 3^{rd} party cookware with the induction cooking system includes executing a series of semi-automated cookware characterization (e.g., of heating behavior, weight, etc.), and assigning a cookware ID (identifier) attached to a separate wireless tag (e.g., NFC tag, RFID tag, etc.). In some embodiments, the tag is programmed with a cookware profile based on the cookware characterization. In other embodiments, a data store including a list of cookware identifiers and corresponding information is updated to register the new cookware identifier, including creating a record for the cookware identifier that also includes the characterization of the cookware. In some embodiments, lookups of the table are performed to retrieve cookware profile information pertaining to the cookware identifier. In some embodiments, the table includes information pertaining to both first party cookware (developed, for example, in conjunction with the cookware system), as well as third-party cookware. Further details regarding cookware characterization are described below. In some embodiments, third party cookware registration is supported by use of a mobile device.

In some embodiments, the system recognizes the type of cookware being utilized based on other standards such as NFC (generic, KI standard, etc.). As one example, after a third-party cookware item has been characterized, the cookware is registered by assignment of NFC tokens that are attached to the cookware. In some embodiments, read/write access to the NFC token/tag is provided to the cookware system.

In addition to identification via RFID and NFC, cookware detection can also be performed in other ways in various embodiments. For example, cookware can be detected without needing additional tags in the cookware, and instead determining a signature or fingerprint of the cookware for identification. In various embodiments, a signature of the cookware is generated based on one or more of the weight of the cookware, heating profile, inductance, electric current frequency, acoustics, etc. In some embodiments, a unique signature or identifier of the pan is generated based on the corresponding pattern of sensor signatures. The table of cookware types and corresponding profiles is updated to include cookware that is identified based on sensor signatures, as well as corresponding profile information. In some embodiments, at cooking time, lookups are performed on the cookware records table by querying the cookware profile table using a detected sensor signature. The record matching to the queried-for sensor signature is accessed, and corresponding cookware profile information is obtained from the accessed record for use in adapting the parameters of the system.

As described above, multiple modalities of cookware/accessories detection can be combined to perform detection (e.g., using both weight and temperature profile to determine what type of cookware object is present). As one example, impedance and operating frequency measurements can also be used to identify or recognize the cookware being utilized or that is in the presence of the induction coil. In some embodiments, presence or absence of a cookware object on the induction coil is based on detection threshold frequencies.

Based on cookware recognition, a cooking context is established—the type of cookware being utilized. Operation of the induction cooking system is adapted based on the cookware context, further examples of which are described below. For example, based on the recognition of a type of cookware object (e.g., detecting presence of a type of cookware object), information pertaining to the cookware object is used to adjust various components of the cooking system, such as the graphical user interface (GUI), control-loop coefficients for use in a temperature control loop, etc.

### Cookware Profiles

As described, in some embodiments, each type of known cookware is registered, including having a record in a data structure for the type of cookware and corresponding cookware profile information. For example, the type of cookware is assigned an identifier, and is registered with the cooking system or an entity (e.g., remote cloud server) that is accessible to the cooking system. New types of cookware can be registered over time.

In some embodiments, each type of cookware is associated with a cookware profile. In some embodiments, the cookware profiles are locally stored in a memory of the system, in a tag of the cookware, or are otherwise accessible by the system (e.g., obtained by querying a data store of a remote server).

In various embodiments, the cookware profile includes information about the cookware itself, parameters for use by the induction cooking system parameters, etc. In some embodiments, the system settings are customized for the specific cookware.

For example, consider cooking techniques. Suppose that there are numerous different types of cooking techniques that are available for selection. In some embodiments, the cookware profile includes the subset of allowable cooking techniques that can be used with the cookware. In some embodiments, the allowable cooking techniques are used to drive available menu options presented in a contextual user interface. In some embodiments, each technique is associated with a secondary set of options. For example, suppose a multi-cooker. One of the techniques included in the profile is cooking rice. In some embodiments, the profile for the technique includes sub-menu options, such as the type of rice to be made (e.g., sushi rice, porridge, white rice, brown rice, etc.). Another example of sub-menu options includes a specification of desired end-state (e.g., rare, medium-rare, medium-well, etc.). In some embodiments, the allowed (and presented/selectable options for) ingredient end-states are specific to the cookware, to specific techniques, or both (e.g., specific technique when using a specific type of cookware). In this example, the profile for the cookware includes an indication of allowable UI and menu options.

The cookware profile also includes operational temperature settings, such as temperature pre-sets, temperature ranges, speed control, etc. As another example, the cookware profile also includes closed loop temperature control parameters, such as factors for PID control of the induction coil. PID control parameters to be used under different conditions or points in time when cooking can also be specified. In some embodiments, components of the cooking system, such as the user interface, heater controller, are adjusted or adapted according to the profile of the cookware.

In some embodiments, a cookware profile includes information pertaining to characteristics of the cookware object. Examples of such characteristics maintained in the profile or record for the cookware include thermal properties, acoustic properties, weight, thermal mass, physical dimensions (e.g., surface area of bottom of pan, volume in a container, etc.), material properties, etc. As will be described in further detail below, various types of events or states related to cooking are detected from onboard sensor measurements. In some embodiments, what particular patterns of sensor measurement values are detected as signaling an event are based on recognizing the cookware being used, and having profile information of the cookware. As one example, a cooking technique may involve multiple steps, where the conditions for completing a step or transitioning to a next step in the technique are based on detection of certain events. Whether the events have occurred is detected based on accessed characteristics of the cookware. One example type of event or state information that is monitored for by the system is the state or condition of ingredients being cooked. In some embodiments, the state of ingredients is based not only sensor measurements (e.g., specific values for temperature, pressure, mass, moisture, doneness, crispness, etc.), but also the properties of the cookware being used (e.g., its thermal mass, weight, etc.).

### Cookware Characterization and Calibration

The following are further embodiments of cookware characterization and calibration. The characteristics of the cookware are determined and stored in a profile of the cookware, for use by the induction cooking system.

Cookware that can be characterized include bundled or compatible or dedicated first-party cookware integrated with the cooking system, where first party cookware is constructed to have certain properties or characteristics, such as compatible material properties, characterization, and calibration matching the induction coil. This facilitates predictable heating behavior (temperature change rate, weight, heating pattern and heat evenness) of cookware with burner power output. In some embodiments, third-party cookware is characterized to determine its thermal properties, acoustic properties, etc., with a profile generated for the third-party cookware.

The following are embodiments of characterizing cookware. The characterization can be performed in a laboratory setting. In other embodiments, the induction cooking system includes a characterization mode for characterizing the cookware in situ.

In some embodiments, characterizing cookware includes running a series of steps to characterize various properties of the cookware object in various different states (e.g., with water inside, empty, etc.). For example, the cookware is heated to obtain control loop parameters (e.g., K-factors and Q factors for PID control of the induction coil). In some embodiments, characterizing the cookware includes weighing the cookware when empty to obtain the weight of the cookware. As another example, the induction coil can be used to transmit various signals to the cookware to obtain resonance of the cookware object. For example, impedance and operating frequency measurements are used to determine characteristics of the cookware such as material properties and thermal properties. As another example, characterization of a cookware object or cooking vessel includes using one or more impedance reflectance spectra, acoustic spectra, and/or weight is used to detect and correlate to thermodynamic response of the cookware. In some embodiments, impedance and operating frequency measurements, as well as induction frequency and/or acoustic frequency can then also be used as a spectral cookware fingerprint to identify or recognize the cookware being utilized or that is in the presence of the induction coil.

As described above, in some embodiments, the cookware is associated with a unique identifier. A profile corresponding to the cookware identifier is generated that includes the determined characteristics of the cookware. The cookware profile is then stored, such as locally at the cooking system, in a remote storage, and a local user device (e.g., their mobile device), etc.

As described above, based on the recognition of the type of cookware being utilized, as well as the various sensor measurements collected, the induction cooking system is configured to adapt and optimize the cooking experience to the type of cookware by accessing characteristic profile information corresponding to the cookware. For example, various types of actions and functionality may be provided upon recognition of the type of cookware object being utilized and accessing information pertaining to the characteristics of the detected cookware object. Various examples and embodiments of intelligent optimization and adaptation of cooking processes based on cookware identification and detection are described below.

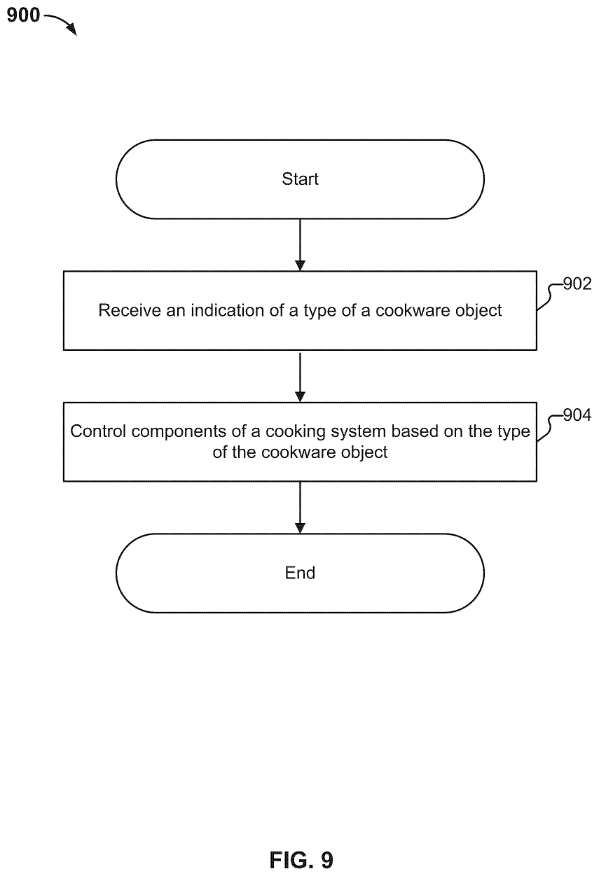

FIG. 9 is a flow diagram illustrating an embodiment of a process for cooking system parameter adaptation based on recognized cookware. In some embodiments, process 900 is executed by system controller 304. The process begins at 902, when an indication of a type of a cookware object is received. For example, the presence of a type of a cookware object is detected and recognized. At 904, one or more components of a cooking system are controlled based on the recognized type of the cookware object. For example, a cookware profile pertaining to the detected type of cookware object is received. At least two different types of cookware are associated with different cookware profiles.

As described above, components of the system are adapted by recognizing the cookware being used (e.g., based on tags, sensor signature, etc.). In some embodiments, system parameters and settings are determined by performing a lookup of the profile based on an identifier of the cookware that is determined based on the recognition of the cookware (e.g., identifier extracted from tags, spectral fingerprint determined based on stimulating of cookware with sensors, etc.). A record corresponding to the recognized identifier is accessed, and a cookware profile information corresponding to the identifier is retrieved from the record.

As described above, in some embodiments, each type of cookware is associated with a unique identifier (e.g., signature, tag identifier, etc.). Each cookware that is registered has a profile. In some embodiments, the identifier of the cookware is used to perform a lookup of the corresponding profile. For example, if the cookware has an NFC or RFID tag, an identifier in the tag is read and used to perform a lookup for the corresponding profile. As another example, a fingerprint of the cookware (e.g., spectral fingerprint) is generated for the present cookware, and the corresponding profile (if available) is determined by performing a lookup of a cookware fingerprint database. A profile is accessed if there is one matching the fingerprint. As one example, the spectral fingerprint is based on the thermal response of the cookware to inductive energy input. New cookware profiles can be added over time as part of registering new cookware (and characterizing the cookware).

Information in the corresponding profile is accessed and used to drive or configure various aspects of the cooking system. Different types of cookware are associated with different profiles. The cookware information included in the profile includes cookware characteristics, such as thermal properties, inductive response characteristics, weight characteristics, etc. In some embodiments, the profile includes the type of the cookware (e.g., frying pan, egg cooker, multi-cooker, etc.). In some embodiments, the type of the cookware is embedded or encoded in the identifier of the cookware. In some embodiments, the cookware profile information includes temperature control parameters. As another example, the cookware profile information includes UI control settings, such as allowable UI options.

The system is configured by loading information from the profile when setting system parameters. For example, the system parameters are adjusted according to predetermined data profile information. That is, the cookware is recognized. The corresponding profile is obtained or accessed. The system behaves according to the obtained cookware profile. For example, components of the cooking system are adapted based on, or otherwise operate according to, the context of the detected type of cookware object. For example, the context of the cookware object, as well as cooking state information, are used to adjust the user interface as well as control algorithms.

Examples of cooking system adaptation based on recognition of cookware being utilized include dynamic contextual user interfaces and cooking automation. While embodiments involving an induction cooking device are described herein for illustrative purposes, the techniques described herein may be variously adapted to accommodate contextual UI, thermal control, and cooking automation of any other type of heating device (e.g., radiant heating device), as appropriate.

The following are further embodiments of cooking system adaptation based on detected cookware.

### Auto-Taring Based on Recognized Cookware

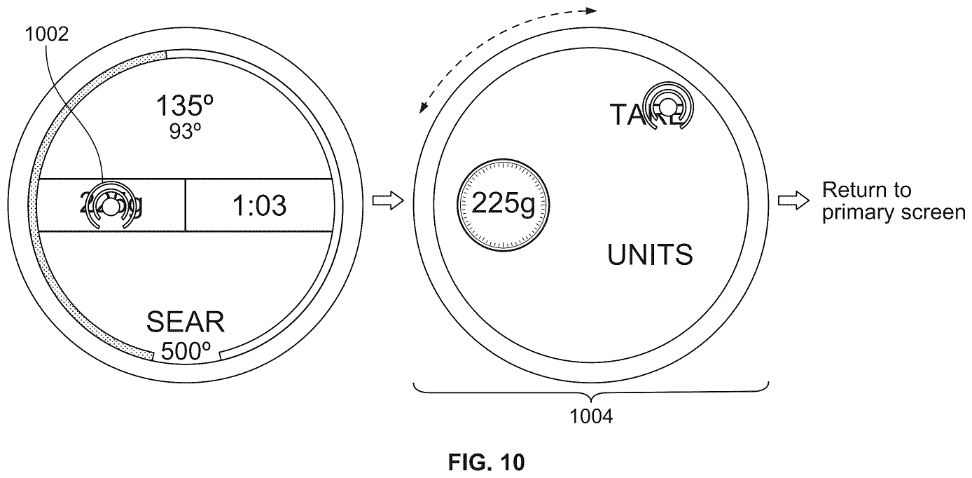

FIG. 10 illustrates an embodiment of a weighing scale function of an induction cooking system. In the example of FIG. 10, the user interacts with region 1002 of the display of the dial (e.g., via touch screen, or rotation of ring with selection via push down of the dial). In response, the display transitions to the user interface shown at 1004.

At 1004, the user can use the physical rotational ring to scroll through the selection menu and make a selection by either pushing down on the dial or using the touch interface. In some embodiments, the tare function can be activated via voice command.

In some embodiments, based on the recognized cookware (or measurement container) being utilized, the cooking system retrieves weight information for the detected cookware (e.g., based on weight information stored in the profile corresponding to the cookware). In some embodiments, the system uses the pre-stored weight of the device to automatically tare the weight scale. For example, if a known frying pan is placed on the system and detected, the weighing scale tares automatically. This allows the mass or weight of an ingredient in the cookware to be automatically determined. The cooking system also supports manual taring.

As shown in this example, for a given type of cookware, the weighing sub-system of the induction cooktop utilized pre-stored weight information of the cookware, containers, etc. (e.g., as stored in a cookware profile). Such weight information of identified cookware can be used in conjunction with information regarding ingredients (which can be determined via the taring described above).

As another example, suppose that the cookware object being used is detected to be a measurement container. In response to recognizing that the cookware object being used is a container for measurement, the system automatically enters an auto-taring mode, including providing a user interface for controlling the auto-taring mode.

In the above example, by recognizing the cookware that is present (e.g., using NFC, RFID, spectral fingerprints, etc.), the system can perform automatic taring (and remove the need for the user to perform multiple steps to tare) to determine the weight of any ingredients in the measurement container or cookware. This is facilitated by using the techniques described herein to identify the measurement container/cookware and use the pre-loaded or pre-stored weight for the cookware/container holding an ingredient.

The following are further examples of various weight information maintained or monitored by the system or are included in a cookware's profile, which include, without limitation:
weight of cookware/container
weight of parts of cookware/container, such as the weight of the lid of a pot
weight of ingredients that are already present in the cookware/container
weight of ingredients that are added to cookware/container during step-by-step cooking guidance (examples of which are described in further detail below).

The tracking of such weight information of cookware, ingredients, etc. facilitates various types of functionalities that are beneficial for a user, such as, without limitation:
when the cookware or container that already contains ingredients is placed on the weighing scale, the system calculates the weight of the ingredients by subtracting the weight of the cookware/container (automatic taring, as described above)
the system tares automatically as step-by-step cooking guidance progresses
the system is able to infer or derive or otherwise determine, at any point in time of a cooking session, changes in weight (e.g., during sauce reduction of a cooking session).

As shown in this example, the context of the cookware is not only utilized during heating/cooking stages, but also during preparation phases of a cooking session. The context of the cookware can also be used to facilitate maintenance phases as well.

### Contextual UI and Technique Monitoring and Guidance Based on Identified Cookware

In some embodiments, the intelligent induction cooking system described herein provides an all-in-one heating system for a variety of cooking needs. In various embodiments, this is facilitated via a universal interface that is adaptable and universally applicable to the context of the cookware being used.

For example, the induction cooking base system recognizes the type of cookware object in use via identifiers such as NFC (Near Field Communication)/RFID (Radio Frequency Identification) tags, spectral fingerprints, etc. and provides a custom user interface for the pan or cookware via the user interface on the base system. This is in contrast to existing induction cooktops which typically only detect presence, not type. This is also in contrast to standards such as the Ki standard, which keeps the interface on the device, where each cooking appliance is associated with its own interface and its own specific functions. In contrast, the user interface of the base cooking device is a centralized, singular interface that is universally adaptable or responsive to the cookware that has been recognized to be in use for cooking.

As one example, controller 304, via UI controller 306, adapts the user interface presented to a user based on the recognized type of cookware. One example of providing a contextual user interface is providing specific prompts to a user (e.g., via a contextual UI), where available prompts are dependent on the type of cookware being used. For example, the available techniques for users to provide input of type of cooking method or technique to be performed. As another example, the user provides an input of a desired end result or ingredient end-state (e.g., doneness of steak, crispiness of pancake, doneness of eggs, etc.). In some embodiments, a selection of desired ingredient end-state is made from a set of available options for ingredient end-state. In some embodiments, what ingredient end-states are available for selection is based on cookware type, technique type, or both.

As described herein, by recognizing the type of cookware that is to be used/in use, and thus knowing the properties of the specific cookware being used, a contextual user interface is provided that is customized towards that specific type of cookware.

As one example, the menus and sub-menus presented in the user interface are controlled based on the type of recognized cookware. Available options in the menus are determined based on the type of recognized cookware. Allowed inputs that the user is permitted to provide are based on the type of recognized cookware. Responses to user selections are also determined based on the recognized type of cookware. For example, if a pancake pan is detected, then the technique menu only includes the subset of cooking techniques (out of the superset of all of the techniques that the cooking system can perform and/or provide automated guidance on) that are available for use with a pancake pan. As another example, available options for selecting the desired doneness or end-state of ingredients are constrained by the cookware. For example, if an egg cooker is recognized as being in use, then the menu that is displayed is limited to doneness options for eggs. Different types of cookware can be associated with different menu options for selecting doneness (e.g., menu options for selecting level of crispiness when using a pancake pan, menu options for selecting level of doneness of steak when a frying pan is used, etc.). In some embodiments, the available menu and sub-menu operations and structures are maintained in the cookware profile. By automatically adapting the menu options of the user interface based on the recognized cookware, the system can guide the user through a much more streamlined interface as compared to other existing systems.

Another aspect of the contextual user interface described herein includes cooking technique guidance, monitoring, and control via the user interface. In existing systems, users typically reference an external resource such as a cookbook to determine how to perform certain techniques. In contrast, in embodiments of the techniques described herein, the parameters for various cooking techniques are built into the cooking system itself. In some embodiments, the cooking techniques are implemented in the system as cooking programs or routines. This includes having the parameters for different cooking techniques integrated into the cooking system, such as for simmering, sauteing, etc. By integrating the system parameters along with the onboard and connectable sensor measurements, a contextual user interface that is adapted both to the type of cookware, as well as the cooking technique being utilized is presented.

This includes detecting certain types of phases of a cooking technique. The phases or state of the cooking technique are determined based on the detection, from monitoring of onboard sensor measurements, of various cooking insights, such as detection of user interventions/actions, detection of foodstuffs state, weight measurements, temperature measurements, cookware temperature, probe temperature, etc. The detection of cooking phases allows the system to provide technique guidance (e.g., when a current phase of a cooking technique is completed, when to move on to the next phase of the cooking technique, etc.). In some embodiments, the contextual user interfaces provided, as described above, are also determined based on the detection of phases of cooking techniques. For example, given a weight and a recipe, the system is programmed to expect a certain type of cooking content (e.g., protein). Based on this, when a certain amount of weight has been added, the system can provide guidance on how to adjust certain functions via the user interface (e.g., how to use a browning percentage function). In this way, the cooking user interfaces are both dynamic and contextual.

In some embodiments, the triggers for determining cooking insights are not only dependent on the onboard sensor measurements, but also the characteristics of the cookware that is in use. That is, the user interface provides various information about a technique being performed. The manner in which the user interface updates to provide updated information is based on detection of monitored cooking state information. The manner in which cooking state information is detected is dependent on both the sensor measurements, as well as the characteristics of the cookware being used. In this way, the technique guidance that is provided via the user interfaces is also adapted to the context of the cookware being utilized. Further, presented information such as prompts are also tailored to the context of the cookware recognized as being in use. Further examples and embodiments of determining cooking insights based on recognized cookware are described below.

Recognizing cookware and having a contextual interface that is adaptive to the context of the recognized cookware improves the quality of the cooking experience. For example, the integrated system is programmed with various types of cooking techniques. This includes information on technique guidance to provide instructions via the contextual user interface for the user to follow. For example, a cooking technique may involve flipping at a certain phase of the cooking process. In some embodiments, the cooking system is configured to provide notifications of user actions to be performed as the cooking progresses.

As described above, the information that is provided, and the available inputs that are presented via the contextual user interface are dynamically determined based on the monitoring of the phases of the cooking technique being performed. In the below examples, technique guidance is provided via the user interface, where the information provided via the user interface is used to facilitate technique guidance to guide the interaction of the user with the detected cookware. In this way, the cooking system provides an interface to manage various different types of cookware. This removes the need for individual cookware objects to have their own respective interfaces. Technique guidance is one example of complex functionality that is provided via the user interface. Other examples of functionality supported by the universal interface include using a singular interface to drive multiple different types of cookware objects.

The following are embodiments of adaptive cooking user interfaces based on identified or recognized cookware.

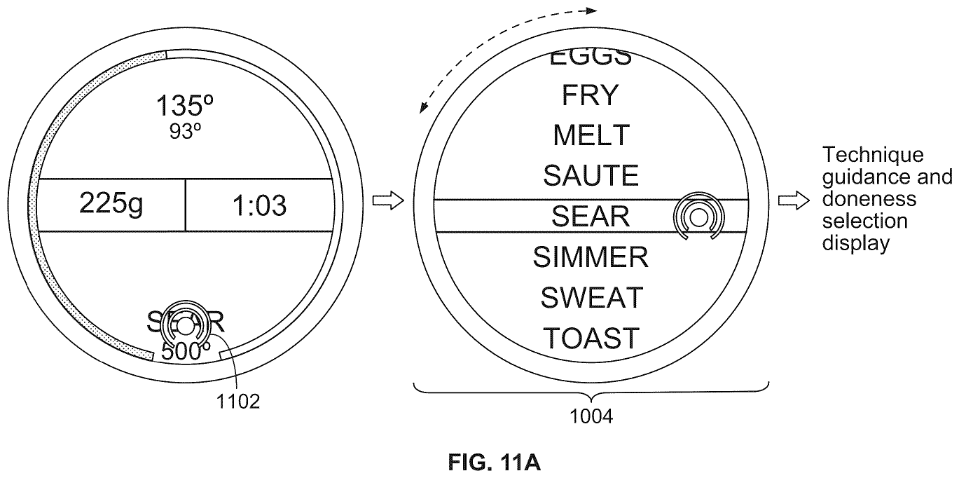

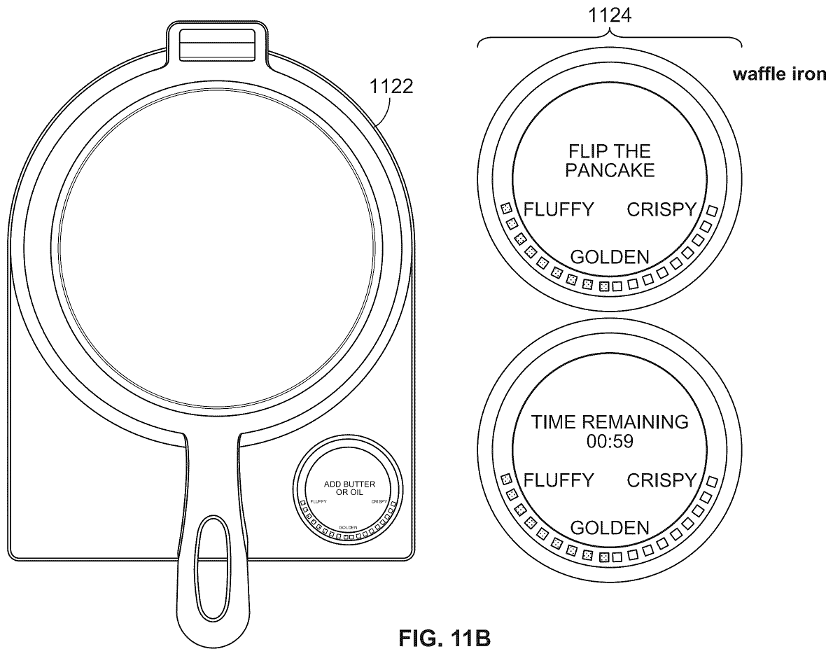

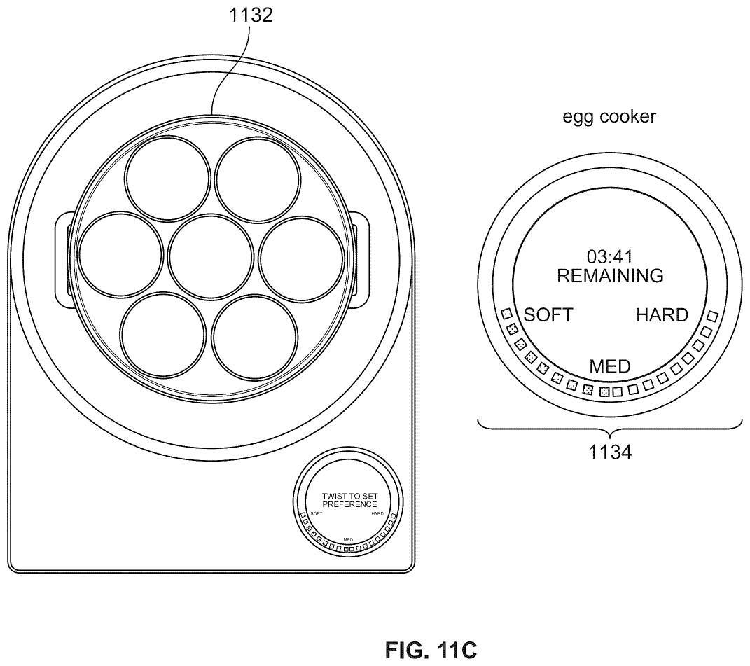

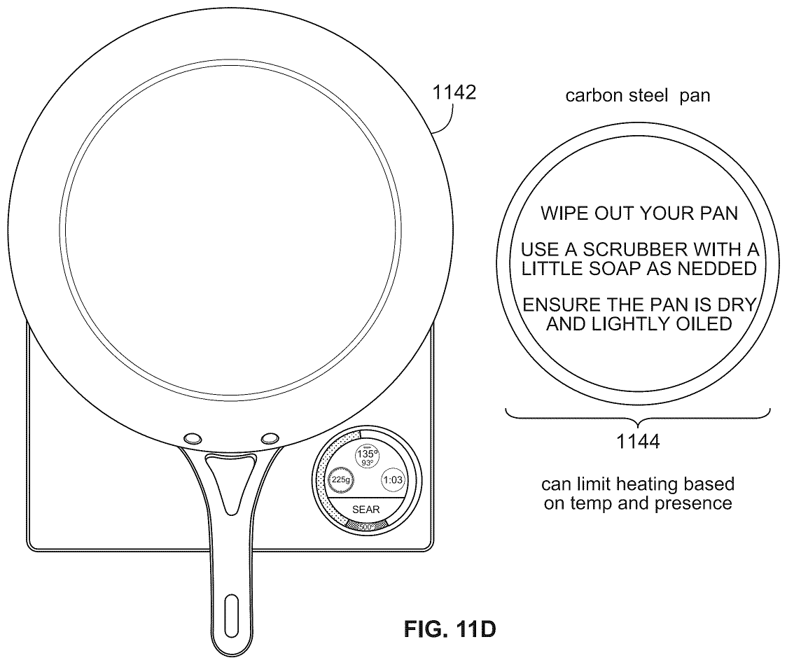

FIG. 11A illustrates an embodiment of cooking technique selection. In this example, the user interacts with region 1102 of the display of the dial (e.g., via a touch screen interface). A technique selection menu that includes available cooking techniques is displayed in response, as shown at 1104. As shown in this example, the technique selection menu is contextual, and is dependent on the type of cookware that is placed on the system (and detected/identified). For example, at 1104, available techniques for a detected frying pan are shown. The user can then interact with the contextual user interface that presents information that is adapted to the detected type of cookware, such as by scrolling through cooking technique options by rotating the ring dial or scrolling via the touchscreen, making a selection of a cooking technique by touching a selected option or pushing down the dial, etc. After a cooking technique is selected, the UI updates to provide guidance on how to execute the selected technique, as well as provide options for the user to specify the doneness they desire.

The following are examples of contextual user interfaces for technique guidance and doneness selection that are adapted to different identified cookware.

FIG. 11B illustrates an embodiment of contextual technique guidance and doneness selection user interfaces adapted for a waffle iron. In this example, the induction cooking device automatically detects that cookware of type waffle iron has been placed on the induction cooking device.

In this example, a waffle iron is shown at 1122. The system adapts provided user interfaces based on recognition of the waffle iron. An example of such a user interface based on cookware context is shown at 1124. In this example, technique guidance specific to the detected type of cookware is shown, where the user interface provides instructions to “flip the pancake”. Such technique guidance would not be provided in the context of other types of cookware being detected, such as a rice cooker.

In the example cookware contextual user interface of 1124, doneness selection options relevant to the detected waffle iron are also provided, such as the level of doneness for pancakes being made, such as fluffy, golden, or crispy. The menu options or information for doneness are specific to the context of the waffle iron being recognized as in use.

FIG. 11C illustrates an embodiment of contextual technique guidance and doneness selection user interfaces adapted for an egg cooker. In this example, the induction cooking device automatically detects that cookware of type egg cooker has been placed on the induction cooking device.

In this example, an egg cooker is shown at 1132. The system adapts provided user interfaces based on detection of an egg cooker. An example of such a user interface based on cookware context is the doneness selection menu 1134. Via the interface of 1134, a user can select a desired level of doneness for eggs being cooked (e.g., soft, to medium, to hard). As shown in this example, the options for doneness selection for the egg cooker are different from the selectable doneness options provided for the waffle iron (as shown at 1124 of FIG. 11B).

Other contextual user interfaces can be presented where what content or information is presented is automatically adapted to the type of identified cookware. One example is a pan maintenance guidance user interface that is presented at the end of a cooking session.

FIG. 11D illustrates an embodiment of a contextual user interface for pan maintenance guidance adapted for a carbon steel pan. In this example, the induction cooking device automatically detects that cookware of type carbon steel pan has been placed on the induction cooking device.

In this example, at the end of a cooking session, the induction cooking device is configured to present a maintenance notification 1144 that is adapted specifically for the recognized carbon steel pan. For example, the maintenance instructions shown for the carbon steel pan include to “wipe out your pan,” “use a scrubber with a little soap as needed,” and to “ensure the pan is dry and lightly oiled. Different maintenance instructions are presented for different types of cookware that are recognized to be in use.

In some embodiments, in addition to the UI, other parameters of the system can be adapted to the type of cookware and for a desired cookware action. For example, with respect to cookware maintenance, the cooking system provides a cookware maintenance mode, which adapts heating control for maintaining detected types of cookware. As one example, this includes limiting heating based on temperature (as measured by sensors), and presence. For example, if maintenance of a detected carbon steel pan is to be performed, then the system limits its heating (e.g., by adjusting the power delivered to the coils, based on temperature and presence).

As shown in the above examples, by performing automated user interface configuration based on recognized cookware type, embodiments of the cooking system described herein, much more streamlined interfaces can be provided to a user, as compared to existing systems. In addition to cookware, the cooking system described herein is configured to automatically provide contextual, centralized user interfaces adaptive for controlling and/or presenting information for various other types of devices as well, such as pressure sensors, moisture sensors, fans within a pressure cooker for moisture regulation, circulators (e.g., plugged into the USB-C port of the cooking device, or that are battery operated and wirelessly communicate with the cooking system), etc.

In various embodiments, information and user input options presented via the contextual user interface are provided by a high pixel density touchscreen such as dial 106 that facilitates the providing of complex graphics to convey a sophisticated amount of information that is configurable and adaptable to operate across a broad spectrum of different types of cookware or devices. In this way, the user interface is a singular, universal interface that can control, during a cooking session, a multitude of cookware being utilized in conjunction with and/or connected to the cooking system. For example, after the user is done using one type of cookware and removes it from the cooking device, the user can then place another type of cookware on the cooking device. The presence of the newly added cookware is detected, and its type automatically recognized. The user interface automatically updates or adapts in response to the recognized cookware. In this way, a singular user interface device is used to control the entire cooking environment, without the user needing to interact with multiple different interfaces or have to manual determine what to select from the space of all possible options.

While in the above examples, the dial is shown to be connectable and integrated with an induction cooktop, the dial and the contextual user interface can be used in conjunction with other types of heating or cooking devices, as appropriate. For example, a similar type of dial with a contextual user interface can be used with an oven, or all-in-one system that includes microwave, steam, air frying, baking, convention, grilling, etc. Such a dial and interface can also be used with a built-in, multi-zone cooking system. For example, each induction burner can be associated with its own smart dial. In some embodiments, the built-in cooking system has multiple types of heating elements (e.g., induction, radiant heat, etc.). As another example, the dial can be connected to other cooking appliances, such as multi-function cookers. In this way, a unified user interface can be used to provide a universal interface for any cookware or cooking device used in conjunction with the intelligent induction cooking system described herein.

Another example cooking appliance that the dial can also be configured to be a user interface for is a multi-cooker. When in use with the induction cooking system (e.g., placed on the top plate of the induction cooking system), various components of the multi-cooker are controllable by the induction cooking system. The following are further embodiments of a multi-cooker.

Embodiments of the cordless cooker described herein replace various types of cookware, such as pots, high-end rice cookers, slow cookers, Dutch ovens, etc. In some embodiments, the multifunction cookware is also portable, allowing transport from the base “burner” system to a dining table.

In some embodiments, the multi-cooker is an all-in-one cordless multi-cooker with a built-in heater that receives wireless power transfer from the induction burner (e.g., by utilizing the KI standard), where control is centralized with the dial (such that there is no cluttered UI on the multi-cooker).

In some embodiments, the multifunction cookware includes an insulated body with heating (via the induction coil). The multifunction cookware also incorporates various sensors for cooking performance and safety. In some embodiments, the multifunction cookware includes a sous vide mode with data transfer (e.g., via NFC). Example functions of the multifunction cookware include pressure cooker, rice cooker, and soup cooking.

The following are examples of construction of multifunction cookware. As one example, the multifunction cookware is 6 quarts within a stainless-steel inner surface (or any other volume/material selection as applicable). An electric connection (e.g., pin or wireless) is made with the induction coil/burner (e.g., via dimple/pin or induction coil wireless power and signal/data transfer). In some embodiments, the multifunction cookware is insulated (e.g., vacuum or via plastic shell).

In some embodiments, the multifunction cookware is associated with different types of smart lids. One example type of intelligent lid is a pressure smart lid with sensors (e.g., temperature and pressure sensors), pressure release valve, and integrated stirrer. Another example of an intelligent lid for multi-function cookware is a transparent non-pressure smart lid, with sensors and integrated stirrer. The following are further embodiments of an intelligent lid for multi-function cookware.

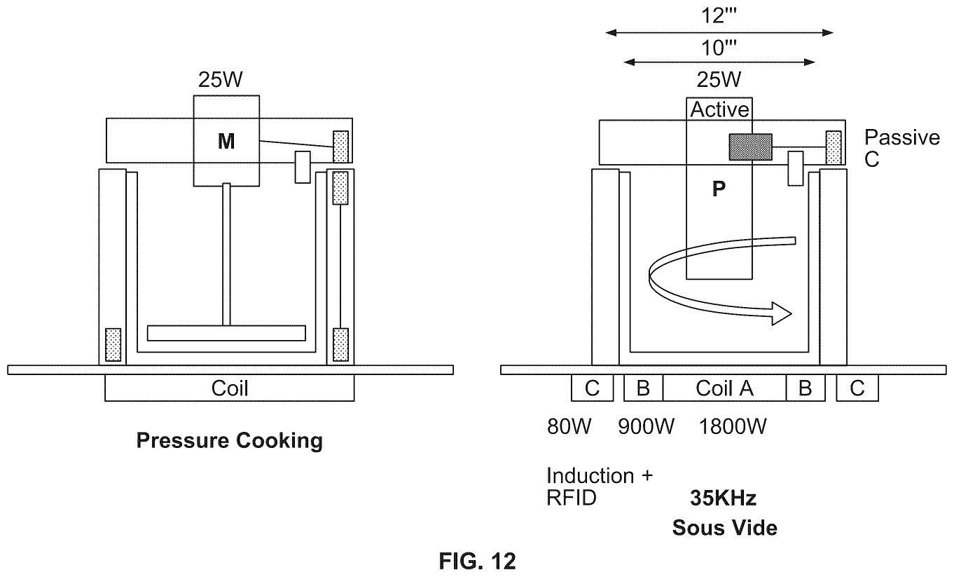

FIG. 12 illustrates an embodiment of a multi-function cooker with a smart lid. In some embodiments, the multi-function cookware with smart lid shown in FIG. 12 is an embodiment of the multi-cooker with smart lid 212 shown in the example of FIG. 2. In some embodiments, the intelligent lid or cover communicates with the induction burner via a protocol such as NFC. For example, sensor signals are transferred between the multi-function cookware and the base induction system via NFC. Power is transferred from the induction burner to the smart lid, such as via wireless induction power transfer, or via physical electrical cable (e.g., USB connection, via which data transfer can also be provided). In some embodiments, the smart lid includes integrated sensors for control and safety. As another example, the smart lid includes an integrated motorized actuator (e.g., for stirring). In some embodiments, the motor obtains power via the induction coil or a wired power connection. In some embodiments, in addition to driving a mixer/stirrer, the motor also drives a fan of the multifunction cookware. As yet another example, the smart lid includes an integrated motorized venting (e.g., for pressure and moisture control). In some embodiments, the smart lid includes built in pressure transducers and thermal sensors. Other example sensors incorporated in the multifunction cookware include moisture and humidity sensors.

The following are further embodiments of control of a multifunction cookware. As one example, multi-cooker control is used to facilitate a pressure-cooking mode, to, for example, detect overheating of food which will result in low, or no pressure built up in the pressure cooker mode. In some embodiments, multi-cooker control is based on the aforementioned sensors, which as one example are located on the upper area of the pot (side wall, lid, etc.), either with a wired connection or wireless connection.

The following is another example of multi-function cookware control. In some embodiments, the multi-function cookware can be controlled based on onboard sensors of the base system, without requiring additional sensors incorporated in the multi-function cookware. For example, temperature sensors of the base system take measurements at the bottom of the pot, either through direct contact (e.g., protruding temperature contact) and/or via the heating top plate glass, to detect different heating rate and/or stabilized temperature after certain predetermined periods of time. Further information such as the weight and weight change of the pot, power input/output measurement, etc. can also be provided as input to the control algorithm for controlling components of a multi-function cookware.

The following is another example of heating control involving a multi-cooker. In some embodiments, the lid includes various sensors that the system controller receives measurement data from. As one example, measurement of temperature inside the cookware is performed with a sensor in the lid. In some embodiments, measurement of humidity is performed inside the cookware with a sensor in the lid. As described above, sensor measurements may be used by the system as feedback to control various components of the system. As one example, the system includes an actuator to circulate or stir the liquid inside the cookware, controlled by the system based on sensor feedback.

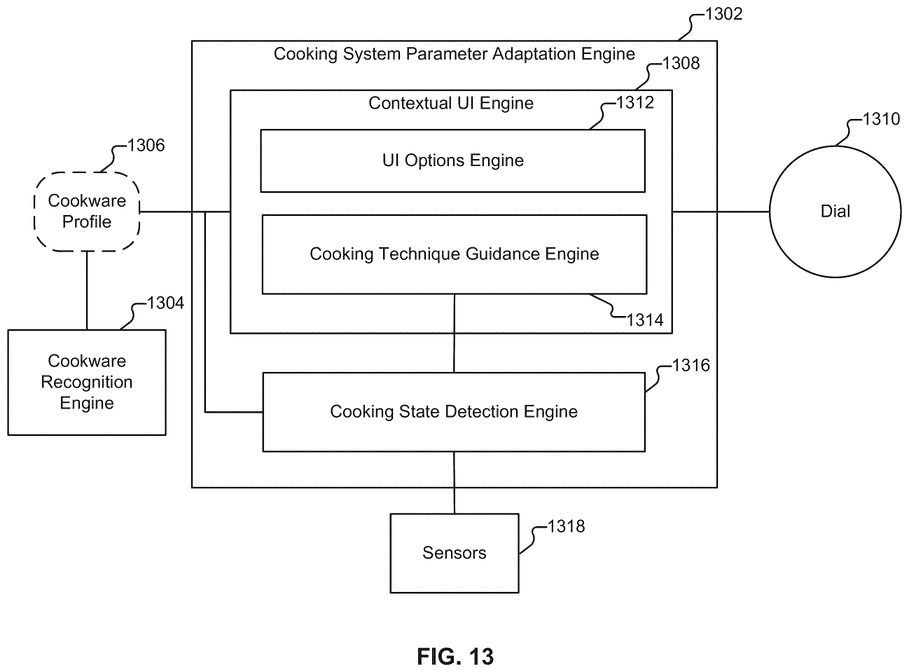

FIG. 13 illustrates an embodiment of a system for cooking system adaptation based on recognized cookware. In some embodiments, system 1302 is an alternative view of system 300 of FIG. 3. In this example, cookware recognition engine 1304 is configured to recognize a type of cookware that is being used with the cooking system. Examples of cookware recognition include detecting using NFC, RFID, etc. As another example, cookware recognition is performed using Wi-Fi, where a cookware object that has a transmitter is configured to communicate with the cooking system over Wi-Fi to identify itself to the cooking system. Cookware can also be identified by characterizing or determining a signature of the cookware via sensors (e.g., a spectral signature determined by probing the cookware using the induction coil, microphone, speakers, weight sensors, temperature sensors, etc.). Users can also input, via the contextual user interface, the type of cookware that they are using, notifying the system of the type of cookware that is in use. For example, the user can search from a set of registered cookware and make a selection of the cookware they are using. The user can also indicate the type of cookware they are using via voice inputs.

In some embodiments, a cookware profile 1306 corresponding to the recognized cookware is accessed. For example, the cookware profile is accessed by accessing a record corresponding to the recognized cookware. Different types of cookware are associated with corresponding cookware profiles. In some embodiments, the cookware profiles include various system parameters that are used by the cooking system to adapt its operation. One example of such cookware information includes user interface configuration parameters, such as menu options, prompt options, etc. In various embodiments, the cookware profiles are stored locally to a memory of the cooking system, retrieved from a cloud entity, and/or read from the cookware being utilized.

In some embodiments, the characteristics of the cookware are inferred from other contextual information. For example, it may be the case that the cookware object is not directly identifiable or detectable by the system. In some embodiments, other information is used as context to at least infer some of the properties of cookware being used. For example, the type of cooking technique being performed, or the recipe being implemented can be used to infer properties of the cookware being utilized. As one example, suppose that a user has indicated that they are cooking a Moroccan tajine. In some embodiments, the system performs a lookup of a record corresponding to the selected technique and determines the type of cookware that is typically used to create such a dish. In this example, a profile for cookware used in conjunction with the technique indicates that ceramic-type material is commonly used to create tajine. Based on the profile of cookware used to make tajine, the system determines that the cookware is likely to be ceramic, and the system adapts its components accordingly, such as being gentler with respect to heating power to prevent cracking.

The cookware recognition and profiles containing cookware-specific parameters are used by cooking system parameter adaptation engine 1302 to recognize, out of all the possible different types of cookware that exist (pots, pans, appliances, etc.), what type of cookware is actually being used, and in response determine how to optimally control the operation of the cooking system, including configuring the system to facilitate interaction with various different types of cookware from a singular interface. For example, regardless of what type of cookware the user puts on the cooking device, the cooking device provides a user interface that is adapted and specific to the recognized type of cookware to manage the cooking experience. In this way, cookware such as appliances such as a rice cooker or instant cookers need not have their own dedicated display on the appliance itself.

In this example, contextual UI engine 1308 is configured to control the user interface that is displayed on dial 1310 (an example of dial 106). In this example, the user interface that is provided is adapted to the cooking context, which includes the type of cookware object being used. The cooking context for adapting the UI also includes what cooking technique is being performed. In some embodiments, the contextual UI engine provides available inputs and determined outputs based on the cookware profile 1306 of the recognized cookware.

In this example, UI options engine 1312 is configured to determine the content for menus to be displayed, UI options for selection, the response of the user interface to various inputs, etc. based on the detected cookware object. As one example, suppose that the presence of a specific type of frying pan, known to the system, is detected. On the display/contextual user interface, a technique selection menu is only populated with those techniques that can be performed using the frying pan. For example, pressure cooking techniques are not displayed. Instead, only cooking techniques such as searing, toasting, etc. that can be performed USING the frying pan are presented via the display. For example, suppose that there are overall 150 available techniques in all. The cooking system selects a subset of techniques that is available for selection for the frying pan.

In this example, cooking technique guidance engine 1314 is configured to provide guidance on cooking techniques being performed using the recognized cookware object and the cooking system. For example, suppose that a user has made a selection of a cooking technique from the subset of cooking techniques that are available for the detected type of cookware object.

In some embodiments, as the user performs a cooking technique, the technique guidance engine is configured to update the user interface based on the state or phase of the cooking technique being performed. In various embodiments, and without limitation, cooking state includes the state of the cookware, the state of the ingredients in the cookware, the state or phase of a cooking process (e.g., cooking technique), user actions or interventions that have been performed, etc. In some embodiments, the state of the technique, as well as detection of events that occurred during the technique are determined by cooking state detection engine 1316.

Cooking state detection engine 1316 is configured to monitor the state or phase of a cooking session over time. In some embodiments, determining the state or phase of the cooking session includes determining insights/applications from sensor measurements/data (e.g., collected from onboard and/or collected sensors 1318).

In some embodiments, the manner in which sensor data is translated, synthesized, or otherwise mapped into insights is dependent on the context of the type of cookware object being used. For example, for the same sensor readings, different insights may be determined for different types of cookware. In some embodiments, in addition to taking as input sensor readings from sensors 1318, the state detection engine also takes into account the characteristics of the cookware (as obtained from cookware profile 1306) to perform cooking state and event detection.

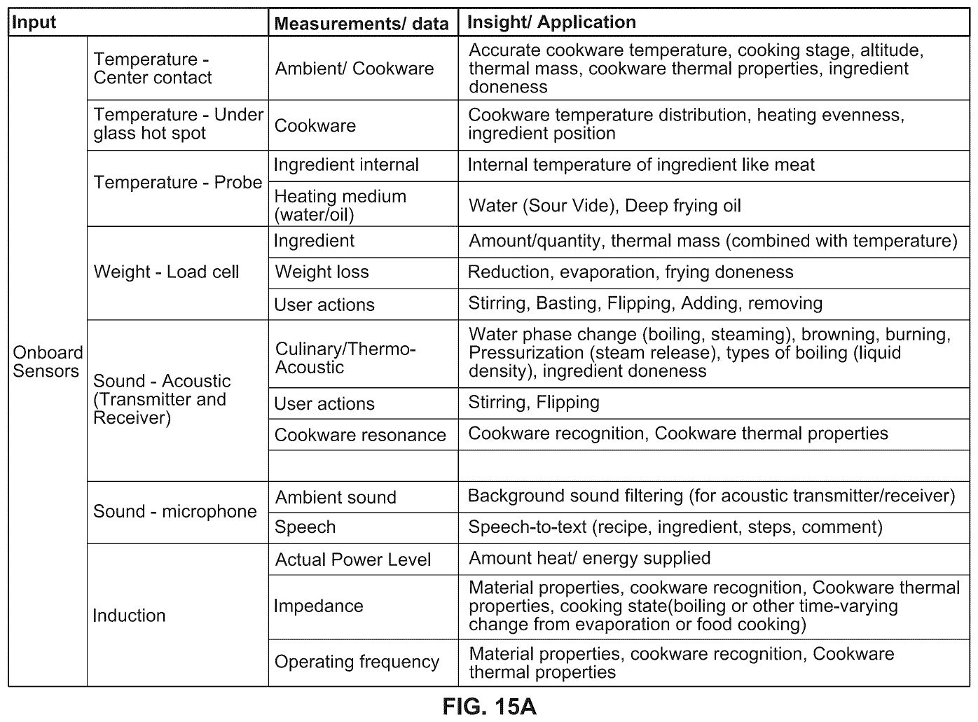

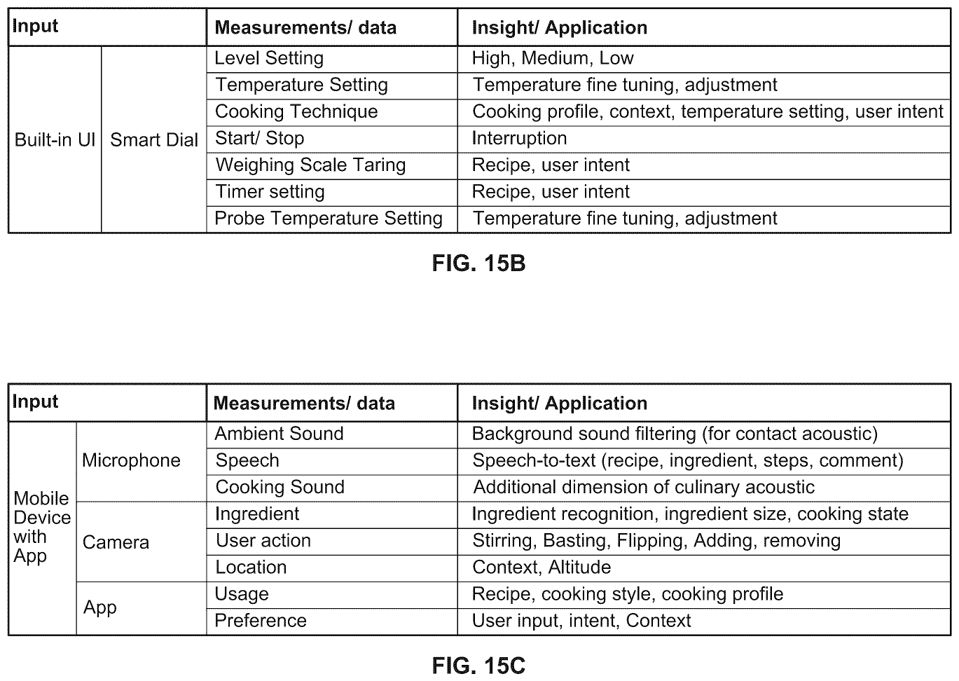

The state and events detected by engine 1316 are used by guidance engine 1314 to determine how to update the UI to provide relevant information to the user about the progress of their cooking. For example, the contextual UI is an event-driven interface. In some embodiments, the insights include detection of various events, where the events are used as triggers for updating the user interface. How events are detected, as well as what events are used as triggers for driving the user interface can be cookware specific. The integration of sensors and synthesis of cooking state information provides accurate feedback to both the user (via the user interface), as well as cooking control. Further examples of insights are described in conjunction with the example of FIGS. 15A-C.

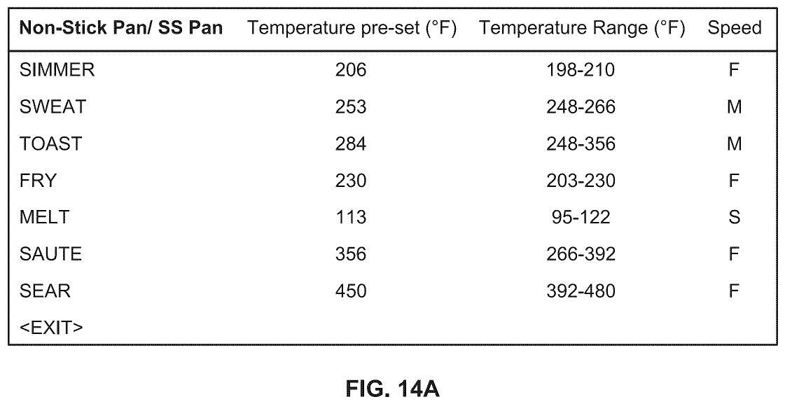

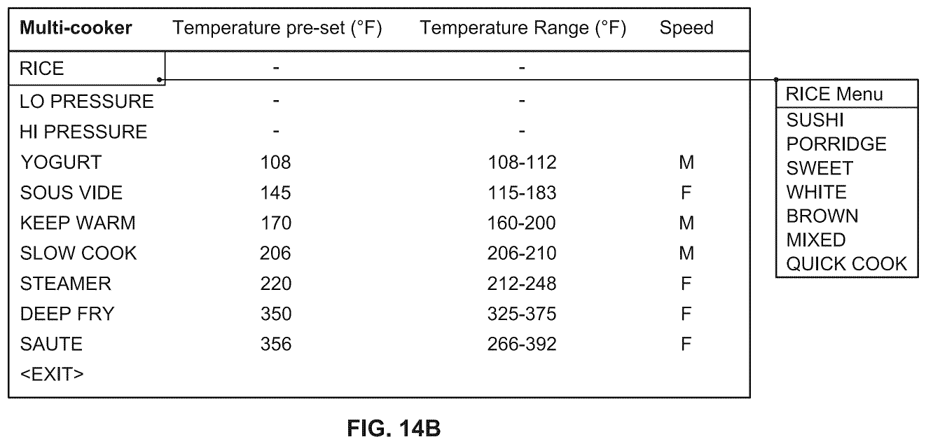

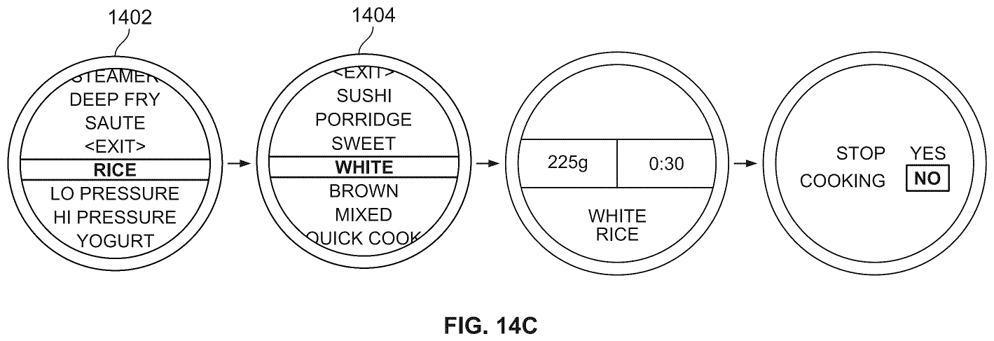

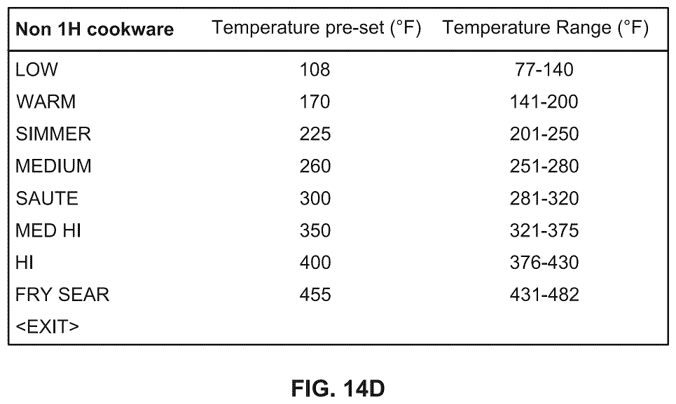

FIG. 14A illustrates an embodiment of available cooking techniques for a non-stick pan. In this example, the list of available techniques for the pan is shown in a profile for the pan. In addition, for each technique, temperature pre-sets, temperature ranges, and speeds that are specific to the characteristics of the pan are shown. For example, while a different pan may have the same available techniques, the temperature pre-sets and temperature ranges may be different based on the thermal characteristics of the pan. Different pans may have a different set of available techniques.

FIG. 14B illustrates an embodiment of available cooking techniques for a multi-cooker. As compared to the example technique menu that would be configured based on the pan profile information of FIG. 14A, the structure and contents of the menus that would be presented via the universal user interface are different for the multi-cooker. In this example, a profile for the multi-cooker is shown, indicating the available cooking techniques for the multi-cooker. In this example, the profile further specifies sub-menu options for techniques. In this example, under the rice cooking technique, available rice-type options for display are specified. The configuration of the menus for the UI of the cooking device is performed according to the menu parameters of the profile shown in FIG. 14B.

FIG. 14C illustrates an embodiment of a rice cooking menu. In this example, the structure of the menu tree and the options presented in the menus are determined according to the example profile shown in FIG. 14B. For example, the available cooking techniques are shown at 1402, while the rice type sub-menu options are visualized or rendered as shown at 1404, based on the menu configuration information of the multi-cooker's profile, as shown in the example of FIG. 14B.

As described above, in embodiments, the menu configuration information shown in FIGS. 14A and 14B is included in profiles for the non-stick pan and the multi-cooker that are accessible by the induction cooking system. In other embodiments, the system performs a lookup using an identifier of the type of cookware object to determine available techniques. The induction cooking system then uses such profile information to adjust or adapt or configure the technique menus that are presented so that they are linked to the specific cookware being utilized. This includes loading the available techniques, as well as corresponding information pertaining to each technique when using the particular pan, such as temperature pre-set, temperature range, etc.

In some embodiments, if non-registered cookware is being used, a generic or default menu is presented. FIG. 14D illustrates an embodiment of a default cooking technique menu configuration profile for non-registered cookware. For example, a cookware object is determined to be present, but is unable to be recognized. In some embodiments, a cookware object is determined to be non-registered if it cannot be identified by the system (e.g., no NFC or RFID tag, no previously registered cookware that could be found with similar spectral characteristics, etc.). Default menu configuration parameters are then used to drive or control the user interfaces that are presented.

Determining a permitted subset of techniques is one example portion of overall technique guidance that the system can provide based on the context of the detected cookware. In some embodiments, after selection of a technique to be performed, the system further pre-sets the temperature of the cookware (by driving the induction coil) according to the temperature pre-set corresponding to the selected cooking technique, that is specified for the particular type of cookware being utilized.

The cooking system also provides various forms of technique guidance as the user performs cooking. As described above, information used to guide the progression of the technique or cooking routine being performed is also presented via the user interface. In some embodiments, the conditions under which the user interface is updated are not only based on the technique being used, but also the detection of cooking states or events. The detection of insights such as cooking states or events is also based on the context of the recognized cookware. Further embodiments of detecting cooking insights are described below.

### Detecting Cooking Insights

As described above, by knowing properties of the cookware (based on having recognized the type of cookware object that is detected to be in the presence of the induction cooking system), the system can infer various state or event information pertaining to a cooking technique being performed. For example, measurements are collected from various sensors over time (e.g., the course of a cooking session). Cooking insights and applications are determined from the sensor measurements. In some embodiments, the contextual user interface described herein is driven based on detection of certain events or states during cooking. For example, what information or prompts are presented via the UI and when, as well as what selectable options are available and when, are determined based on the detection of cooking events and states. In some embodiments, the detection of cooking events and states is a function of interpretation of one or more sensor readings. In some embodiments, what cooking insights are determined from the raw sensor measurements is customized to the specific cookware that has been recognized.

FIG. 15A illustrates an embodiment of insights determined from input sensor data. Such insights are used to drive a contextual user interface to provide relevant information pertaining to the state or phase of a cooking session. As shown in this example, various types of measurement data are recorded and collected through various onboard sensors, such as temperature, weight, acoustics, induction, etc. Various different applications or insights are determined from the raw sensor data/measurements. In some embodiments, the derivation of the applications/insights from the raw sensor data is customized to a specific type of cookware. As shown in this example, raw sensor measurements from various sensors, such as acoustic sensors (which can include transducers, microphones in contact with the cookware, microphones that are air-coupled with the cookware, etc.), weight sensors, temperature sensors, etc. are synthesized together to determine various fingerprints or signatures or patterns of sensor measurements indicating certain cooking states or events. Contextual decisions are then made off the detected cooking states or events based on synthesizing sensor readings.

The intersection of such information is used not only to improve the accuracy and the performance of cooking, but combined with knowledge of what type of cookware object is being utilized, facilitates the determination of insights that are not accessible to existing cooking systems. As one example, integration of the properties/characteristics of the cookware object being used, sensor data from integrated sensors, the technique being performed, etc. facilitates the detection of what is occurring inside cookware, such as what is inside the cookware, the state of the ingredients within the cookware, etc. Further, information and prompts based on such insights are provided via the contextual user interface described herein, facilitating more effective interaction between the cooking system and the user when cooking.

One example of insights includes recognition of cookware as described above. Other examples of insights and events determined from sensor measurements include detecting of user actions. Examples of detected user actions include user actions performed with the cookware and/or with respect to the contents of the cookware, such as flipping, stirring, basting, adding ingredients, removing ingredients, etc. Other detected user actions include user interactions with the user interface, such as setting parameters of the cooking, including setting temperatures, selecting techniques, entering cooking modes such as warming modes, etc. Another example type of insight or event detected or determined by the cooking system from sensor measurements includes content or ingredient condition, such as percentage browning, sauce reduction amount, phase of boiling, thermal mass, position of ingredient in the cookware, etc.

Another example type of insight or event detected from sensor measurements includes environmental conditions, such as altitude. For example, the center temperature contact (temperature contact probe 104 that is in contact with the cookware) is used to determine cookware temperature, cooking stage, etc. The center temperature contact can also be used to determine altitude. For example, suppose that water is being boiled. The altitude is determined by measuring the temperature at which the water boils (water boils at different temperatures at different altitudes with different atmospheric pressures). The temperature at which the water boils is determined by monitoring the gradient of the temperature (measured over time or periodically by the center temperature contact), and observing where the temperature flattens (which is indicative that the water is now boiling). The monitored gradient of the temperature is used to determine what temperature the water boiled at, which is in turn used to infer the altitude at which cooking is being performed.

As another example, suppose that rice cooking is a cooking technique that is being performed. By detecting that a pressure pot or cooker is being utilized, the system is adapted to control temperature not only based on temperature measurements, but also pressure. Without the context of knowing the type of cookware being utilized, it would be difficult for the system to determine that pressure information can be utilized to determine such insights.

Further, other types of insights are unlocked or facilitated based on recognizing the type of cookware object being utilized. For example, by recognizing the type of cookware being used, the cooking system determines what applicable events to monitor for. Different types of cookware may be associated with different types of insights that can be monitored. In some embodiments, the available types of events that the system is configurable to monitor for, given the type of cookware, is included in the profile of the cookware.

As one example, by detecting that a pressure cooker is being utilized, the system can listen to acoustic sensors to determine sound signatures corresponding to certain cooking events or phases relevant to pressure cooking. This includes monitoring for acoustic signatures corresponding to the sound of steam escaping. The sound of steam escaping in the context of a pressure cooker indicates to the system that pressure is building. Further, other phases or events, such as boiling of water, or rolling boiling can be detected. Such cooking context about the state of cooking can be used to provide useful information to the user about the state of their cooking. Such cooking state information can also be used as context for cooking control algorithms, as will be described in further detail below.

As another example of cooking insights based on the context of the cookware object, suppose that a frying pan is recognized to be in use. The characteristic behavior of the pan (e.g., thermal behavior, acoustic behavior, temperature behavior, etc.) is used to implement browning level control detection. For example, by knowing that the current context is that browning is to be performed with a particular type of frying pan (context is a combination of selected technique and cookware type), the cooking system is adapted to monitor for signals in the raw sensor data that correspond to various levels of browning of the ingredient (e.g., percentage browning). In response to detection of a level of browning, the system performs various actions, such as heating control. As another example, the system provides prompts or selectable input options via the UI that are related to the context of browning with the frying pan. For example, the UI is driven to provide a notification that the content being browned (such as an onion) is at a certain browning level (e.g., 50% browning). The UI can also be driven to provide an option to the user to stop browning, or to continue browning. In this example, the user can select, via the UI, to stop browning, or to continue browning. If continuing browning, the user is also provided the option to select a browning level to stop at (e.g., 80%). The system is also configured to control heating to stop cooking when the browning level reaches the user-selected set point. As shown in this example, the cooking state (which is determined based on the context of the cookware being utilized) is used as context for both the user interface and heating control (further embodiments of which will be described below).

As yet another example, by accessing profile information pertaining to a recognized type of cookware and its properties, cooking state information pertaining to sauce reduction using a specific saucepan can be determined. For example, the weight of the cookware and sauce at the start of reduction is measured using the weight sensors of the cooking system. The weight of the cookware is accessed from the profile. The weight of the sauce at the beginning of the reduction is determined by subtracting the weight of the cookware. Over time, the combined weight of the cookware and sauce is monitored. By subtracting out the accessed weight of the cookware, the change in weight of the sauce is monitored over time. In this way, the amount of sauce that has been reduced is accurately monitored. Various UI information can be provided based on the monitored sauce reduction, such as when the sauce reduction level reaches a threshold percentage (based on weight measurements). For example, when sauce reduction reaches 50%, a notification can be pushed to the UI indicating that 50% reduction of the content (sauce) has been reached. In this example, the type of notification that was provided is based on the sauce reduction technique having been selected. The option to select sauce reduction as a technique was made available based on recognition of a saucepan. Further, the notification is based on the detecting a condition of foodstuffs (percentage reduction of sauce). The condition of the foodstuffs was also determined based on recognizing the cookware (so that the weight of the saucepan can be determined and subtracted from the monitored weight on the top plate over time to obtain the sauce weight).

The recording of time-varying weight measurements is also used by the system to track the number of ingredients or items that are being placed in cookware. For example, the change in weight is recorded over time. Step changes in weight that increase measured weight indicate the addition of ingredients into the cookware. Step changes corresponding to reduction in measured weight indicate the removal of ingredients from a cookware object. In other embodiments, removal of ingredients is determined by changes in the sound or acoustics that the food is making.

In some embodiments, each time a step increase in weight change is detected, a count of ingredient objects in the cookware is incremented. Each time a step decrease in weight is detected, the count of ingredient objects in the cookware is decremented. By accessing information about the weight of the cookware, weight changes due to user actions can be determined, which can in turn be used to infer other events (e.g., addition or removal of ingredients).

Other examples of user actions that are determined based on measured weight or mass changes and accessed information of the weight characteristics of the cookware include detecting of stirring, basting, flipping, etc. For example, each of the aforementioned user actions is associated with a corresponding pattern or signature of weight change or fluctuation over time. As one example, when stirring, a pan is pushed. From a weight sensor perspective, the cookware appears transiently heavier at one moment, and then less heavy at a next moment. As another example, when flipping, the measured mass decreases then increases again. Flipping can also be detected based on a change in acoustic signature over time. As another example, flipping is detected based on a signature of temperature changes. For example, when an ingredient is flipped over, the colder side of the ingredient is now in contact with the cookware surface. This will result in a temperature drop in the cookware. The drop in measured temperature of the cookware is used to detect the flipping of the ingredient. In various embodiments, signals from multiple sensors are combined to determine whether a user action has occurred. For example, flipping is detected based on detecting a particular signature of weight changes combined with detecting of drop in temperature within a window of time. That is, the triggering of detection of a certain type of event during cooking can be based on a variety of sensor readings over time.

In some embodiments, detection of user actions is used to further control power delivery to the induction coils. For example, existing induction burners shut off the power when the cookware is not detected. Shutting power off too quickly and abruptly could confuse the user when the user moves or tilts the cookware for certain cooking routines, such as basting or stir frying, and is not intending to stop heating. In some embodiments, when it is detected that the user is performing an action with the cookware that would at least partially remove the cookware from the induction cooking system (e.g., basting, deduced based on detecting a pattern of weight change over a window of time corresponding to basting with the cookware being identified), the induction coil continues to be driven, even if a pan is lifted at an angle.

Other types of information pertaining to the condition of ingredients or foodstuffs being cooked can also be deduced based on accessing information pertaining to the characteristics of the cookware. For example, the thermal mass of what is on the induction cooking system (cookware plus the ingredient) is measured. From the cookware profile, the thermal mass of the cookware is determined. Information pertaining to the content in the cookware is deduced based on the overall measured thermal mass and the accessed thermal mass of the cookware itself, along with temperature measurements.

As another example, the position of the ingredient within the cookware object is detectable. In some embodiments, the cooking system also includes a temperature sensor below the plate that is away from the center temperature probe. For example, one or more temperature sensors are located at the circumference of the top plate. The temperature measurements from both the center probe and the outer probes are combined to determine a cookware temperature distribution. In this way, the system determines the distribution of heat across the bottom surface of the cookware. The distribution of heat is influenced by the position of the ingredients within the cookware. The position of the ingredient is then determined based on the measured distribution of heat, as well as characteristics of the cookware, such as its size, its temperature evenness, etc. For example, given a certain amount of heat (based on the amount of power put into the induction coil), an expected thermal distribution for the cookware without any ingredients is obtained (e.g., included in profile based on characterization of thermal distribution of empty cookware). Differences between the measured thermal distribution of what is on the plate and the expected thermal distribution of the cookware (without any ingredients) are used to deduce the position of the ingredients within the cookware. Updates to the UI can be provided based on the ingredient position. For example, if the ingredient is not in the center of the pan, the UI is updated to include a notification that the ingredient is off-center. A suggestion can also be provided to move the ingredient to the center so that it will be more evenly heated. In this example, the system accesses and integrates a variety of information to deduce information about the ingredients in the cookware, such as the amount of energy being supplied to the induction coil, the measured thermal mass, measured thermal distribution of the cookware, as well as the expected distribution of heat in the cookware (which is known based on recognition of the identity of the cookware being used).

As yet another example, the doneness of content (foodstuffs or ingredients) being cooked is another example of cooking state information that is monitored, and which can be used to trigger updates to the user interface. For example, based on the context of a pancake pan being detected, the system adapts its monitoring logic to monitor for certain events that are relevant to the pancake pan, such as detecting whether the pancakes in the pan have reached a desired level of doneness. For example, the patterns of sensor measurement values corresponding to different levels of doneness are maintained in the profile for the cookware. The system loads the events to be monitored from the profile. The corresponding sensor measurement signatures corresponding to the different types of events to be monitored are also obtained from the cookware profile. In some embodiments, the available doneness levels that a user can select from are also determined based on the context of the pancake pan being utilized.

Detection of ingredient state can be used to drive the contextual user interface. For example, suppose the user is using the cooking system to facilitate automating a pancake making recipe. After a certain level of doneness, the user interface is to prompt the user to flip the pancake. Using embodiments of the techniques described herein, the pancake doneness is monitored. When the pancake doneness is detected to be at a certain level (according to the recipe being automated), the system progresses to a next step of the recipe and commands the user interface to issue a prompt to the user to flip the pancake. After the system detects that flipping has occurred (by identifying a corresponding pattern of weight change, as described above), the system moves to a next step of a programmatic recipe transcription.

Another example of state information that the system monitors for is the addition of ingredients and their types. For example, as described above, the addition of ingredients is determined based on changes in measured weight on the plate of the induction cooking system. Sensor information can be used to differentiate between the types of content that have been added. For example, different types of content, when heated, would result in certain measured thermal and acoustic signatures. Such thermal signatures are monitored for to determine whether the events corresponding to the thermal signatures have occurred. By performing signal processing on the various sensors, the addition of different types of ingredients can be detected by the system and used to provide feedback to the system with respect to the cooking process.

Another example of cooking state monitoring includes monitoring for burning of ingredients based on sensor measurements (e.g., identifying pattern of sensor measurement values that corresponds to a signature of burning ingredients). Another example of cooking state monitoring includes safety monitoring and monitoring for unsafe conditions. As one example, suppose it is determined that a multi-cooker is being utilized with the cooking system. The cooking system is configured to monitor for certain sensor signals that together are indicative of unsafe usage of the multi-cooker (e.g., specific conditions, such as pressure-related conditions that are specific to the multi-cooker).

Other types of checks are facilitated via the context aware cooking state and event monitoring. For example, in the example of the multi-cooker, suppose that the rice cooking technique has been selected and is being performed. The system is configured with logic that monitors the onboard sensor measurements and synthesizes various sensor signals to determine whether specific types of events relevant to rice cooking using a multi-cooker have occurred (where the types of events to be monitored are determined based on the context of the recognized cookware and/or the technique being used). In some embodiments, different types of events are associated with different sensor signatures. A sensor signature is determined as a function of one or more sensor readings, which may be aggregated over time. In some embodiments, the manner in which sensor readings are combined to determine the presence of a specific type of cooking event or state is customized for a specific type of cookware. As one example, the system is configured with an acoustic signature of rice cooking when using the multi-cooker. If there is a deviation in the measured acoustics from the rice cooking acoustic signature, the UI is updated to provide a notification to the user indicating that there is a potential issue with rice cooking. A recommendation to check cooking settings is also provided. In this way, the system also performs validation and checking of the cooking session based on recognition of the type of cookware being used.

The following is another example of safety monitoring. One example type of potentially unsafe event that the system monitors for is whether an empty cookware is being heated. As described above, by accessing the weight of the cookware (e.g., from the profile for the cookware), the system determines whether there are any ingredients in the cookware. If the heating has been on for a threshold amount of time (by monitoring how long the induction coil has been active, etc.), the temperature of the cookware is running away (based on temperature measurements over a window of time), and the measured weight on top of the plate is close to the weight of the cookware (indicating that there is little to no content in the cookware), then this is indicative of an empty cookware being heated. In response to detection of such an unsafe condition, the UI is driven or controlled to provide an alert or notification of the detected unsafe condition. In some embodiments, the system also controls power to the induction coil to turn the coil off.

The following is another example of safety monitoring. Many people use stainless steel trays. However, such trays may not be for cooking. In some embodiments, in response to detecting such a type of cookware that should not be heated (e.g., based on spectral analysis using the induction coil), the system prohibits the induction coil from turning on, thereby preventing the tray from being inadvertently heated up.

As shown in the example of FIG. 15A, another sensor usable by the system is an external temperature probe, which can be connected with the cooking system either wirelessly (e.g., over Bluetooth) or with a wired connection (e.g., USB-C connection). The probe may be powered via a wired connection, battery powered, etc. The external probe can be used to provide a direct temperature measurement of the internal temperature of an ingredient. Such information is usable to provide fine-grain control over cooking processes such as sous-vide.

As shown in the example of FIG. 15A, various acoustic sensors (such as microphones in contact with the cookware, air-gapped, etc.) can be used to detect acoustic signatures of what is occurring during the cooking session.

As shown in the example of FIG. 15A, sensor data associated with the induction coil can also be utilized to determine various insights of cooking state. One example of such insights derived from induction-related sensor measurements includes the amount of heat/energy supplied from power level measurements. Further, material properties, cookware recognition, cookware thermal properties, cooking state (e.g., boiling or other time-varying change from evaporation or food cooking) are determined from impedance measurements. Material properties, cookware recognition, and cookware thermal properties can also be derived from operating frequency measurements.

As shown in the above examples, the cooking system listens to various sensor measurements to determine a cooking state context, and reacts to various cooking event information by driving the user interface to provide relevant context to what is occurring during a cooking session. Further, the processing of raw sensor data in the context of the cookware being utilized facilitates the identification of relevant signals that are used as feedback throughout the system, such as the user interface and induction control. The integration of the cookware profile information, onboard sensor measurements, user interface, and control algorithms facilitates various complex functionality.

Another example of information and measurements that the system utilizes to determine insights is measurements or interaction data of the dial interface itself. For example, insights such as user intent are determined by the system from user inputs and interactions with the centralized user interface. For example, via the integrated user interface, the system determines what levels the user has set, whether they have adjusted any setting levels, etc. What cooking technique the user has selected is also determined by the system, which, as described above, is used as context for the system in determining how to control heating parameters of the system, for determining what types of events or state to monitor for, etc. For example, if the user selects the “toasting” cooking technique via the user interface, then the system is adapted to monitor for events pertaining to toasting (rather than, say, monitoring sensor data for water boiling, which is unlikely when toasting). By inferring user intent from detected user inputs via the user interface, the characteristics of the cookware being used, and the various other measurements described above, the system achieves greater accuracy and insight into the cooking environment, facilitating various adaptations that the cooking system can make to improve the cooking experience.

FIG. 15B illustrates examples of cooking insights derived from user interface measurements. As described above, the dial or user interface is another example of a sensor, which in this case, senses settings provided by the user. Various insights can be determined from user interactions, as shown in the example of FIG. 15B.

The following is another example of deriving user intent. As shown in the example profile information of FIGS. 14A and 14B, for a given type of cookware and cooking technique, operational temperature settings such as temperature pre-sets and temperature ranges are specified. Suppose that the user is selecting the toasting cooking technique. The system, based on the profile information shown in the example of FIG. 14A, sets the temperature to the pre-set temperature of 284 degrees Fahrenheit. Now suppose that the user adjusts the temperature via the user interface to be higher or lower. The system monitors the desired user input to determine whether it is within the allowed temperature range given the context of the type of cookware being used and the technique being performed (according to the temperature range information for the technique using the pan, as specified in the pan's profile). If so, then the user adjustment is permitted, and the heating control is adjusted according to the user input. If the user adjustment is out of bounds, then the system reacts in response, such as by limiting the amount of adjustment to be within the temperature range, notifying the user via the UI that the adjustment is beyond the (suggested) temperature range for this technique with this cookware, etc.

In some embodiments, the user can enter a manual mode of cooking. In some embodiments, when in manual mode, the system provides the user with default, cookware-agnostic options or settings for manual control, such as “low,” “medium,” or “high,” where each setting is associated with a temperature range. For example, the options are determined based on the profile information shown in FIG. 14D.

In some embodiments, the cooking system is used in conjunction with an external device, such as a mobile device (e.g., smartphone, tablet, etc.). In some embodiments, an external camera device is used that can be positioned at a certain distance and/or angle to be able to view the contents of the cookware. As another example, the camera is an external device included in the range hood, above the cooking device.

The external device may be connected to the cooking device via a wired (e.g., USB-C) or wireless connection (e.g., Wi-Fi, Bluetooth, etc.). The external device may include a variety of sensors, such as a microphone, camera, etc. In some embodiments, such as when the external device is a mobile device such as a smartphone, a companion app is installed on the external device for use in conjunction with the cooking device.

FIG. 15C illustrates embodiments of insights and applications determined from measurements/data collected by the external mobile device. For example, camera measurements can be used to determine user actions with respect to ingredients, such as stirring, basting, flipping, adding, removal, etc. Camera measurements can also be used to perform ingredient recognition, ingredient size determination, cooking state detection, etc. Acoustic measurements can be taken using the microphone of the external device and used to also determine events that are occurring during cooking. In some embodiments, usage of the companion app can be used to determine user inputs and intent, as well as other information such as technique selection.

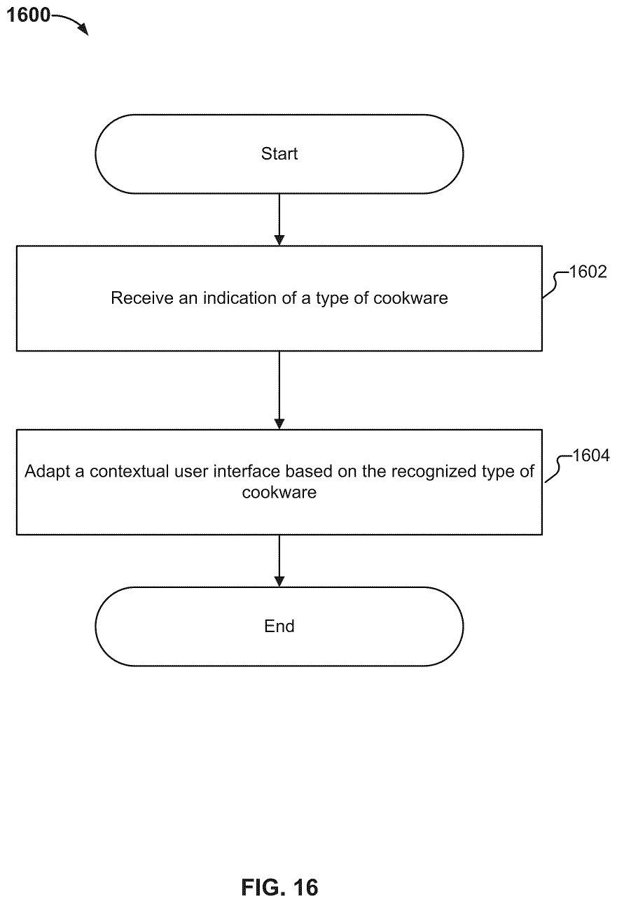

FIG. 16 is a flow diagram illustrating an embodiment of a process for providing a contextual cooking user interface. In some embodiments, process 1600 is executed by contextual UI engine 1308. The process begins at 1602, when an indication of a type of cookware is received. For example, a presence of the cookware is detected. In some embodiments, an induction coil is used to detect the presence of cookware. As another example, a change in weight detected by a weight sensor of the system is an indication that cookware is present. The type of the cookware (that is in the presence of the cooking system) is recognized. In some embodiments, the type of cookware is recognized through the use of tags, such as NFC or RFID tags embedded or otherwise coupled to the cookware. The cooking system includes a reader for reading the identifier tags of the cookware. In some embodiments, proximity of such tags indicates their presence. As another example, the cooking system uses sensors to characterize the cookware, where the cookware is identified based on the characterization of the cookware. For example, the cookware may be probed or measured using various sensors or components such as weight sensors, temperature sensors, acoustic sensors, induction coils, etc. A signature or fingerprint for the cookware is determined as an identifier of the cookware.

A profile of the cookware is accessed. For example, the profile is obtained from a tag embedded with the cookware (and used to recognize the cookware). As another example, an identifier is obtained from cookware recognition. A lookup using the cookware identifier is performed to obtain the profile of the cookware. As another example, the sensor signature of the cookware is used to perform a lookup of cookware signatures to identify the particular cookware that is being used with the system. As another example, the sensor signature is used as a key to identify a matching record that includes the corresponding profile for the cookware. In some embodiments, multiple types of cookware are registered with the cooking system or a remote entity with which the cooking system communicates (to obtain or access the profile of the characteristics of the cookware).

At 1604, a contextual user interface is adapted based on the type of cookware. For example, a contextual user interface of the cooking device that the recognized type of cookware is being used in conjunction with is adapted based on the recognized type of the cookware. As one example, the user interface of the cooking system is adapted based on user interface configuration parameters associated with the recognized cookware (e.g., included in the cookware profile). User interface configuration parameters include menu configuration parameters specific to the cookware. Menu configuration parameters include the structure of menus (which may include sub-menus), available options in the menus, etc. Another example of user interface configuration parameters includes guidance parameters that determine what information is presented during recipe or technique guidance, as well as the conditions under which the user interface updates.

In some embodiments, the contextual user interface is presented on a display that is separate from the cookware. In some embodiments, the display is integrated with the cooking system. In some embodiments, the display is a centralized display that provides appropriate information according to the type of cookware that has been recognized. One example of adapting the contextual user interface based on the type of cookware includes determining permitted cooking techniques available when using the type of cookware. In some embodiments, only those cooking techniques determined to be permitted for the type of cookware are presented as selectable options in a technique selection menu in the contextual user interface. In some embodiments, the available cooking techniques for selection are limited to those that are designated as permitted for the cookware.

As described above, in some embodiments, the context-aware user interface configuration is performed by accessing profile information pertaining to the cookware. For example, each different type of registered cookware is associated with a profile. The system behaves according to the cookware profile corresponding to the cookware. In some embodiments, the contextual user interface is driven based on the detection of certain events, such as the occurrence of detected user actions, cooking operations, or user inputs. For example, the detection of certain events triggers the presentation of certain information, as well as the available input options in the contextual user interface. In some embodiments, the parameters for determining when events are detected are dependent on, or otherwise based on, profile information pertaining to the recognized cookware.

In some embodiments, the contextual UI is updated based on detection of trigger events. In some embodiments, the trigger events used to update the contextual UI are based on the type of cookware that has been recognized. In some embodiments, the parameters (e.g., patterns of measurement values) for detecting a trigger event are based on the type of cookware that has been recognized. In some embodiments, what information is presented in updating the UI in response to an event trigger (e.g., prompts to provide) is based on the type of cookware that has been recognized. For example, the user interface is updated according to the detection of state or events associated with cooking being performed. The cookware-specific profile information described herein (e.g., thermal characteristics, weight characteristics, induction coil response characteristics, etc.) facilitates more accurate control of a cooking routine, such as by utilizing cookware profile information to detect a phase of the cooking routine that a user is currently in, deducing information about the ingredients or content being cooked (e.g., by subtracting out contributions of the cookware from sensor measurements to determine properties of the content being cooked), detecting user actions or interventions (e.g., flipping, basting, stirring, etc.).

In some embodiments, the contextual user interface is adapted to present customized programs or customized cooking techniques that are linked to a specific type of recognized cookware.

Another example of a contextual user interface that can be provided based on determination of cookware type is maintenance guidance interfaces. For example, for different detected types of cookware with different material properties, different maintenance information can be provided. For example, if a carbon steel pan is detected, the contextual user interface is configured to present maintenance guidance relevant to the carbon steel pan, such as providing instructions on how to season the carbon steel pan.

Other examples of functionality performed according to the profile of the recognized cookware include auto-taring (e.g., based on weight information included in the cookware profile) to determine the weight of ingredients.

As described above, the contextual user interface can also be adjusted to provide options for manual mode control. As described above, the universal interface controls, based on detecting a presence and type of cookware, what type of inputs the user can provide (e.g., available options that a user can select from), and what types of information are provided as output by the interface.

### Temperature Control Based on Identified Cookware

In addition to providing a contextual user interface, as described above, where the context is provided by the specific cookware that is recognized as being utilized, the heating element of the induction cooking system is also controlled according to the type of cookware being utilized. For example, the system adapts how it interacts with the cookware to achieve various results, such as certain temperatures. The manner in which the system adapts its interaction with the cookware is based on the detected type of the cookware. For example, to achieve a certain temperature, the system will have to adapt differently (e.g., via different ways in controlling the induction coil) for different types of cookware.

In some embodiments, the cookware profile for a certain cookware includes thermal properties of that cookware. In some embodiments, the system utilizes such thermal characteristic information specific to a cookware to determine how to control the system (e.g., its induction coils) to control how the cookware is heated. This allows fine grain temperature control, improving performance. As will be described in further detail below, in some embodiments, such heating element control includes precise controlling of power to effect accurate control of the temperature of the cookware, based on recognizing the cookware itself.

Existing induction burners do not have the ability to understand what cookware (e.g., pan) they are working with, and what the characteristics of the cookware are. Because of this lack of understanding of the cookware, existing induction burners make estimations as to how the performance of the induction burner is to be driven to heat up or control the temperature of the cookware. For example, existing systems may drive their induction coil in the same broad way to account for any type of cookware that might be used.

Making such estimations results in various cooking issues, such as largely overshooting any desired temperature targets. This is due to the high variability in the construction of different types of cookware, and even in different instances of the same cookware, such as due to differences in quality of whether or not they are fully laminated or delaminated. This variation in cookware creates a large error band that induction burners attempt to deal with.

In the context of induction heating, as heat is generated in the cookware, using different cookware on the same induction burner will produce different levels of heating behavior (e.g., temperature increase) for the same input power. Existing induction burners are unable to determine how to control the power to achieve a desired temperature, as they are not able to determine the temperature impact on the cookware given the amount of power provided. That is, there is a disconnect between the power used to drive the induction coil, and its impact on temperature of the cookware and its contents.

This results in errors between the actual resulting temperature and the desired temperature, such as the actual temperature of the cookware greatly exceeding or overshooting the desired cookware temperature (e.g., 20%). Other existing types of heating systems, such as radiant heating systems (e.g., gas stoves), are also difficult to control in an accurate manner to achieve or maintain a desired temperature in a consistent manner across the diversity of cookware that may be utilized. Such temperature control issues are further exacerbated by induction stoves, where there is no physical expression of temperature (e.g., as in the color of the flame of a gas stove, or the heat in the air surrounding the pan), as heat is generated within the cookware when using an induction stove, and there is no visual indicator of how hot the cookware is.

Using the closed-loop heating control techniques described herein, issues with existing induction burners, such as temperature overshoot and ripple when holding temperature, are addressed. For example, in induction cooking, power applied to the induction coil is converted in the cookware into heat through eddy currents that are generated. The amount of heat that was converted from the applied power is related to the temperature that the cookware is at. By having access to the characteristics of the cookware, control loop parameters such as PID coefficients can be accurately set so that the cookware can be heated to the desired set point as quickly as possible (e.g., as high a rate as possible), without overshoot.

Cookware recognition allows the burner to deliver power in a manner that is customized to the cookware, where different power-heating profiles are applied for different cookware. Further, for the same cookware, different control loop parameters are used under different conditions, such as different types of desired temperature control or adjustment. The crossover points at which the system updates its parameters are also customized to the type of cookware being utilized. In this way, even when the user switches cookware, consistent and accurate temperature control is provided.

As one example, by having knowledge of the specific cookware being used and accessing its characteristics, the induction coil can be driven to reach a desired temperature without overshoot. Further, the desired temperature (e.g., temperature setpoint) can be reached quickly and efficiently (which is desirable in the context of cooking) without overshoot. Further, by accessing information regarding the characteristics of the cookware being used, the heating controller is capable of high temperature accuracy, such as providing sub-degree temperature precision, such as when holding the cookware at a specified temperature. In some embodiments, such accurate temperature control is facilitated by a closed-loop heating controller that takes into account characteristics of the cookware being utilized, as well as feedback from various onboard sensors of the cooking system. For example, by having access to characteristics of the cookware, and also having sensor measurements that indicate what is occurring with the cookware, the closed-loop heating control techniques described herein control power to the induction coil in a manner that provides accurate temperature control, and also allows cookware to be quickly heated up to a desired temperature without the temperature of the cookware overshooting that desired temperature. For example, using knowledge of (or otherwise determining, such as in a calibration tuning phase, further details of which are described below) the thermal properties of the cookware, improved temperature performance can be achieved, one example of which is reducing overshoot, which is an issue with existing systems that do not have knowledge of the properties of the specific cookware being used, and thus have a more general operating window to accommodate the uncertainty in the cookware object being used. In contrast, the cooking system described herein can provide targeted, bespoke temperature control based on detection of the cookware (and its thermal properties).

Further, as described above, the cooking system is integrated with various onboard sensors. Such sensors include those relating to the induction coil, and are usable to provide measurements such as actual power level, impedance, and operating frequency. By also having access and knowledge of the properties of the cookware, the closed-loop system described herein has improved accuracy in the amount of power that is being supplied, the efficiency of the conversion of the power (by knowing heat measurements via integrated temperature sensors, the thermal properties of the cookware, etc.), etc.

As described above, compared to existing cooking devices, embodiments of the closed-loop temperature control techniques based on cookware recognition described herein provide improvements to heating control, such that high temperatures can be quickly reached with little overshoot, and temperatures can be maintained with high precision and little variation.

While embodiments involving induction coils as the heating element being controlled are described herein for illustrative purposes, embodiments of the closed-loop temperature control techniques described herein may be variously adapted to accommodate any other type of heating element (e.g., radiant heating such as gas stoves), as appropriate.

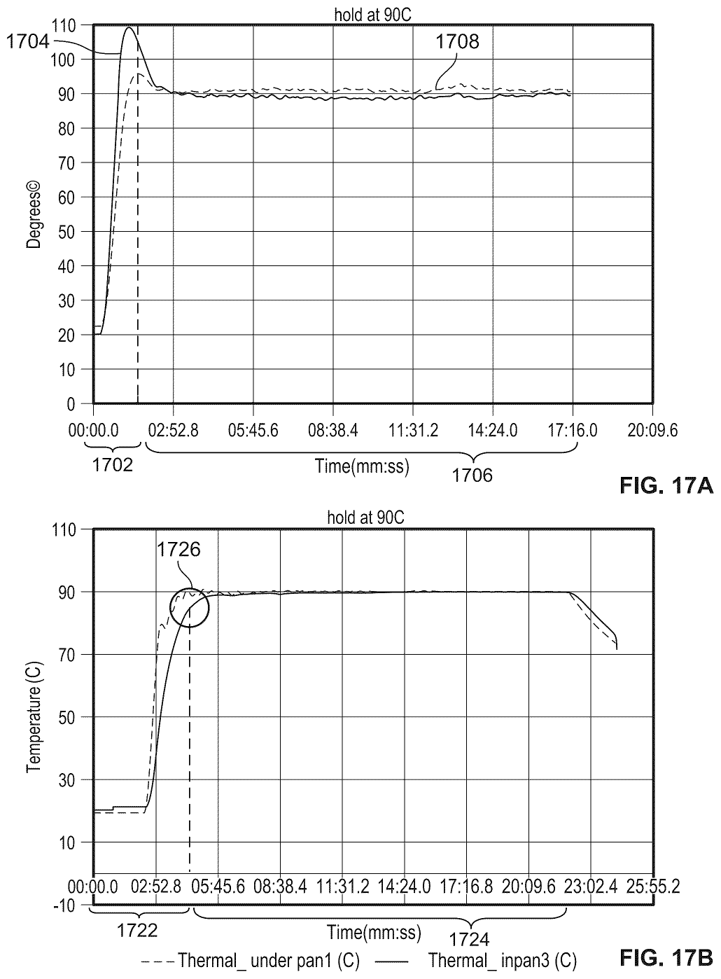

FIGS. 17A and 17B illustrate embodiments of cookware temperature behavior. In the examples shown in FIGS. 17A and 17B, heating of the same pan using two different induction cooking systems is shown. In this example, two induction cooking systems are used to perform pre-heating of a pan from cold up to a set point temperature, and then holding of the temperature of the pan. In this example, temperature control improvements provided via the closed-loop heating control techniques described herein are shown at FIG. 17B, relative to an existing system as shown in FIG. 17A.

FIG. 17A illustrates an example of cookware temperature behavior when preheating and holding temperature. In this example, heating control using a single fixed set of control parameters that is not optimized for the cookware is shown. In this example, when preheating the pan up to the desired temperature of 90 degrees Celsius during preheating phase 1702, the existing system exhibits overshoot, as shown at 1704. Further, when attempting to hold temperature at 1706, the actual cookware temperature exhibits variation and ripple as shown at 1708, where the actual cookware temperature fluctuates about the desired 90 degrees C. set point. The inaccurate temperature control results in pre-heating overshoot, as well as temperature holding variation in both the bottom of the pan (which is closest to the induction coil), and the surface of the pan (on which ingredients are cooked). There will be a delay between the temperature of the surface and the bottom of the pan due to intervening material thickness.

FIG. 17B illustrates an example of cookware temperature behavior when preheating and holding temperature using cookware recognition. In contrast to the example of FIG. 17A, using the closed-loop control techniques described herein, improved pre-heating is provided. For example, during pre-heating phase 1722, no overshoot is exhibited. Further, during the pre-heating phase, the cookware temperature is brought up to the set point temperature quickly (and faster as compared to the example of FIG. 17A) while still having little to no overshoot, where the ability to quickly bring cookware temperature is a desirable property in the context of cooking. For example, while pre-heating without overshoot could be achieved by slowly heating up the cookware, such slow heating can be less desirable when cooking.

Continuing with the example of FIG. 17B, as shown, when using the closed-loop control techniques described herein, during temperature holding phase 1724, the 90 degree C. temperature is maintained with greater precision and less variation as compared to as shown at 1708 of FIG. 17A.

As shown in the example of FIG. 17B, using the temperature control techniques described herein, not only is there no overshooting in the preheating phase, but after the temperature is reached, there is little ripple or wiggle in the cookware temperature. This is an improvement to existing systems such as that shown at FIG. 17A.

In some embodiments, the closed-loop control techniques described herein utilize closed-loop control parameters that are specific to, or otherwise correspond to, the type of cookware that is being used. For example, a PID controller is used to control the power delivered to the induction coil. Different PID control parameters are used for different types of cookware. Further, a single type of cookware may have multiple associated sets of control parameters. In some embodiments, the different sets of control parameters are used for controlling the induction coil for different phases of heating or for different operating conditions or functions (e.g., pre-heating quickly, holding temperature accurately, etc.). In some embodiments, transition points are determined for switching between one set of PID parameters and another set of PID parameters, or for otherwise updating PID parameters. In some embodiments, the crossover points for updating or changing PID parameters are cookware dependent.

As described above, the improved temperature control provided by the techniques described herein is facilitated by using different control parameters for different contexts and conditions. For example, different sets of control parameters are used for different types of cookware, different types of functions or actions to be performed, or both (e.g., combined condition of performing a specific action using a specific type of cookware).

For example, rather than having a single or fixed set of control parameters according to which the temperature control operates that is applied for all conditions (e.g., for both pre-heating and holding temperature), the system detects the occurrence of certain conditions, and then adapts its control parameters (which control how the system drives the induction coil given a computed difference between a set point temperature and a measured, actual temperature) to the detected conditions.

Referring again to the example of FIG. 17B, the system divides the heating shown into two different types of actions. For example, the first portion 1722 of the heating is segmented as a pre-heating phase, in which a pan is to be brought up from an initial cold state to a desired set point temperature. A second portion of heating is shown at 1724, which is a holding phase. Here, after the pan has been brought up to the set point (pre-heating is complete), the control system is operated to maintain or hold the temperature of the cookware at the set-point.

Using multiple sets of control loop parameters to provide temperature control for different types of actions or contexts or desired modes of heating (pre-heating and holding in this example) facilitates driving of the induction coil (applying power to the induction coil) in a manner that is optimal for the given cooking context. The use of multiple control loop parameters for different conditions provides an improvement over using a single, generic set of control parameters that is applied regardless of what is occurring. For example, suppose a set of control parameters that is optimized for boiling of water. If this set of control parameters were also used for pre-heating, this could result in overshooting of cookware temperature, as shown at 1704 of FIG. 17A. Further, if this same set of control parameters (that is tuned for boiling water) were also used for holding of temperature, this could result in ripple and greater variation about the set point, as shown at 1704 of FIG. 17A.

As shown in the example of FIG. 17B, when pre-heating, the control loop is adapted to use a set of coefficients that is optimal for pre-heating, which includes control loop parameter values that build cookware temperature up to the temperature set point as quickly as possible, while reducing the possibility of overshoot. When it is detected that the system should go into a holding mode, the control loop is adapted to use a different set of control loop coefficients that is optimal for keeping the measured temperature within a narrow band about the desired set-point. In some embodiments, scheduling is performed to determine cross-over points at which the control loop switches from using one set of coefficients to another set of coefficients, or to otherwise update the temperature control loop coefficients that are being used. In some embodiments, the cross-over points are cookware-specific. As one example, in FIG. 17B, the cross-over point 1726 for switching from pre-heating control coefficients to holding control coefficients is determined based on the specific cookware being utilized, which aids in reducing undesirable effects, such as overshooting. In some embodiments, and as will be described in further detail below, the transition from control loop parameters for quickly closing the delta to the setpoint temperature, to control loop parameters for maintaining a desired temperature is based on the delta, or how far off, the actual temperature is from the desired temperature.

Further details regarding condition-dependent control loop parameter determination, and cross-over point determination are described in further detail below. Using the techniques for temperature control with adaptive control loop parameters, heating element control is optimized based on the cooking context, such as recognition of the cookware being used, and the current desired heating mode.

The adaptive temperature control techniques described herein are an improvement over existing systems. For example, by integrating control of the heating element with information about the cookware, as well as feedback from integrated sensors that is processed in the context of the known cookware, a closed loop control system is provided that facilitates improved accuracy and control in the cooking process as compared to existing types of cooking systems.

For example, existing induction cooking systems are open loop, and do not integrate information about what is happening to the cookware (in which the heat is being generated) or the ingredients being cooked. This makes it challenging to control existing cooking systems to achieve desired cooking results.

For example, in existing induction cooking systems, properties of the cookware being utilized are not known, and existing induction systems will apply the same settings to different cookware. However, in induction cooking, there is a greater dependency on the type of cookware being used (as the heat is being generated in the cookware itself). This results in different or unpredictable heating and cooking performance with existing induction cooking systems, as they do not compensate for the different properties of different cookware (which may have differing efficiency in generating heat, where one pan generates heat much more quickly than another pan).

This use of a single, fixed set of control parameters by existing systems, regardless of cookware or the operations being performed, is insufficient for accurate temperature control given the variation that can occur in cooking. As one example, suppose one scenario in which an empty pan is being heated, and another scenario in which a pot of water is being heated. With the empty pan, because it will heat up and cool down quickly, the power to the induction coil should be cut off sooner. In the case of heating a pot of water, because of the water also taking energy from the pot, power would need to be applied to the induction coil in a manner that is different from when heating the empty pan, in order to reach a desired temperature set point quickly. In existing systems, which do not have intelligence as to what is occurring (e.g., what cookware is being used, what ingredients are being heated, etc.), a single, fixed set of control parameters would be used for both scenarios. As one example, the fixed set of control parameters may be tuned for the boiling of water. However, the use of these boiling water-tuned parameters is insufficient or otherwise non-optimal for accurate temperature control of pre-heating of the empty pan.

By dynamically utilizing different sets of PID coefficients that are configured to different types of cookware and cooking conditions, more accurate temperature performance can be achieved compared to existing systems. For example, using the techniques described herein, temperature control loop parameters such as PID coefficients are set based on knowledge of the specific cookware being heated, facilitating the ability to have a much flatter response over time (e.g., without ringing or ripple).

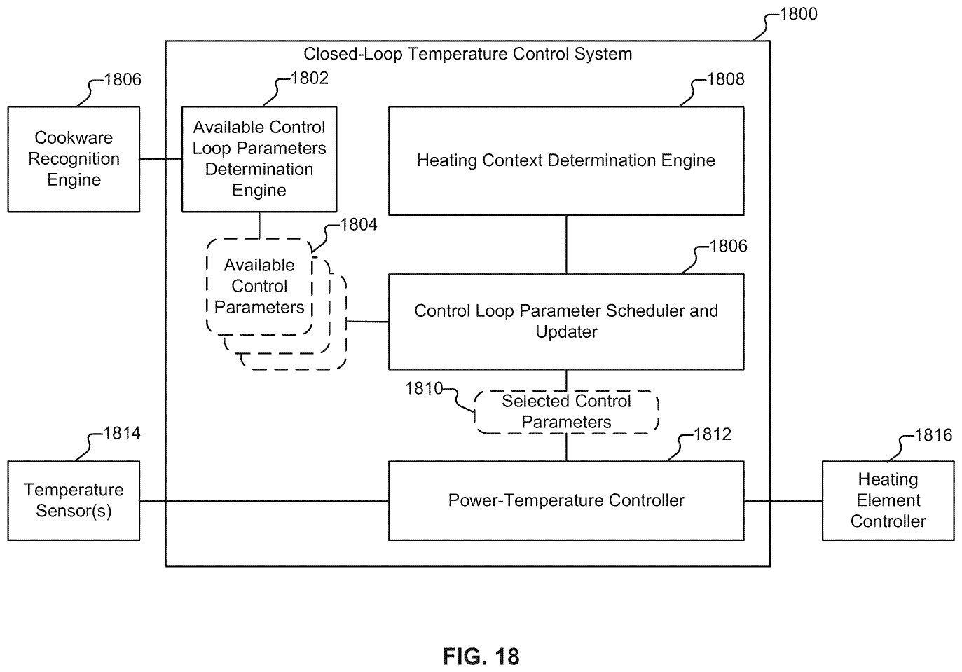

FIG. 18 illustrates an embodiment of an adaptive closed-loop temperature control system. In some embodiments, closed-loop temperature control is executed by system controller 304.

In some embodiments, available control loop parameters determination engine 1802 is configured to determine available control loop parameters. The available control parameters 1804 include control parameters usable to control a heating element to control the temperature of cookware in various operating contexts and modes.

In some embodiments, the available control loop parameters include control parameters that are specific to recognized cookware that is being used in conjunction with the cooking system. For example cookware recognition engine 1806 is configured to recognize or identify a cookware object that is being utilized (e.g., on the plate of the induction cooking system). Examples and embodiments of recognizing cookware are described above. A cookware profile corresponding to the recognized cookware is accessed. In some embodiments, the cookware profile includes control parameters that are customized or specific to the cookware that are usable in various operating contexts or heating modes. In some embodiments, control loop parameters engine 1802 accesses the cookware-specific closed loop temperature control parameters from the profile corresponding to the recognized cookware, and includes them in available control parameters 1804.

In some embodiments, the available control loop parameters 1804 include cookware control loop parameters that are used for different heating modes, but are applicable to multiple types of cookware.

In some embodiments, the available control loop parameters 1804 further include transition or crossover parameters. In some embodiments, the crossover parameters are used by the temperature control system to determine when to update the control loop parameters that are in use. For example, if the temperature system is switching from pre-heating to holding mode, the point at which the temperature controller switches from using pre-heating control parameters to holding control parameters is determined according to a crossover parameter. In some embodiments, the crossover parameters that are used to facilitate transitioning between temperature control loop parameters are cookware-specific and customized to properties of the cookware.

As one example, the control loop parameters include PID (Proportional-Integral-Derivative) coefficients, as well as scheduling coefficients (for determining when to use some set of PID coefficients).

The following is one example of available control parameters 1804. Suppose a specific type of frying pan is identified or recognized. In some embodiments, a set of holding control parameters specific to the pan is retrieved from a profile of the recognized pan. In some embodiments, the holding control parameters usable to maintain the actual temperature of the pan at a desired target temperature are a nominal set of control parameters that are used by default. In some embodiments, a set of pre-heating control parameters is obtained. The pre-heating control parameters may be cookware-specific and obtained from the cookware profile. In other embodiments, the temperature control system is pre-configured with pre-heating control parameters that are applicable to all cookware. In this example, the control loop parameters determination engine 1802 is also configured to obtain a crossover or transition parameter/threshold from the profile corresponding to the recognized cookware. For example, the crossover threshold is used to determine when to update the parameters of the temperature controller from pre-heating parameters to holding mode parameters. The crossover threshold is customized for the specific type of cookware in this example. The available control parameters 1804 can include various other control parameters for use in other operating contexts, as well as crossover parameters for determining or transitioning between parameters for different operating contexts.

In some embodiments, the available control parameters 1804 are provided to control loop parameter scheduler and updater 1806. Scheduler 1806 is configured to determine the set of control parameters to use in the temperature control loop. In some embodiments, the set of control parameters that is selected is determined based on available control parameters 1804, as well as the heating context (e.g., what type of heating control mode is to be utilized, such as mass-driven, temperature delta-driven, cooking technique-driven, holding, etc.). For example, control-loop parameters are updated as a function of time or operating context.

In this example, heating context determination engine 1808 is configured to determine what type of cookware heating profile or mode that the temperature control system should operate in. As will be described in further detail below, examples of changes in cooking context that would change or trigger how temperature is controlled include changes in mass, selection of a particular technique, and/or a desired delta to be closed. Further examples and embodiments of heating profiles and operating modes are described below.

In some embodiments, if the scheduler 1806 determines that the control loop parameters are to be updated (e.g., based on change in operating mode or desired heating profile), the scheduler updates or changes the control loop parameters to a selected set of control parameters. As will be described in further detail below, the control loop parameters to use are driven based on mass, temperature delta, and/or technique selection. In some embodiments, the control loop parameters that are determined for use are optimized for the cookware being utilized. The updating is performed according to a crossover or transition threshold that is optimized or specific to the recognized cookware. In this way, the temperature control loop can be adjusted by varying the PID coefficients of the control loop over time based on detection of various conditions, where the PID coefficients are also optimized for a specific type of cookware being used.

In some embodiments, the updated control parameters 1810 are provided to power-temperature controller 1812. In one embodiment, the control parameters are PID (Proportional-Integral-Derivative) coefficients, and the power-temperature controller 1812 is a PID controller.

In some embodiments, the selected coefficients are plugged into the PID controller to produce an accurate cookware temperature outcome. For example, the set of coefficients define how the controller 1810 will react or respond (e.g., determine how much power to apply to, or otherwise drive, the induction coil) based on the difference between the set point and the measured temperature (proportional response/gain term), the sum of the difference between the set point and the measured temperature over time (integral response/gain term), and the rate of change of the measured temperature or the difference between the set point and the measured temperature (derivative response/gain term). That is, the power applied or delivered to the induction coil is controlled as a function of the difference between the target temperature (e.g., desired temperature set point), and the actual measured temperature.

For example, based on the selected control parameters in use by PID controller 1812, the measured temperature, and the desired target temperature, the controller determines and sends commands or otherwise actuates a heating element controller 1816 (an example of which is induction coil controller 308) to provide a certain amount of power (and for a certain amount of time) to the induction coil to generate a change in cookware temperature or response. For example, suppose that the desired cookware temperature set point is 90 degrees Celsius, and the current measured cookware temperature is 40 degrees Celsius. The result of the comparison is converted to a continuous output. The continuous output is translated into commands for driving (e.g., delivering power) to the induction coil. In some embodiments, this control loop measurement and command updating process is periodically assessed (e.g., at 50 kHz).

In some embodiments, the measured temperature is determined from temperatures sensors 1814, including center temperature probe 104, under-plate temperature sensors. Further embodiments regarding utilizing multiple channels of temperature measurements from multiple sensors are described below. In some embodiments, the target temperature is determined based on a desired setpoint. The setpoint may be manually set by a user, automatically set when performing a technique or recipe, etc.

### Further Embodiments of Control Loop Parameter Scheduling

The following are further examples and embodiments of implementing control loop parameter scheduling, also referred to herein as gain scheduling. In some embodiments, scheduling of what control loop parameters the PID controller operates with includes determining a new, updated set of control loop parameters to use, and when the PID controller parameters should be updated to the new PID coefficients. The ability to dynamically change PID coefficients as a function of time or cooking contexts, as well as the use of PID coefficients that are optimized to each type of cookware, provides improved temperature control.

The PID coefficients in use affect how reactive the PID controller is to differences between a desired target temperature and an actual measured temperature. For example, the PID coefficients are used to determine an adjustment to an amount of power being delivered (e.g., to the induction coil heating element) given the temperature “error” (difference between measured and target temperatures). For the same temperature difference, different sets of PID coefficients would result in different amounts of power being applied to reduce the temperature gap. For example, temperature of the cookware is a function of power applied, mass, and time. That is, the thermal response of the cookware (amount of change in temperature of the cookware) given a certain amount of inductive energy input (which is a function of the power applied to the induction coil) is dependent on the mass of what is being heated (cookware and ingredients), and the amount of time that power has been applied. As another example, for a given mass with a set of thermal properties, higher amounts of applied power will result in larger changes in cookware temperature for the same amount of time that power is applied.

As the temperature of what is being heated can vary continuously (e.g., due to heat loss to the ambient environment), the control loop continuously compares measured temperature against the setpoint temperature to dynamically determine how to adjust power delivery to the induction coil to elicit a thermal response in what is being heated (cookware and ingredients in cookware) to reduce the temperature gap.

In some embodiments, a nominal condition of the temperature control system is when the system is stable, and the cookware temperature, though it may vary or fluctuate, is relatively close to the desired setpoint. In this state, a set of PID coefficients for holding or maintaining actual cookware temperature at a setpoint temperature is utilized.

There may be situations in which other PID coefficients, different from the nominal holding PID coefficients, are more optimal for achieving a desired setpoint temperature in a particular way (e.g., faster, without ringing, etc.). In some embodiments, the scheduler is configured to determine, given a cooking context, what are the optimal PID coefficients to use. After the system stabilizes (e.g., the cookware temperature is stably close to, or within a threshold of, the set point), the temperature controller reverts to the holding PID coefficients.

The following are examples of various conditions under which different PID coefficients (e.g., other than the holding or nominal or default PID coefficients) may be more optimal to use. As one example, in pre-heating, an empty pan is to be heated up from a cold initial temperature to a setpoint. In this scenario, at the beginning of pre-heating, there is a very large temperature delta between cookware temperature and the desired temperature setpoint. Further, it is desirable for this large delta in measured cookware temperature and desired setpoint to be closed as quickly as possible.

In some embodiments, for scenarios in which large temperature deltas are to be closed quickly, rather than using the holding PID coefficients (which are tuned to be more effective when the cookware temperature is much closer around the desired setpoint), a set of coefficients that is biased more towards the proportional (“P”) term is used by the scheduler to quickly bring up the temperature of the cookware to the desired setpoint temperature. In some embodiments, the P-coefficient used is also a function of time. As one example, a total gap between a starting temperature and a desired temperature is broken into a fast-slew (P-only) for heating an empty pan. The scheduler then reverts back to the holding PID coefficients when the cookware temperature approaches, or is much closer to, the desired setpoint.

For example, after quickly reaching a desired setpoint (using a proportional driven control for pre-heating), the control loop switches to temperature holding control parameters to precisely maintain or hold the cookware at the desired temperature. For example, the cookware will cool down during the cooking process for a variety of reasons, such as depositing energy into the food, cold food being put in the cookware, water in the cookware boiling off, etc., all of which remove energy from the cookware and decrease its temperature.

As another example, for preheating (to take the cookware from a cold state to a hot state), PID coefficients with high gain (high proportional term) are used to ramp up the temperature as quickly as possible. To prevent overshoot, the condition on when to revert back to the nominal holding parameters is determined to have roll off behavior as the cookware temperature is closer to the desired set point. As another example of pre-heating without overshoot, during the pre-heating phase (in which, for example, an empty cookware is being heated up from a starting temperature to a desired temperature), the pan temperature is to be quickly ramped up to the set point. In some embodiments, for the pre-heating phase, the proportional and derivative terms are more pronounced, where the proportional term drives the speed at which the temperature will ramp, and the derivative term will indicate when to reduce or cut power, so that the pan can “coast” to the desired set point temperature.

As another example, certain types of cooking operations involve ingredients or foodstuffs whose thermal behavior can change or is variable, which impacts how much the temperature of the cookware will change in response to a certain applied amount of power. For example, boiling water or deep frying involve phase changes. To accommodate the phase changes of water or oil, which will change the thermal response of the cookware to inductive energy input, a set of PID coefficients customized for accommodating phase changes is utilized to bring the cookware temperature much closer to the desired setpoint before the temperature control system reverts to the nominal PID settings for holding the desired temperature. As one example, the amount of time in which pre-heating control is performed (e.g., P-only or proportional-biased control) is extended to accommodate the phase changes to allow the measured temperature to reach the desired setpoint before reverting back to the holding parameters.

As another example, PID control is used to maintain a cookware's temperature to a desired setpoint in the face of conditions such as changes in thermal loss. The use of different techniques will result in differing rates of thermal loss and alter how the temperature of the cookware responds to applied power. In some embodiments, the scheduler dynamically updates PID coefficients based on the technique being performed to account for the different rates of thermal loss and the change in cookware thermal response to applied power. This provides more optimal control of applied power in bridging the gap between actual cookware temperature and a desired setpoint temperature under varying conditions resulting from the performing of certain techniques. For example, techniques such as heating butter, toasting nuts, or liquid reduction require a stable temperature set point, at which rapidly changing thermal loss occurs. In some embodiments, the scheduler dynamically updates the PID coefficients in use to account for the rapidly changing thermal loss. As one example, the scheduler dynamically and actively changes the PID coefficients upward and downward until the system stabilizes. As another example, another set of PID coefficients is used for sugar work, which involves a gradual change from evaporation that is dominated with commensurate circulation, to later stages that are dominated by caramelization and poor thermal conductivity in the vessel.

Boiling of water and reducing of sauce are examples of cooking operations that result in large amounts of evaporative loss. In such a case, the temperature of the cookware will fluctuate or vary significantly. Existing systems will have significant ringing, with a pattern of overshooting and undershooting, resulting in, for example, water boiling, stop boiling, boiling again, stop boiling, etc. Using the techniques described herein, in response to detecting that water is to be boiled, or that the sauce reduction technique is to be performed, the PID controller is loaded with parameters tuned for accommodating such evaporative loss.

As another example of technique driven scheduling, the control loop parameters can be updated multiple times over the course of implementing a single technique. For example, suppose cooking rice using a pressure cooker. One set of PID coefficients is used for heating the pot up. A different set of PID coefficients is used when boiling off water in the rice cooker. A final set of PID coefficients is used when finishing cooking of the rest when there is little liquid water is left (and cooking is operating primarily based on steam within the container).

As another example, a change in mass will affect the thermal response of the cookware to applied power. For example, the addition of ingredients such as a large piece of steak will alter the thermal mass of what is being heated, and thus alter how the cookware's temperature responds to applied power. In some embodiments, the scheduler dynamically updates PID coefficients based on detected changes in mass.

As shown above, and as will be described in further detail below, the scheduler is configured to dynamically update and determine closed loop control parameters (PID coefficients) based on total mass, technique selection, and/or temperature delta to be closed. This allows the temperature controller to adapt to transient behavior in the system, where the manner in which the temperature controller adapts (e.g., which coefficients are selected for use) is mass-driven, technique-driven, and/or total-delta driven. In some embodiments, the temperature control system also reverts back to a nominal set of PID coefficients (e.g., holding control parameters) when the system stabilizes or is in steady state, and the cookware temperature is closer to the desired setpoint.

Compared to existing systems, using the control loop techniques described herein, coefficients for temperature control are adaptive and specific to the context of the cookware being utilized and the cooking function to be performed. This allows for the temperature control system to compensate or adapt for different types of cookware, which may have vastly different properties and characteristics.

In some embodiments, the determination of when to use (e.g., schedule the use of) a set of parameters is implemented using a fourth coefficient.

### Further Embodiments Regarding Temperature Sensors

In some embodiments, the temperature controller performs temperature control based on a desired setpoint, as well as measured cookware temperature. Measured cookware temperature is determined using one or more temperature sensors, such as a center temperature probe (104) that is in contact with the cookware, under-plate temperature sensors (e.g., around the circumference of the plate on which the cookware rests), etc. Temperature probes may also be used to take measurements of content in the cookware. For example, while in the examples described herein, determining how to apply power to the induction coil to achieve a desired cookware temperature or heating profile is described for illustrative purposes, the control loop can also be configured to control for other types of temperatures, such as the temperature of ingredients.

In some embodiments, the center temperature probe in contact with the cookware is a main driver of the temperature control loop, where the temperature sensors beneath the plate allow for corrections based on cookware material type (e.g., for carbon steel, which has highly local and efficient electro-thermal conversion, versus clad stainless, which is highly inefficient, but thermally very uniform).

In some embodiments, when multiple temperature measurements are utilized, aggregation of the sensor measurements is performed to determine the measured temperature that the PID controller uses in its control loop. In some embodiments, an average is taken of the temperature measurements is used. In other embodiments, a subset of the temperature sensor measurements is used. As another example, when multiple temperature sensor measurements are collected, weights are applied to the temperature sensor measurements, which biases the impact of specific measurements (taken from specific temperature sensors) on how the temperature controller determines how to drive the induction coil. The weighting of certain measurements when determining cookware temperature can be used to take into account how heat is generated in cookware when using induction coils.

In some embodiments, the information indicating what temperature sensor measurements to use, weighting of particular temperature sensor measurements, etc., is passed along with the adjusted PID parameters to the PID controller, which uses the temperature sensor configuration/specification information to determine what is the actual temperature that is compared against the target temperature.

### Determining Cookware-Specific Closed Loop Control Parameters

The following are embodiments of determining closed-loop control parameters optimized for a specific type of cookware. In some embodiments, the control loop coefficients are determined during a setup or calibration phase.

In some embodiments, determining closed-loop control parameters (also referred to herein as “auto-tuning”) includes determining a temperature or thermal response of a specific type of cookware to electrical input energy to the induction coil. This includes determining, for a certain amount of applied power (e.g., 100 Watts), for a certain duration (e.g., 1 second), the change in temperature of the cookware (e.g., increase by one degree Celsius). As another example, the temperature response is determined by heating the cookware object and determining the frequency at which ringing occurs, its natural oscillation with pure P, etc. In some embodiments, coefficients are determined to also take into account or incorporate the response of the temperature control system, including any associated latencies or phase delays. For example, there may be some delay between commanding a power board to apply power (or cut power) and the requested power change actually occurring, which may result in transient power oscillations. In some embodiments, the coefficients are determined over suitable time constants to take into account ringing in the rest of the control system, not only in the cookware.

In some embodiments, the temperature response of the cookware to the applied amount of power for the specified temperature is used to determine the PID coefficients for the specific type of cookware. For example, the coefficients can be determined using algorithms such as Ziegler-Nichols, Cohen-Coon, or any other appropriate tuning process. In some embodiments, thermal response (temperature response to applied power) of a specific cookware object is determined by acoustically measuring the thermoelastic response of the cookware object.

The following is a further example of determining PID coefficients for a given cookware object (e.g., pan). For each cookware object, there is a critical temperature that is reached, and a periodicity (time response). In some embodiments, the thermal characteristics of a cookware object are used to determine one or more sets of control coefficients.

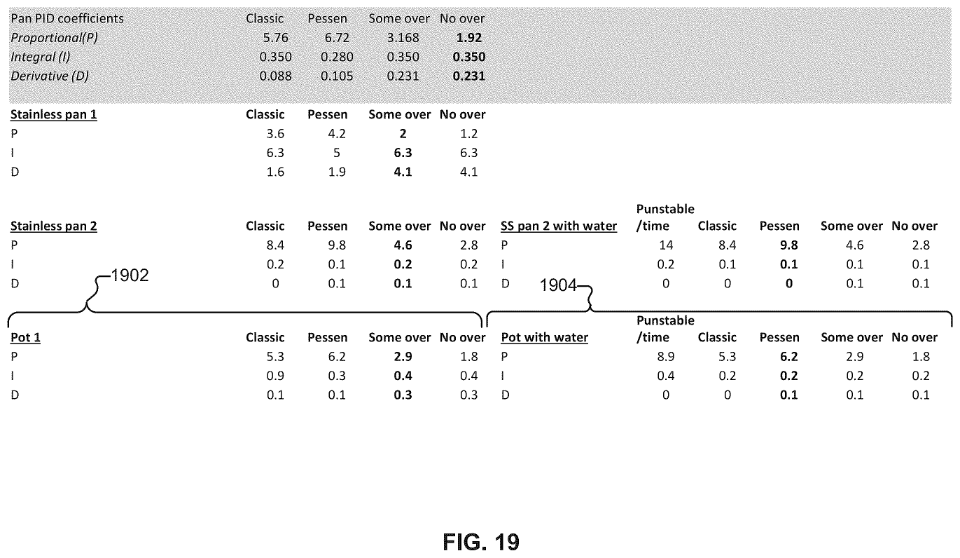

In some embodiments, the temperature control system is set to a set point. The control system is allowed to become unstable. For example, the P coefficient is adjusted (with no I and no D) until the system transitions from having a stable, slow response to having a self-ringing response. For example, for a given power, a sweep of P coefficient values is performed to identify the P coefficient at which the system becomes unstable (also referred to herein as the unstable P coefficient, or “Punstable”). The self-ringing response results in a period of oscillation. Various types of algorithms can then be used to determine PID coefficients (e.g., classic tuning, Pessen tuning, some overshoot, no overshoot (e.g., Ziegler-Nichols and Cohen-Coon), as described above). Examples of PID coefficients for different types of cookware are shown in conjunction with FIG. 19.

FIG. 19 illustrates examples of control loop parameters customized for different types of cookware. In the example of FIG. 19, for a given type of cookware object, sets of PID coefficients corresponding to different types of tuning are shown. The set of PID coefficients that provides the desired thermal response can then be associated with the cookware for use by the temperature control system. For example, such cookware-specific PID coefficients are recorded to a profile of the cookware.

In some embodiments, within the same type of cookware, different sets of PID parameters are specified for the cookware under different conditions. In the example of FIG. 19, PID coefficients are also shown for each of the different types of cookware with water in them. For example, the empty pot (1902) and the pot with water (1904) have similar P terms, but different I and D terms. In some embodiments, during run time, the appropriate set of PID coefficients is determined by performing a lookup of the information shown in FIG. 19 based on an identifier of cookware type and a condition of interest (e.g., water in the cookware). For each type of cookware, control-loop parameter sets for other types of conditions (and when the use of specific control-loop parameter sets is to be scheduled) can be configured. By having different coefficients for different cookware, a temperature control loop is adaptable to the use of different types of cookware.

In some embodiments, sets of coefficients are generated for specific types of conditions that are also applicable to multiple types of cookware (e.g., cookware that is not recognized by the system). For example, a set of coefficients is generated that operates for boiling of water in any cookware. Another set of coefficients is generated that operates for deep-frying in any cookware. Another set of coefficients is generated for cooking actions such as evaporation or breakdown of caramelization of sugar, for any cookware.

In some embodiments, the control loop parameters are re-determined or readjusted periodically, or in response to certain trigger events. For example, the auto-tuning described herein can be re-performed when it is detected that content (e.g., ingredients) has been added to the cookware object being used. Thus, the coefficients that are utilized by the control loop can include both preconfigured or pre-characterized (e.g., previously determined and included in a cookware profile), as well as dynamically determined control loop parameters. The calibration and determination of PID coefficients can be performed in a laboratory setting, such that the PID coefficients are pre-configured for a given type of cookware prior to receipt by a user. As another example, calibration can be performed by a user, with corresponding instructions provided for how to perform such calibration. This allows for new types of cookware to be registered and characterized with the cooking system.

In some embodiments, the available control-loop parameters optimized for the cookware are stored in a table or other data structure. In some embodiments, the available control-loop parameters are stored in a profile of the cookware. In some embodiments, the PID coefficients are also associated with corresponding scheduling parameters that specify criteria for which certain PID coefficients are to be used to operate the temperature control loop. Further details regarding determining scheduling parameters for using particular PID coefficients are described below.

### Determining Scheduling Criteria for Updating Control Loop Parameters

The following are further embodiments of determining scheduling criteria that specify when certain closed loop control parameters are to be used.

As another example, suppose that pre-heating of an empty pan was performed according to a set of temperature delta-driven control loop parameters. At some point, the set point temperature is neared, and the system switches to a set of PID coefficients for holding or maintaining a setpoint temperature. The following is an example of determining criteria for switching to the holding set of PID coefficients.

In this example, after the pan has reached the desired set point, a different set of PID coefficients is accessed and loaded into the temperature controller for holding or maintaining a desired temperature. PID coefficients specific to the pan are utilized. In some embodiments, the switch to the different set of PID coefficients is performed in response to coefficient switchover trigger criteria. One example of a trigger criteria for switching over to another set of PID coefficients is the delta or difference between the measured temperature and the intended temperature. As another example, a threshold is used to determine the crossover point, such as when the measured temperature is a threshold percentage of the intended temperature. As another example, switching between sets of coefficients is performed when the temperature is within a control band range. In this example, when the measured temperature is within a threshold of the setpoint (e.g., threshold percentage of the setpoint), the scheduler switches the PID controller to using PID coefficients for holding or maintaining the temperature of the cookware at the setpoint.

In some embodiments, the crossover point at which delta-driven temperature control is switched off (and holding control is implemented) is determined based on the thermal characteristics of the cookware being used. For example, steel pans typically have significant temperature overshoot, where due to having poor lateral thermal conductivity, it may take time for heat to spread from where the induction coils are to the part of the pan that is measurable by a temperature sensor. In this case (and also for other types of pans such as carbon steel pans), a center contact temperature sensor is measuring in what is typically a colder spot (where there is a potentially large difference or gradient in temperatures across the cookware). Further, pans made of different materials will heat up at different rates. For example, a carbon steel pan may heat at ˜ 4-5 degrees C. per second at full power, while a stainless-steel pan may heat at ˜3-4 degrees C. per second at full power. In some embodiments, the point at which the PID coefficients are switched over (crossover trigger criteria) is cookware-specific, taking into account that there are potentially large differentials in temperature across the cookware. As one example, heat is generated first in portions of the cookware that are over the induction coils. If the induction coil is a ring shape, then a ring of heat will be observed. That is, a “donut” shape of heat will form. The conversion efficiency relates to the efficiency of converting power provided to the induction coil into heat (as measured by temperature) in the cookware. If the temperature sensor is in the middle of the donut-shape, then a relatively low temperature of the cookware will be measured. Heat will then conduct across the pan from the regions over the induction coils. Cookware with higher thermal conductivity will distribute the heat faster throughout the cookware, as compared to cookware with lower thermal conductivity.

In some embodiments, the crossover trigger criteria (e.g., what threshold percentage of the setpoint temperature should be used as the criteria for switching to holding mode control parameters) is based on characteristics of the cookware, such as the cookware's conversion efficiency (e.g., efficiency of inductive converting of power to heat, or watts per degree change per second, or the slope at which power is converted to heat) and thermal conductivity of the cookware (e.g., ability to distribute heat laterally across cookware).

Swapping of PID coefficients can also be triggered according to other conditions as well. For example, as described above, the use of some coefficients is driven by the total mass being heated. As one example, the temperature controller updates PID coefficients when a change in mass or weight is detected. For example, PID coefficients for controlling temperature in the context of added ingredients (e.g., added protein such as meat) can be used when a change in weight is detected (as an indication of adding ingredients).

Another example criteria for updating control loop parameters is detection of phase change events. For example, different sets of PID coefficients are used based on detection of phase transitions (e.g., due to boiling of water). In some embodiments, the switching of different sets of PID coefficients is triggered based on detection of different phases of water boiling. Phase detection can be detected acoustically. Phase detection can also be detected thermally. For example, the system monitors for patterns of thermal behavior in the sensor data that are indicative of what state of boiling is occurring. For example, thermally, if for the applied same amount of power, a sudden change in the temperature change per unit time is detected, this is indicative of a change in state. For example, when the slope is shallower, then this is indicative that boiling has begun. Once the water has boiled off, this is detected as another change in the rate at which the temperature changes per unit time. This is due to the state change of water, where different states have different specific heats. In some embodiments, different PID coefficients can be swapped in for different phases of water boiling.

With respect to monitoring the change in temperature given applied power, in some embodiments, the system uses such information to differentiate between different types of ingredients or contents within a cookware object. For example, the temperature change profile of oil with respect to applied power is different for oil as compared to water. In some embodiments, the presence of oil is deduced based on detecting a temperature change profile (given applied power) that matches to oil. Appropriate control parameters corresponding to frying oil are then loaded in response to detection of oil as the content in the cookware. In this example, the detected ingredient is a criteria for using a particular set of control loop parameters.

In some embodiments, the crossover point for swapping between PID coefficients is determined based on the rate at which heat is lost. In the case of boiling or sauce reduction, instead of only the pan radiating heat, volumes of fluid are radiated in vapor form away from the cookware surface (heat and steam). The rate of heat loss can also be affected by airflow.

As described above, in some embodiments, the mass of the cookware, the inductance or natural reflectivity of the cookware (how much power is returned), etc. are taken into account when determining control-loop parameters for a given cookware. Observed thermal shocks to end ringing are also taken into account when determining the P, I, and D coefficients. In some embodiments, the locations of scheduling crosspoints are reverse calculated (e.g., by determining the runout).

### Further Embodiments of Scheduling Control Loop Parameters

The following are embodiments of implementing control-loop parameter scheduling and updating, switching, swapping, or crossing over between different sets of PID coefficients.

In some embodiments, each set of control-loop parameters is associated with a scheduling parameter. For example, the scheduling parameter is a condition for using the corresponding set of control-loop parameters. Examples of scheduling criteria are described above. In some embodiments, an appropriate set of control-loop parameters is determined by performing a lookup of the table of control-loop parameters, where the lookup is performed by using a query that includes a condition (e.g., technique selection, whether a certain temperature delta is to be closed, addition of mass, etc.). The closed-loop parameters matching to the queried-for condition are returned. The use of such a conditional implementation is computationally efficient.

In other embodiments, a single equation is used, where the terms are aggregated together inline. In some embodiments, another control term is included that indicates the threshold that is used for each cookware object. For example, each triple of PID coefficients is further associated with a corresponding fourth term.

In some embodiments, in addition to having P, I, and D terms, an additional second derivative term is specified. In the example of determining when to transition from delta-driven control (for pre-heating, for example) to holding control, the use of the second derivative term is analogous to setting a certain crossover point (e.g., when the measured temperature is at 80% of the desired set point, as described above). When the delta or error is over a certain threshold, the system operates in primarily “P-mode” (mostly proportional gain for high temperature gain mode for fast, delta-driven pre-heating), while when the delta or error is small, the system operates in a more balanced “PID” mode for holding temperature. As one example, the crossover threshold is implemented as a fourth coefficient along with the triple of PID coefficients for reverting to holding set of parameters.

In this example, in addition to a slope (derivative) dependent term, an integral dependent term, and an absolute (proportional) dependent term, an additional delta dependent term (whether temperature delta or error is within a certain threshold of the intended set point) is included. In this case, the power that is commanded to be applied to the induction coil is now also a function of whether the error is within a threshold deviation of the intended set point.

In some embodiments, the scheduling is implemented as a binary state. For example, based on the measured cookware temperature being within a threshold delta to the intended set point temperature, a different PID profile is used. In other embodiments, gain scheduling is integrated into the PID controller as an additional term in the partial derivative.

In another embodiment, a state machine is used to determine when to update PID coefficients. For example, different states are entered based on different triggering criteria, where when certain scheduling criteria are met, a corresponding state is entered, and a set of coefficients pertaining to the state is utilized.

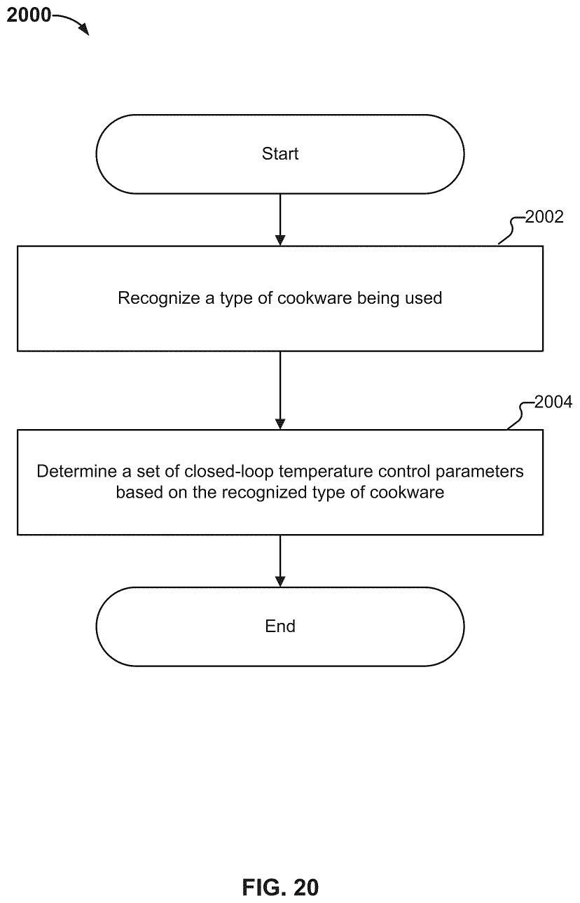

FIG. 20 illustrates an embodiment of a process for temperature control based on cookware recognition. In some embodiments, process 2000 is executed by closed-loop temperature control system 1800. The process begins at 2002, when a type of cookware being used is recognized. At 2004, a set of closed-loop control parameters for controlling a heating element is determined. The set of closed-loop control parameters is determined based on the recognized type of cookware. As described above, in some embodiments, each type of cookware is associated with a cookware profile. In some embodiments, the cookware profile includes corresponding sets of control loop parameters (PID coefficients) configured or determined or customized for the type of cookware. In some embodiments, when a type of cookware being used is recognized or determined, a lookup is performed of the profile to access the PID coefficients configured for the type of cookware.

For example, upon recognition of the type or identity of the cookware that is present, a profile linked or corresponding to the cookware is accessed (e.g., loaded into the memory of the cooking system device, accessed locally or remotely, etc.). A PID lookup table associated with the profile is queried to determine the PID parameters to be utilized given the cookware being utilized and the cooking function or cooking operation to be implemented using the cookware (e.g., cooking technique to be performed using the cookware). For example, different techniques are associated with different PID parameters or programs, such as different PID parameters for cooking rice versus performing toasting. In some embodiments, different end-states (which may be technique and/or cookware specific) are also associated with different PID coefficients or control points (e.g., for gain scheduling). This is beneficial, for example, at latter stages where there is less browning, or there is browning to blackening of ingredients.

In some embodiments, the closed-loop control parameters are determined based on other cooking contexts, such as total mass, technique selected, and/or temperature delta.

In some embodiments, determining control loop parameters tuned or customized for a cookware object or vessel is based on the mass of the cookware, the inductance or natural reflectivity of the cookware (how much power is returned), etc. Observed thermal shocks to end ringing are also taken into account when determining P, I, and D coefficients. In some embodiments, the locations of scheduling crosspoints (for updating PID coefficients under different contexts) are reverse calculated (e.g., by determining the runout).

In some embodiments, a temperature controller operates according to the closed-loop control parameters. As one example, the temperature controller is a PID controller, and the set of control parameters according to which the controller performs temperature control includes PID coefficients.

In some embodiments, a heating element is controlled according to the output of the temperature controller. For example, in the case of a heating element being an induction coil, the induction coil controller is controlled or actuated according to the output of the temperature controller, which determines, according to the closed loop control parameters optimized for the cookware, how much power should be applied to the induction coil given a difference in measured temperature and setpoint temperature. For example, the cookware-specific PID coefficients are plugged into the temperature controller (PID controller) to determine how to drive the induction coil (how much power to apply and when), to achieve a desired cookware heating or temperature profile.

As one example, the output of the temperature controller is a set of commands for how to drive the induction coil based on the sum of the error (temperature difference) multiplied by the proportional coefficient, accumulated error multiplied by the proportional coefficient, and derivative of the error multiplied by the derivative coefficient. The particular set of coefficients used will impact how the induction coil will be driven given a measured temperature difference.

In some embodiments, each type of cookware is associated with a specific unique identifier. Each cookware is associated with one or more sets of control loop parameters applicable or specific to the cookware. In some embodiments, each cookware is also associated with crossover point values or terms that indicate when to update parameters (e.g., schedule when to use a different set of parameters), and what parameter values should be used. As described above, the scheduling takes into account various conditions to determine how to adjust or tune the PID coefficients according to which the temperature controller (PID control loop) operates. The manner in which the PID coefficients are adjusted or updated is based on the type of cookware that is being utilized. In this way, the temperature controller takes into account both the type of cookware (e.g., its material properties), as well as current environmental state conditions.

As described above, the PID coefficients of the induction coil controller (where K, Q, etc. are examples of closed loop control parameters) are adjusted for the specific cookware. This provides an improved temperature and induction cooking controller. In some embodiments, the PID coefficients for a specific cookware are determined using embodiments of the auto-tuning process described above.

The following are further embodiments of control loop parameter scheduling. In some embodiments, responsive to a detected cooking condition, the set of closed loop control parameters is updated. For example, as described above, various events or conditions can trigger a scheduler to determine an updated set of control parameters to provide to the PID controller. In various embodiments, the determination of what control parameters the PID controller should operate with is based on mass change, technique, and temperature delta. For example, the selection of what type of heating control profile should be implemented (and thus, what parameters should be used to implement the desired heating control profile) is mass driven, technique driven, and/or total delta driven (where the delta is the delta or difference between a setpoint or target temperature and a starting temperature).

In various embodiments, updating or otherwise determining PID coefficients is based on detecting changes in cooking, such as changes in mass, temperature deltas to be closed (e.g., due to changes in the setpoint temperature), technique selection, etc. By using different PID coefficients for different types of cookware, consistent temperature control can be provided for different cookware with different properties.

An example of mass-driven scheduling is when the system detects an increase in mass, which is indicative of the adding of an ingredient to the cookware. As addition of a large mass will impact how much of a temperature change is induced for a given amount of power supplied to the induction coil, an updated set of control parameters is determined to account for the addition of a thermal mass to the cooking system.

Technique-driven scheduling includes scheduling based on detection of a cooking technique that is being performed, or is to be performed. Examples of techniques include boiling water, reducing/evaporating sauce, caramelizing sugar, browning, pressure cooking, etc. As one example, a technique to be performed is determined in response to user selection (e.g., via the contextual user interface described herein) of a particular technique. The set of control parameters is updated based on the selected technique. In some embodiments, technique-driven scheduling includes scheduling based on an indicated or desired sub-technique end state (e.g., desired doneness of pancakes, desired end state hard crack for caramelization, medium doneness for fry chop, etc.).

Delta-driven scheduling includes scheduling or updating of control loop parameters based on a request to reduce a delta in temperature. For example, pre-heating is performed to reduce a large delta between a cookware's current temperature and a desired setpoint temperature. In the case of pre-heating, the manner in which the cookware temperature is to be controlled (primarily by the proportional term) is delta-driven. In some embodiments, delta-driven PID coefficients are tuned for reaching a desired setpoint temperature as quickly as possible, without overshoot. In some embodiments, temperature delta-driven PID coefficients (for heating up an empty pan up to setpoint temperature) are used when the delta between the actual cookware temperature and the target temperature to be reached exceeds a threshold. For example, delta-driven PID coefficients are loaded and used when a change to the target set point temperature is detected. As one example, delta-driven control includes parameters optimized for achieving as high a rate of temperature change as possible, without overshooting. For example, the delta-driven controls are optimized to achieve a large slope (high rate of temperature increase over time) without overshooting or ringing. With delta-driven parameters, the cookware temperature is increased as rapidly as possible, where the desired setpoint temperature is reached without overshooting.

In some embodiments, the amount of time that a particular set of control loop parameters is used is based on the operation being performed. For example, cooking actions that involve phase changes, such as boiling water or deep frying, involve extensions of time in how long a certain set of parameters (e.g., proportional-biased parameters) are used.

In some embodiments, the control loop parameters include control loop parameters optimized or tuned for holding or maintaining a setpoint temperature with high precision and small variation. In some embodiments, the holding control loop parameters are a nominal or default set of control loop parameters. For example, the holding control loop parameters are utilized by default unless scheduling of updating the control parameters is triggered based on detection of scheduling criteria (e.g., mass change, technique selection, and/or temperature delta to be closed). In this example, the control parameters by default are those corresponding to a default hold mode. Entering of a scheduling mode (to switch or update parameters) is triggered in response to detection of a scheduling condition. In some embodiments, when a desired setpoint is reached by the cookware, the system switches to (or reverts back to) a nominal PID setting for holding or maintaining a target temperature for the cookware.

In some embodiments, a condition on which to update control parameters is determined. As one example, the control parameters are updated to revert from the use of mass-driven, delta-driven, and/or technique-driven parameters back to a nominal set of PID coefficients (e.g., for holding or maintaining a target temperature). In some embodiments, the crossover condition is determined for the cookware being used, where different cookware objects are associated with different crossover conditions. One example of a crossover condition is a temperature-based crossover threshold. Other crossover criteria or control parameter selection criteria include detection of events, such as phase transitions, addition of ingredients, changes in temperature setpoint, technique selection, detected rate of heat loss, etc.

As shown in the above examples, compared to a pre-programmed temperature controller with a single, fixed set of control parameters that is broadly applied regardless of cookware being used or what cookware function is being performed, the closed-loop temperature controller described herein is adaptive and able to change its control loop parameters in response to different contexts. In some embodiments, the temperature controller described herein follows a setpoint profile, based on tuned control loop parameters (e.g., PID coefficients). In some embodiments, the temperature controller described herein changes its coefficients based on context to change the amount of power that is applied for a given difference in temperature between a target temperature and measured actual temperature. In this way, the responsiveness of the temperature controller can be dynamically changed based on context. For example, in contrast to existing induction systems that operate using fixed parameters that are generally applied, the control system described herein dynamically updates its PID coefficients based on heating context (e.g., cookware type, delta to be closed, selected technique, change in mass, etc.). Changing the coefficients changes the behavior of the temperature controller by changing the amount of power that is applied for a given difference in temperature between a target temperature and an actual measured temperature. Swapping different PID coefficients to the temperature controller changes how reactive the temperature control system is to differences between target temperature and actual measured temperature.

Embodiments of the closed-loop temperature control algorithm are applicable to other types of heating systems, such as electric stoves, gas stoves, etc. For example, with electric stoves, different PID parameters can be used to change the amount of infrared energy that is emitted for a given difference between target and measured temperatures. For gas, different PID parameters can be used to change the amount or intensity of gas (e.g., by actuating a valve to control the amount of flow) for a given difference between a target temperature and an actual measured temperature. For such radiant heating, electric burners, etc., different sets of PID parameters can be selected and utilized in response to triggering of various conditions, such as phase changes, desired cookware heating profiles, changes in what is in the cookware object, etc.

As another example, the temperature control system described herein can be used in a pizza oven, where the temperature control system changes PID parameters to change how much air is passed to wood (e.g., by controlling actuating of a fan) for a given difference between a target temperature and actual measured temperature. In this pizza-oven example, the PID parameters that are used are customized to the different dishes that are being used in conjunction with the pizza oven.

### Embodiments of Emulating a Gas-Like Experience

The following are embodiments of emulating a gas-like cooking experience using embodiments of the induction cooking system described herein. In some embodiments, the induction coil is driven to behave like a gas stove by emulating the thermal heating profile of a fast stove (e.g., by adjusting power rate). As one example, the induction coils (in a multi-induction coil system) can be controlled to deliver heating behavior similar to that of a gas stove, where the outer rim of a cooking pan is gradually hotter than the middle. This is emulated by adjusting the distribution of power (which can be adjusted over time) such that the outer ring is provided more and more power.

In some embodiments, when in an emulation mode to emulate a gas-like experience, the system is configured to provide feedback that is representative of a gas-like experience. In some embodiments, the LED (light-emitting diode) ring is controlled to simulate the intensity/size of fire and correlates to power. In some embodiments, different colors of lighting simulate different intensities of fire (e.g., yellow for medium heat, blue for high heat, etc.). In some embodiments, different numbers of rings being lit up indicate different sizes of fire. In this way, the system provides a visualization of heat to provide a gas/flame cooking experience. In some embodiments, sound (including fan noise) is adjusted to correlate to power. For example, to create an acoustic experience similar to a gas range, the system is made louder at higher heat. In some embodiments, acoustic feedback is provided (e.g., via speakers) based on the level of heat and power level. In this way, feedback is provided to the user about how the system is behaving, in a manner similar to that of a gas stove. In some embodiments, the power control, LED, and sound are coordinated together. In some embodiments, the user interface is adapted when in a gas-stove emulation mode, where heat can be increased and decreased by rotating the knob clockwise or counter-clockwise (to increase or decrease power delivered to the induction coil, similar to increasing or decreasing the amount of gas released for ignition).

### Thermal Acoustics

In some embodiments, the cooking system described herein includes an acoustic sensing system that utilizes acoustic sensors for facilitating various cooking intelligence, such as identifying cookware and cookware content. As will be described in further detail below, in various embodiments, acoustic sensing is utilized or integrated to enhance or facilitate various intelligence, such as that described above, including identification and detection of specific cookware, cookware characterization (e.g., of material properties), and cookware content state detection (e.g., of state of ingredients being cooked in cookware).

Cooking vessels such as pans/pots have distinctive inductive and acoustic properties. Such properties include, for example: dimensional; material; lamination (for multilayer) quality; uniformity/meso-scale (for non-layered). These properties create distinct RF (radio frequency) reactances which can be used or leveraged to facilitate cooking vessel recognition through the inductive heating coil and/or acoustic sensors. The aforementioned properties are also functions of temperature, and can also be used to identify temperature set points. The distinctive inductive and acoustic properties of cooking vessels can also create distinct RF reactances that can be utilized to facilitate cooking vessel condition diagnostics and detection of poor potential cooking performance. As a note, RF resistance and reactance are related to, but not necessarily directly leveraged by acoustic sensors. For example, two system can have the same RF reactance, but different acoustic properties. In some cases, thermophysical properties drive acoustics, and electro-magnetic properties drive RF impedance. Actions can then be performed, such as user notification or algorithm adjustments to compensate for the detected condition of the cooking vessel.

### Implementation of Acoustic Sensing

The following are embodiments of hardware implementations of acoustic sensing, including integration of acoustic sensing components in embodiments of a cooking system such as that described above.

In some embodiments, the sensing system includes one or more acoustic sensors that are located or positioned at various parts of the cooking system to facilitate the acoustic sensing described herein.

### Air-Coupled Acoustic Sensors

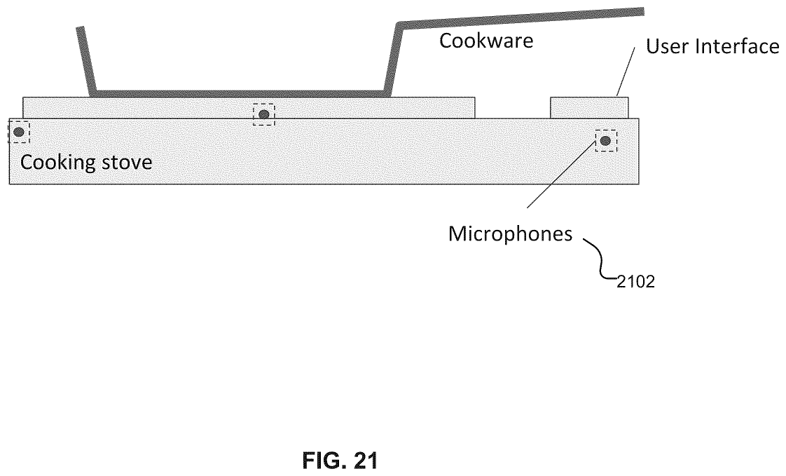

In some embodiments, acoustic sensors include air-coupled acoustic sensors. One example type of acoustic sensor is a microphone. FIG. 21 illustrates an embodiment of acoustic sensing in an intelligent cooking system such as that described above. In the example of FIG. 21, (an array of) air-coupled microphones (e.g., microphone 2102), are used to pick up or detect atmospheric/environmental sounds. In some embodiments, directional microphones are used to reduce extraneous signals. Examples of air-coupled transducers include ferroelectric, magnetostrictive, or any of the range of diaphragm and electrolet-type of air-coupled transducers.

In some embodiments, the same microphones that are used for other functionality (e.g., for pick up voice commands from an end user) are utilized for acoustic sensing and acoustics-based intelligence.

In various embodiments, the microphone(s) can be placed in various different locations, such as beneath the cooking glass (e.g., top plate), or as another example, on a side of the cooking system away from the user interface (e.g., dial).

### Contact Acoustic Sensors

In some embodiments, acoustic sensors also include acoustic sensors that come in contact with cookware or cooking vessels. The use of acoustic sensors that are in contact with cookware is referred to herein as contact acoustics. Acoustic sensing using sensors that are in contact with cookware (e.g., at the bottom of the cookware, at the handle, connected to a structure that will be in direct contact with the bottom of a cooking vessel, or any other location as appropriate) improves sensing accuracy (e.g., sensing of various frequencies in acoustic response). Examples of contact acoustic sensors include transducers, such as piezoelectric elements/transducers. Piezoelectric transducers convert varying or oscillating electrical energy (e.g., AC power) into mechanical vibrations that can be transmitted. Piezoelectric Acoustics transducers also convert mechanical vibrations into an oscillating electrical signal that can be detected (e.g., AC signal). Piezoelectric transducers achieve this through the piezoelectric effect.

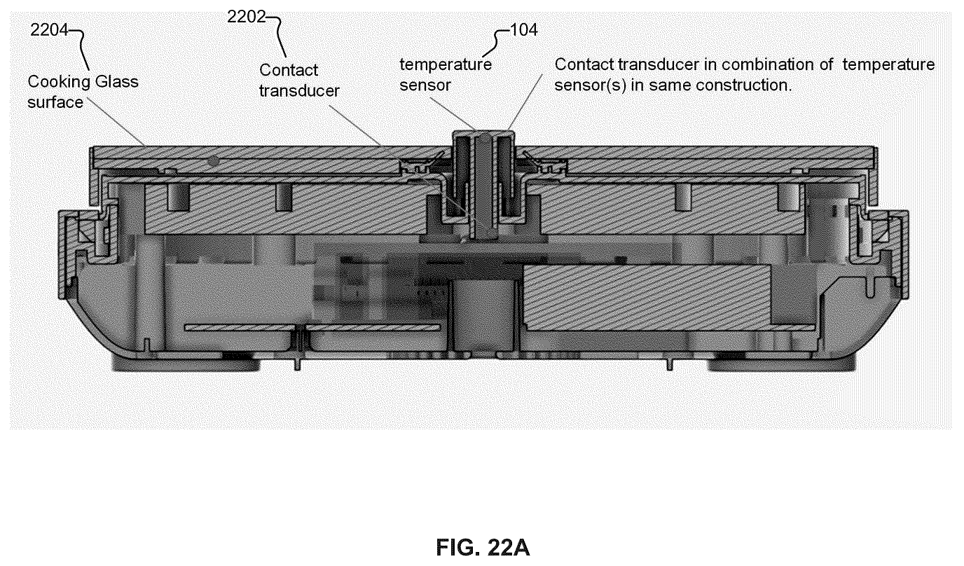

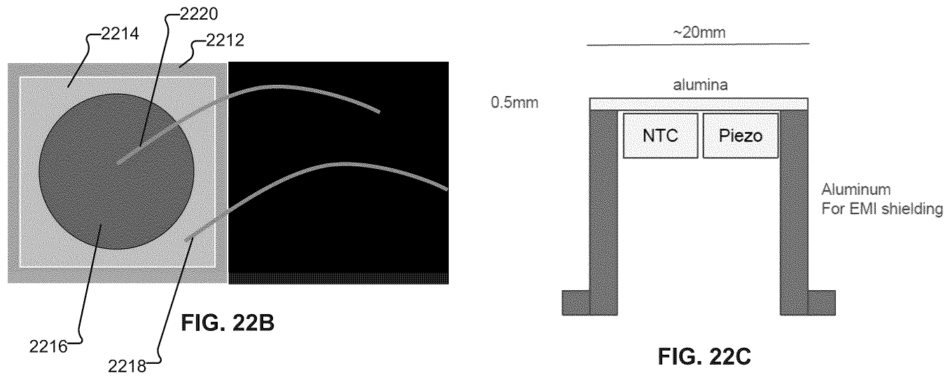

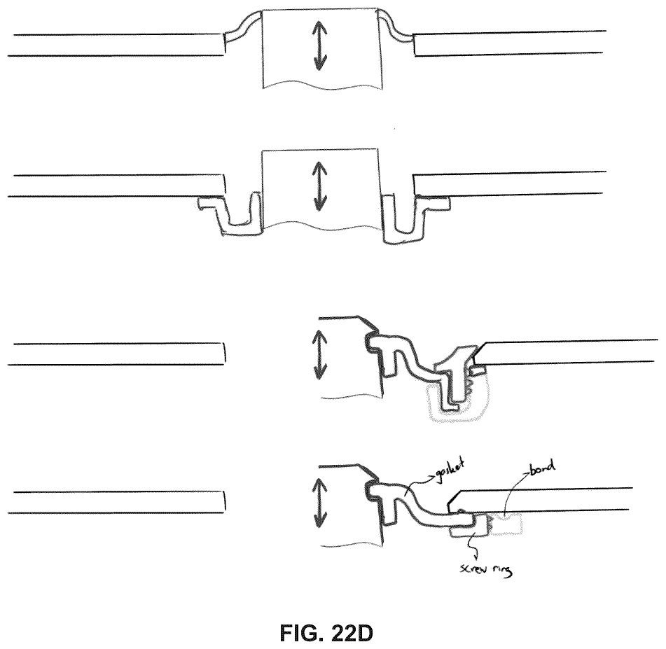

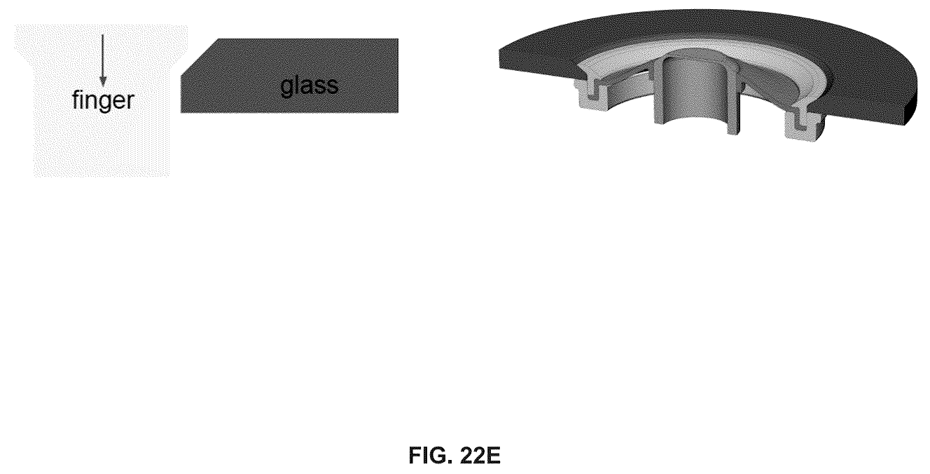

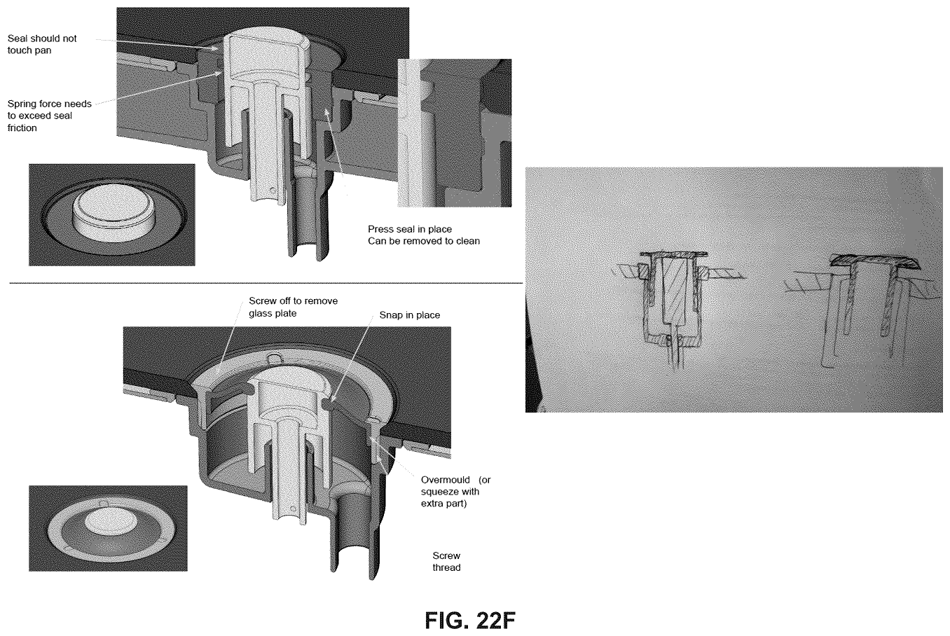

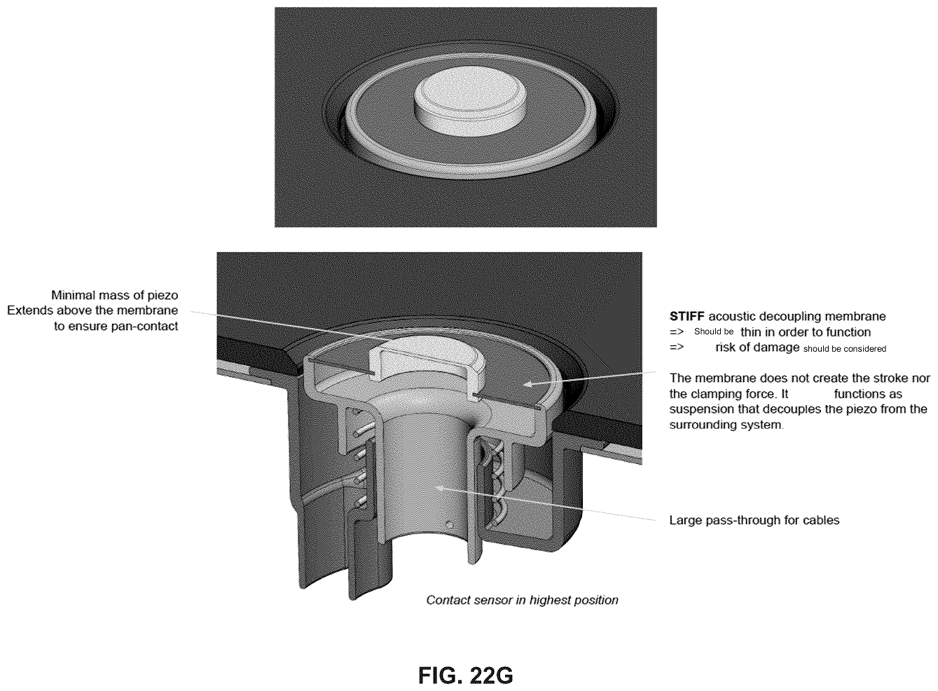

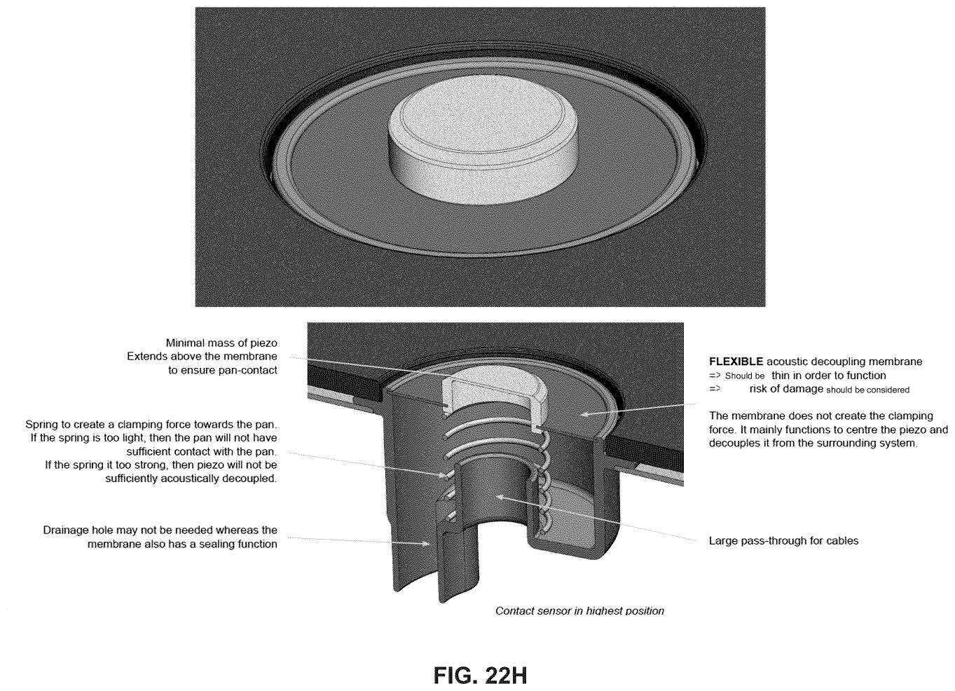

FIG. 22A illustrates an embodiment of an intelligent cooking system with contact acoustic sensors. In the example of FIG. 22A, a cross-section of an intelligent induction cooking system such as that described above is shown (e.g., as shown in the example of FIG. 4B).

In some embodiments, an acoustic transducer (2202) is directly coupled to a cooking vessel (e.g., that is placed on top plate/cooking class surface 2204). In some embodiments, the directly coupled acoustic transducer (also referred to herein as a contact transducer) is configured to detect sounds coupled to the structure of the cooking vessel (e.g., vibrations of the cooking vessel). Such direct coupling significantly improves the ratio of signal to noise in acoustic measurements.

In some embodiments, the contact transducer is installed in combination with a temperature sensor, such as with the center temperature probe 104 in the center of the top plate. In some embodiments, the temperature sensor(s) are installed closer the surface, in contact with the bottom of a cooking vessel (when the cooking vessel is placed on the top plate). The contact transducer can be installed further away from the surface (as shown at 2202), for example, to prolong the lifetime of the contact transducer. In some embodiments, a rigid structure is utilized that has a low thermal conductivity, that is non-magnetic, and has a well-defined contact area with the bottom of a cooking vessel. As one example, a spring-loaded construction is utilized that facilitates a direct contact force to the bottom of a cooking vessel. For example, the contact transducer is included at the bottom of an assembly or rigid structure that includes the temperature sensor probe, and that comes in contact with the contact vessel. When the contact vessel is on the top of the assembly, forces can be transmitted along the assembly between the cooking vessel and the contact transducer. For example, vibrations of the cooking vessel can be transmitted to the transducer, where the vibrations in the transducer are converted to an electrical signal that is analyzed. Similarly, if the transducer is driven with an electrical excitation signal, a corresponding mechanical vibration is induced in the transducer, which can be transmitted to the cooking vessel (and which can induce or excite the cooking vessel to vibrate in response to the mechanical excitation produced by the transducer). In an alternative embodiment, the contact transducer is installed to be in contact with a cooking vessel and beneath the cooktop surface on which cookware is placed.

The following are further embodiments regarding hardware implementation of contact sensors.

FIGS. 22B and 22C illustrate embodiments of a contact sensor assembly. In this example, a contact sensor is shown. For example, a temperature/acoustic sensor is shown. In some embodiments, sufficient travel is provided to ensure good contact and force of the sensor to the cooking vessel (for example, 3-5 mm of stroke is provided). In some embodiments, there is spring force (e.g., spring and rubber membrane with spring function). In some embodiments, there is a shield under the temperature/acoustic sensor. In some embodiments, there is bonding of the piezoelectric element (e.g., so that there are no bubbles). In some embodiments, thermal paste is not used at the piezoelectric element.

In the example of FIG. 22B, a piezo sensor assembly is shown. Shown at 2212 is alumina (1.g., 10×10×1 mm, nominal). Shown at 2214 is conductive silver track, to connect to lower electrode. Shown at 2216 is the piezo. As one example, the piezo is nominally 6-8 mm, 0.3-1.0 mm. Cables to the piezo and conductive silver track are shown at 2220 and 2218, respectively. In some embodiments, the surface is potted with silicone. In some embodiments, the piezo is bonded down using silver loaded epoxy, good to 250+C in the short term, <300 C intermittent.

In some embodiments, the contact assembly includes a tube, face-bonded to the alumina wear plate around the edge such that the NTC and acoustic wires are run coaxially down to the signal processor board. In some embodiments, for signal reasons, an electrically conductive material is used as a shield.

FIG. 22D illustrates an embodiment of a contact sensor. The following are embodiments of main ingress protection directions. In some embodiments, drainage is utilized instead of a seal (e.g., accepting that fluid can leak between the sensor and the glass plate). As another example, the sensor finger is fully sealed to the glass plate. One consideration is that for non-smooth surfaces, there may be pockets that are created. Smooth surfaces may lead to complex seal fixation. In some embodiments, drainage is added for additional safety.

The following are embodiments of sealing design boundaries (in the case of using the above second direction in which the sensor is fully sealed to the glass plate).
Good consistent contact “force” to the cooking vessel, over the lifetime.
   Acoustic: ˜ 100 milligram
   Thermal: large contact area toward the cooking vessel
   Spring is more contact over the lifetime compared to rubber spring
One consideration is that pollution can lead to friction
In some embodiments, sufficient travel is provided to ensure good contact and force of sensor to cooking vessel (e.g., 3-5 mm of stroke)
   Different cooking vessels can have different amounts of indentation
Shield under temperature/acoustic sensor
The shield should not create too much friction. That would then require too strong a spring (which would be more difficult to be pressed downward by the cooking vessel).
The seal does not touch the cooking vessel directly
Survives scrubbing when cleaning
Rigid material that becomes hot may be PPS. Overmolding may be utilized. Seals may be clamped
In some embodiments, the sealing line is near the top edge of the glass plate
The finger need not seal when the cooking vessel is on, as the cooking vessel will cover it
Pollution may occur when the user is cleaning the glass with a cloth

FIG. 22E illustrates embodiments of contact sensors. In one embodiment, an electromagnet is used to push the finger up. In some embodiments, without the magnet on, a spring (or gravity) pushes the finger down and seals to the top side of the glass. It is not expected that the steel/magnet will become hot due to the induction coil, because the coil field is not in the center. In some embodiments, a linear actuator (motor or magnetic) is used to move the finger. In some embodiments, a linear motor is used to control the pressing force.

In some embodiments, the finger is pressed down to snap in low position when cleaning, similar to a pen. In some embodiments, pressing again activates the spring.

FIG. 22F illustrates embodiments of contact sensors. In some embodiments, a user is to remove a part (from the top) in order to clean around the finger. Example types of seals towards the finger include o-ring; lip seal (up/downward); lip seal (horizontal); Membrane/bellow (no friction, and permanently closed, where a larger diameter should be used).

FIG. 22G illustrates embodiments of contact sensors. In this example, an embodiment of a spring-loaded drumhead assembly is shown. In this example, there is acoustic decoupling of piezo from system. In some embodiments, the ideal or optimal piezo fixation for measurement based on piezo reflection (impedance mode) includes: fully free from the system; fully fixed to the pan.

FIG. 22H illustrates embodiments of contact sensors. In this example, an embodiment of a spring-loaded flexible membrane is shown. In this example, there is acoustic decoupling of piezo from system. In some embodiments, the ideal or optimal piezo fixation for measurement based on piezo reflection (impedance mode) includes: fully free from the system; fully fixed to the pan.

FIG. 22I illustrates embodiments of contact sensors. In this example, an embodiment of an elastic membrane is shown. In this example, there is acoustic decoupling of piezo from system. In some embodiments, the ideal or optimal piezo fixation for measurement based on piezo reflection (impedance mode) includes: fully free from the system; fully fixed to the pan.

In one embodiment, a magnet snap is utilized. For example, a magnetic finger head is used. For example, there is a permanent magnet force to snap to the cooking vessel. As one example, magnetic suspension of sensor is combined with magnetic fixation to the cooking vessel. A light spring may also be added. Benefits of such an approach include that: force not affected by cooking vessel height; a higher contact force can be applied; the magnet will snap to the pan, independent of the angle of the pan. Some considerations include that the magnet will become hot and that the magnet may reduce in strength or even de-pole. Magnet strength may also reduce at increasing temperatures.

### Combination of Microphone(s) and Contact Tranduscer(s)

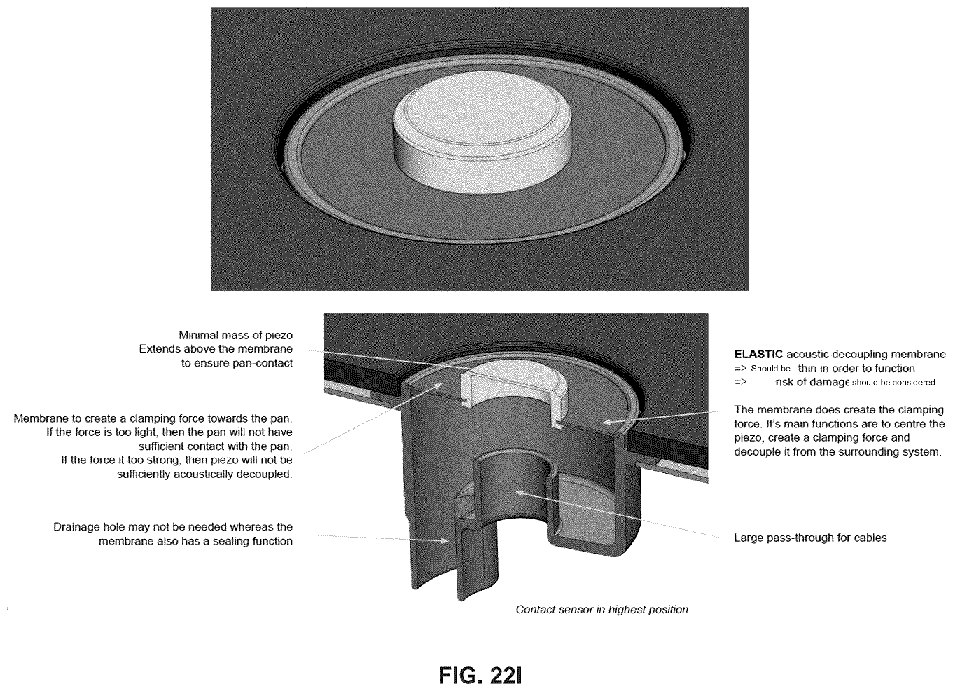

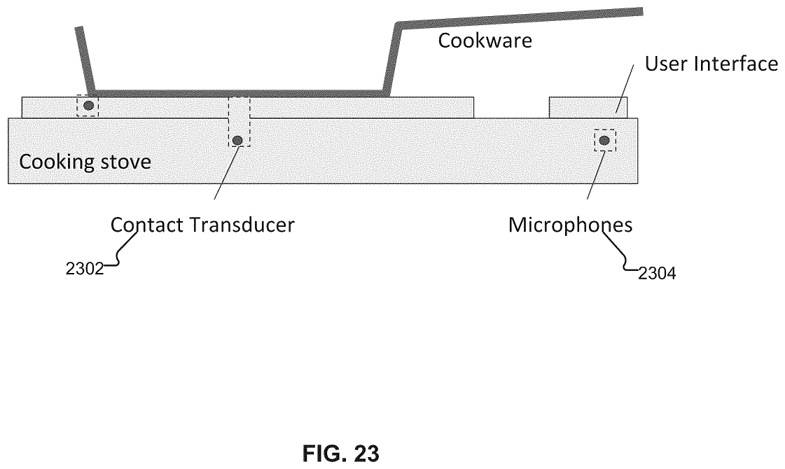

FIG. 23 illustrates an embodiment of acoustic sensing using contact transducers and microphones. In this example, an array of microphones/transducers is used, combining contact transducer(s) (2302) and microphone(s) (2304). As one example, a contact transducer that is in direct contact with the cooking vessel is combined with a microphone that is also utilized for voice commands.

In some embodiments, multiple transducers and microphones are used to improve acoustic sensing, where such an array of combined acoustic sensor types is used to detect signal phase or time delay. In some embodiments, such information is used to provide, for example, localization of sound origin. The array of acoustic sensors can be expanded with contact transducers that are beneath the top plate.

### Acoustics-Based Intelligence

The following are embodiments of cooking intelligence and control algorithms that incorporate acoustic sensing. Examples of acoustics-based cooking intelligence include utilizing or integrating acoustic sensing for cooking vessel characterization, cookware recognition, and cookware content state determination, further embodiments of which are also described below. In various embodiments, acoustic sensor measurements can be combined or integrated with other sensor measurements (e.g., temperature, weight, etc.) to further enhance cookware characterization and recognition, as well as ingredient state detection.

Acoustic measurements of the cooking vessel include measurements of the mechanical vibrations of the cooking vessel under various conditions that are picked up or detected by the acoustic transducers. Contact transducers can be used to directly measure the mechanical vibrations of the cooking vessel. Air-coupled transducers can be used to measure acoustic waves emanating from the cooking vessel (and that propagate through air) as a consequence of mechanical vibration of the cooking vessel.

The mechanical vibrations of the cooking vessel detected or picked up using acoustic sensors provide useful information for facilitating various types of intelligence. For example, as will be described in further detail below, acoustic sensor measurements of the cooking vessel can be used to perform characterization of a cooking vessel (e.g., to characterize thermodynamic response of the cookware) or cookware, passive sound sensing of the stage of food, as well as utilization of cooking vessel signatures (based on features of the vessel, including its acoustic spectra).

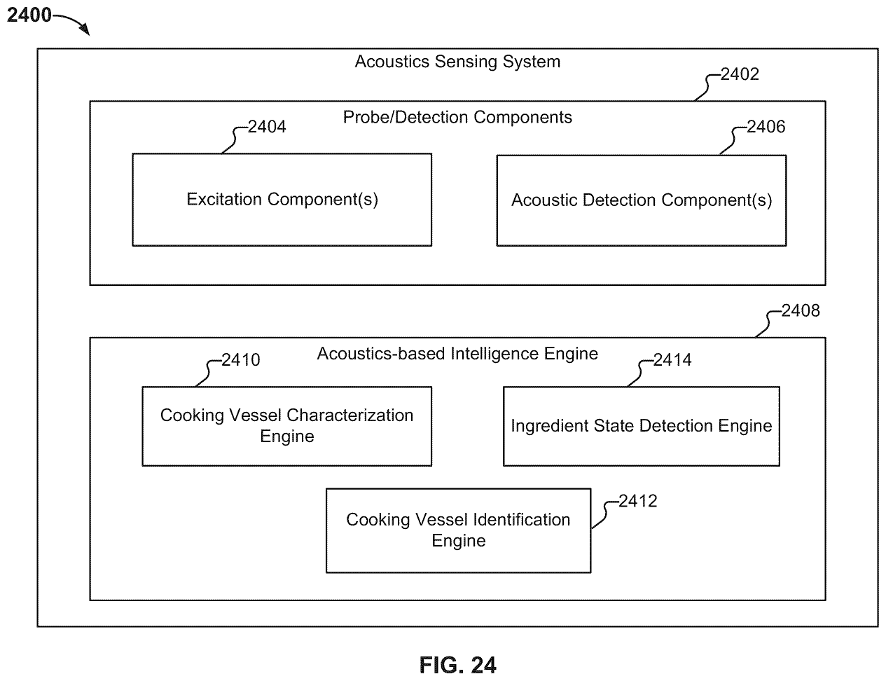

FIG. 24 illustrates an embodiment of an acoustic sensing system. In some embodiments, acoustics sensing system 2400 is an alternative view of control architecture 300 of FIG. 3. In this example, the acoustics sensing system 2400 further includes probe/detection component(s) 2402 and acoustics-based intelligence engine 2408.

In this example, probe/detection components 2402 includes excitation component(s) 2404. In some embodiments, excitation components include hardware elements that are used to facilitate probing by exciting a cooking vessel. Examples of excitation components include the induction coil of the cooking system, transducers such as piezoelectric transducers, etc.

Some types of intelligence, such as cooking vessel characterization and cooking vessel identification are facilitated by purposefully exciting the cooking vessel to induce mechanical vibrations in the cooking vessel. The response of the cooking vessel to the excitation is then listened for and detected by acoustic sensors. Further examples and details regarding excitation of cooking vessels are described below.

In this example, probe/detection components 2402 further includes acoustic detection component(s) 2406. In some embodiments, probing for cooking vessel signatures includes listening for, or determining, features of the cooking vessel, such as its resonant frequencies. As described above, in various embodiments, acoustic detection components include air-coupled microphones, transducers (e.g., piezoelectric elements), as well as combination or arrays of air-coupled microphones and (contact) transducers. The detection components include acoustic sensors that listen for or otherwise detect mechanical vibrations of the cooking vessel. The mechanical vibrations of the cooking vessel can be induced in response to a purposeful excitation. The mechanical vibrations of the cooking vessel can also be a consequence of other processes, such as cooking, where the manner in which the cooking vessel mechanically vibrates will vary depending on how the cooking process is progressing (e.g., as a user adds ingredients, the ingredients themselves change states, etc.). The mechanical vibrations of the cooking vessel are detected by the acoustic sensor, which will also mechanically vibrate due to the mechanical vibration of the cooking vessel. The mechanical vibration of piezoelectric elements due to the vibration of the cooking vessel are then converted a detected electrical signal that corresponds to the mechanical vibration of the cooking vessel.

In some embodiments, the excitation components and the acoustic detection components are separate components. In some embodiments, such as for explicit probing of the cooking vessel for cooking vessel identification, the excitation component and the detection component are used in conjunction with each other and configured to track each other (e.g., actively excite at some set of frequencies, listen for responses at the same excitation frequencies). Further examples and details of such control of acoustic excitation and detection are described below. In other embodiments, a same component is used for excitation and detection. For example, a piezoelectric is driven (e.g., with input electrical energy) to excite the cooking vessel to induce mechanical vibration of the cooking vessel, where the same piezoelectric electric transducer, is also impacted by the mechanical vibrations. The behavior or characteristics of the transducer under such circumstances can then be used to facilitate intelligence with respect to the cooking vessel.

In the example of FIG. 24, acoustics-based intelligence engine 2408 is configured to integrate acoustic probing/sensing into various forms of cooking intelligence. In some embodiments, acoustics-based intelligence engine 2408 is an alternative view of system controller 304. In this example, the acoustics-based intelligence engine 2408 includes cooking vessel characterization engine 2410, ingredient state detection engine 2414, and cooking vessel identification engine 2412. In some embodiments, acoustics-based intelligence engine 2408 is configured to control excitation component(s) 2404 and/or acoustic detection component(s) 2406 to facilitate acoustics-based cooking intelligence. Further details regarding acoustics-based cooking intelligence are described below.

### Characterization of Cooking Vessel

In some embodiments, the acoustic sensing system described herein facilitates characterization of a cooking vessel. In some embodiments, cooking vessel characterization is performed by cooking vessel characterization engine 2410. In various embodiments, one or more of impedance reflectance spectra, acoustic spectra, and/or weight are used to detect and uniquely correlate to the thermodynamic response of the cooking vessel. The improved cooking vessel characterization facilitated by acoustic sensing provides improvements such as improved heating and cooking algorithm performance.

In various embodiments, a cookware's thermal characteristics (e.g., thermal conductivity, heat capacity as a function of applied inductive power, etc.) are characterized either real-time during cooking, or prior to cooking, to determine the optimal heating parameters to achieve highly consistent and high-quality cooking output.

For example, the acoustic resonances (including harmonics) determined via acoustic sensing provide information on the thermoelastic properties of the cooking vessel structure. As one example, the thermal properties of a cooking vessel are characterized by a comparison of a known input power to the cooking vessel temperature as a function of time, using a temperature probe measure the cooking vessel (where the temperature probe can be either in contact or not in contact with the cooking vessel).

### Acoustics-Based Cookware Identification/Recognition

In some embodiments, acoustic sensing is used to facilitate identification of what cookware or cooking vessel is being used with the cooking system.

In some embodiments, based on probing/excitation of a cooking vessel and pickup of the response of the cooking vessel to the excitation, acoustic features of the cookware (e.g., the resonant frequencies of the cooking vessel) are determined to generate unique cookware signatures or fingerprints for the cookware. As will be described in further detail below, in various embodiments, the features of the cooking vessel are determined based on evaluation of impedance reflectance spectra and/or acoustic spectra.

In some embodiments, cooking vessel signatures are generated and utilized as identifiers to optimize cooking performance. Such signatures that are based on acoustic properties facilitate the identification of specific cooking vessels without requiring additional electronics (e.g., RFID (Radio Frequency Identification), optical identification, etc.), or manual entry.

In some embodiments, the generated signatures are used to uniquely identify a cooking vessel's type/design. In various embodiments, the acoustics-based signature is correlated to other information about the cooking vessel, such as its electromagnetic or thermal properties (which can also be characterized using acoustic sensing, as described above), previous position, and/or settings when the cooking vessel used in conjunction with the intelligent cooking device described herein. Previous settings can be used to replicate recipes or techniques with high fidelity and accuracy.

In various embodiments, signature characteristics or features of the cooking vessel are detected using one or more of a combination of the following:
impedance spectra changes to back EMF (electromotive force) as a function of excitation at those frequencies (e.g., using excitation component(s) 2404).
acoustic response emission (e.g., infrasound, sound, and/or ultrasound) from acoustic excitation or when induction excitation causes electroacoustic conversion (e.g., by performing excitation using excitation component(s) 2404). Such response emissions are detected using acoustic detection component(s) 2406 (e.g., via transducers, microphones, etc.).

As will be described in further detail below, embodiments of the acoustics-based cooking vessel signature generation and identification described herein facilitate detection and differentiation of cookware, even if two cooking vessels have similarities in terms of size, material, shape, etc.

In some embodiments, the generation or creation of cooking vessel signatures for identification utilizes electromagnetic and acoustic properties. For example, electromagnetic properties (e.g., the response of a cooking vessel to an alternating current (AC) field, such as those used in induction) are related to material properties, including the layering, lamination, or aggregation of different materials. Each material or layer may have a different impedance spectrum: layering or aggregation creates impedance mismatches which are seen as peaks in the impedance spectrum. Acoustic properties include those related to the above electromagnetic properties (e.g., electroacoustic response), as well as feature dimensions and thermo-elastic (acoustic) characteristics of those features (including, for example, handle, embossing, and cooking vessel shape in three axes (e.g., r, theta, and phi in polar coordinates at frequencies <100 kHz, or mm or mm-sized square structures if, for example, using >10 MHz frequencies).

The following are embodiments of passive receiver techniques for cookware signature generation and identification. In various embodiments, probing/determination of cooking vessel signatures is accomplished through the use of one or more of impedance load sensing, contact transducers, and/or air-coupled transducers.

### Impedance Load Sensing

In some embodiments, probing of cooking vessel signatures using impedance loading sensing includes sensing frequency, amplitude, and phase (relative, for example, to the drive/excitation signal). In some embodiments, impedance load sensing includes utilizing a detection circuit that is isolated from the high-power excitation drive. The detection circuit also has a bandwidth in the range of the frequencies of interest (e.g., > or <20 kHz). In some embodiments, probing of the cookware via impedance load sensing includes a drive signal that is AM modulated (amplitude modulation). In some embodiments, probing of cookware signatures via impedance load sensing includes a time-gated signal through ring-out when a coil is used to perform intentional excitation, for example as an intermittent chirp or burst.

Impedance load sensing can be performed either with or without a dedicated transmitter signal. The following are embodiments of impedance load sensing without a dedicated transmitter. In some embodiments, operating frequency and amplitude are functions of the impedance matching to the cooking vessel to the induction coil-circuit. This can include cooking vessel material and the aggregate of the cooking vessel and content within the vessel. The relative amplitude is a function of the cooking vessel's material and its ability to couple energy out of the induction coil. Non-linearity in power in for constant power from the coil is unique to multi-layered (multi-material) cooking vessels, particularly in the case of delamination. The relative phase is a function of the cooking vessel's magnetic properties. The relative phase is also proportional to the material. In some embodiments, out of band frequencies (frequencies other than the drive frequency) include sounds being made by the cooking vessel's contents, fans, or structures that are coupled to the cooking vessel.

The following are embodiments of impedance load sensing when a transmitter is used (e.g., chirp or burst transmission). In some embodiments, the reflected response of the induction coil-cooking vessel system as a function of frequency is dependent on: geometry of the cooking vessel (resonances); and mass of the cooking vessel-contents aggregate (where harmonics fall off as a function of mass. In some embodiments, out of band frequency and associated phase differences as a function of time include: sounds being made by the cooking vessel-contents, fan, or structure; changes to the contents of the pan (water content, gelatinization/crystallization/denaturation).

### Air-Coupled Transducer

In some embodiments, probing of cookware signatures using an air-coupled transducer (e.g., microphone) involves a frequency cut off, similar to the above embodiment involving a contact transducer, but with a rejection that is higher either spatially or in frequency. In various embodiments, excitation is provided by the induction coil or a contact transducer.

In various embodiments, probing of cooking vessel signatures through the use of air-coupled transducers is performed with or without dedicated transmitters. In some embodiments, if a dedicated transmitter is not used, then the detected frequency and amplitude are the operating point and coupling efficiency of the induction coil to the cooking vessel, which includes cooking vessel material and contents-cooking vessel aggregate. Out of band frequencies (e.g., frequencies other than the drive frequency include sounds being made by the cooking vessel-contents, fans, and environment, and may be dependent on the microphone directionality.

In some embodiments, if a transmitter is used (e.g., chirp or burst), then the detected response, as a function of frequency, is dependent on: the geometry of the cooking vessel (resonances); and sounds being made by the cooking vessel-contents, fan, and environment. Out of band frequency and associated phase differences as a function of time include time of flight arrival (wavelet) of frequencies provides localization of sound source relative to transducer, but at, for example, 350 m/s.

### Contact Transducer

In some embodiments, probing of cookware signatures using a contact transducer includes a detection circuit having common mode rejection of the high-power drive. In some embodiments, the detection circuit has common mode rejection of fan(s) in the system. In some embodiments, the detection circuit has a frequency bandpass above fan frequencies, and below driver frequencies. In various embodiments, the transducer is mounted to the top of the cooking device, to a floating probe (such as along with a thermal probe), etc. In some embodiments, excitation is provided through the induction coil, a transducer controlled to perform a sweep, or a transmitter/receiver in ring-out mode.

In various embodiments, probing of cooking vessel signatures through the use of contact transducers is performed with or without a dedicated transmitter signal. In some embodiments, if no dedicated transmitter signal is used, then detected frequency and amplitude are the operating point and coupling efficiency of the induction coil to the cooking vessel. This includes cooking vessel material and content-cooking vessel aggregate. Out of band frequencies (e.g., frequencies other than the drive frequency) include sounds being made by the cooking vessel-contents, fans, or structures that are coupled to the cooking vessel.

In some embodiments, if a transmitter is used (e.g., chirp or burst), the detected response as a function of frequency is dependent on: geometry of the cooking vessel (resonances); sounds being made by the cooking vessel-contents, fan, or structure; and mass of the cooking vessel-contents (where harmonics fall off as a function of mass). Out of band frequency and associated phase differences as a function of time include time of flight arrival (e.g., wavelet) of frequencies provides localization of sound source relative to transducer at a sound speed between 3000 m/s and 6000 m/s, involving a resolution of 0.1% of the resonance frequency.

Further embodiments regarding cookware signature generation for identification and recognition are described in further detail below.

The following are further considerations for transmitters for cooking vessel recognition. Due to sound speed of ˜5.7 km/s, usable resonances <100 kHz may be circumferential and cross diameter of cooking vessel (e.g., pan) at different heights of pan. In some embodiments, mode splitting (e.g., adding peaks) can be accomplished or can be achieved by breaking symmetry or introducing scattering (e.g., holes, dissimilar materials, embossing, thickness variations, mounting, etc.). The features can include the handle, but in some cases only resonances of the handle will allow features on the handle to perturb the resulting spectrum. In some embodiments, a signature can be created in the 1-10 MHz regime (which may involve a separate transmitter (Tx) source), with ˜mm dimensional features.

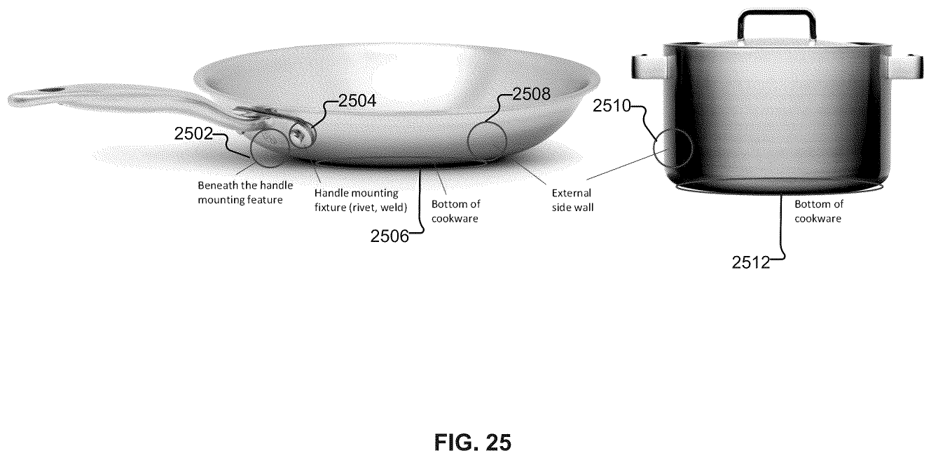

FIG. 25 illustrates an embodiment of cookware with features to facilitate cookware signatures. As described above, mode splitting (e.g., adding peaks in detected response, thereby creating different detectable patterns of frequencies) by breaking symmetry or introducing scattering (e.g., holes, indentations, dissimilar materials, embossing, thickness variations, mounting, etc.). Such features make one cooking vessel ‘sing’ (e.g., acoustically resonate) differently from any other cooking vessel. Example locations or areas of a cooking vessel at which specific signature features can be added or placed without affecting the reliability and robustness of the cookware include beneath the handle mounting feature (2502), handle mounting fixture (e.g., rivet, weld) (2504), bottom of pan cookware (2506), external side wall of pan (2508), external side wall (2510), and bottom of pot cookware (2512). Such locations are examples of areas of cookware where that are easy to manufacture, do not affect usability and cleanability, and do not affect cooking performance. For example, suppose two similar stainless pans. One pan can be stamped or mechanically embossed with a feature that results in creation of a unique sound resonance (and which can be used as a signature for the cookware).

The following are further embodiments regarding cookware signature generation for identification and recognition. As described above, contact acoustics (e.g., a contact transducer that is in contact with the cooking vessel) can be used to probe a cooking vessel and determine a signature for the cooking vessel.

As described above, in some embodiments, acoustics-based cookware identification includes exciting the cookware (to induce a response including mechanical vibration of the cooking vessel responsive to the excitation), and sensing the response of the cookware to the excitation using one or more acoustic sensors. Different cooking vessels will have different acoustic responses, where the response of the cookware to the excitation is usable to identify the cooking vessel. For example, different cooking vessels will have different resonances (e.g., resonate at different patterns of frequencies), which can be used as fingerprints for identification. To determine such resonances, the acoustic and inductive properties of the cooking vessel are excited to elicit a response that can be picked up by acoustic sensors, and based on which the resonances can be identified. In some embodiments, the resonances of the cooking vessel are determined by evaluating the frequency spectrum of the mechanical vibration of the cooking vessel that is induced by the excitation and detected by an acoustic sensor. For example, the characteristics/signature of the cooking vessel are determined by performing a spectral analysis of frequencies in the acoustic response emission detected by a listening component (where the acoustic response emission is induced in response to acoustic excitation or when induction excitation causes electroacoustic conversion).

In other embodiments, the resonances of the cooking vessel are determined by evaluating characteristics of an acoustic sensor (e.g., frequency spectrum of a transducer's impedance) that change or are affected by the response of the cooking vessel to the excitation (e.g., to measure the effect of the mechanical vibration of the cooking on the impedance of the transducer as the transducer is also being driven with an AC voltage signal that will cause the transducer to mechanically vibrate). For example, the characteristics/signature of the cooking vessel are determined by performing a spectral analysis of an impedance spectrum of the transducer, where the impedance spectrum is a function of, or otherwise based on

The following are three embodiments of modes of utilizing contact acoustics for cooking vessel identification.

### Contact Acoustics-Coil Excitation Mode

In some embodiments, the induction coil of the system (that is also used for heating) is used as an excitation component to induce mechanical vibration of the cooking vessel. In some embodiments, an acoustic sensor such as a transducer is used to sense the mechanical vibration of the cooking vessel induced in response to the excitation. A frequency spectrum analysis of the returned signal (e.g., spectral analysis of the spectrum of frequencies in the electrical signal corresponding to sensed mechanical vibration of the cooking vessel responsive to the excitation) is used to identify the resonance frequencies of the cooking vessel. That is, in this example mode, the signature of the cooking vessel is identified by performing probing using the coil for excitation, and a contact acoustics transducer for pickup.

In this example, in which there is coil excitation to induce vibration in the cooking vessel, and a piezoelectric transducer to listen to the response, different cooking vessels exhibit different patterns of frequency response. These different patterns of response are used as signatures to uniquely identify and differentiate between cooking vessels.

With an induction coil, when driven, current flowing through the induction coil will induce currents in the metal of the cooking vessel. As the metal of the cooking vessel resists the induced current, the cooking vessel will physically move. This is referred to as the magnetostrictive effect. The mechanical vibration/movement of the cooking vessel is picked up by the contact transducer that is contact with the cooking vessel. For example, due to the characteristics of the cooking vessel (its physical dimensions, layers, thicknesses, etc.), there will be waves of motion or flex across the pan at various frequencies. Different parts of the cooking vessel may be vibrating, some parts in phase with other parts. In some embodiments, the contact acoustics sensor (e.g., piezo transducer) will detect vibrations at the different frequencies as the waves of motion across the cooking vessel cause varying amounts of pressure on the piezoelectric transducer. One benefit of the coil excitation mode is that elements that are for pan presence detection can be leveraged. For example, pan presence detection is used to prevent the induction stove from being turned on in the event that no pan is detected in the presence of the induction coil. For example, a small signal is sent via the induction coil. Measurements with respect to the coil are taken (e.g., resonance frequency, voltage drop, etc.). If, for example, a voltage is detected with respect to the induction coil, this is indicative of a cooking vessel being on top of the induction coil. In this way, the same circuit for cooking (e.g., that includes the induction coil), can also be controlled to facilitate cooking vessel identification, thereby reducing complexity.

In some embodiments, the contact piezo transducer used as the detection component in this mode is configured to pick up the mechanical vibrations of the cooking vessel in response to excitation. The detected mechanical vibrations of the cooking vessel, also referred to in this example as a returned signal, are analyzed to determine the resonance frequencies of the cooking vessel, either at a natural or a predetermined frequency.

In this example mode, vibration is induced in a cooking vessel using the induction coil. The induction coil, when activated or driven, will transmit power at a wide range or band of frequencies, effectively probing the cooking vessel with energy at multiple excitation frequencies. The multi-frequency induction will induce currents in the cooking vessel, which result in the cooking vessel vibrating. The induced vibration of the cooking vessel is then picked up with a transducer (e.g., piezoelectric transducer). The cooking vessel will have a greater loudness at the cooking vessel's resonant frequencies. This is picked up by the receiver as peaks in amplitude at those resonant frequencies.

For example, during cooking vessel identification, the cooking vessel is continually excited by the coil, where the excitation is a broadband excitation with power across a range of frequencies. In one embodiment, the detector or listening acoustic sensor (e.g., listening contact transducer) is configured to identify the cooking vessel's resonance frequencies by perform a sweep, where for one period of time, a filter is applied to listen or take measurements at a first frequency, and then for a second period of time, a filter is applied to listen or take measurements at a second frequency, and so on (e.g., listening at different frequencies is multiplexed in time). In this case, continual excitation (which is wideband or broadband) is being performed, where the detector is measuring at one frequency at a time. In other embodiments, multiple filters are utilized such that multiple frequencies are listened to by the detector simultaneously. For example, an 8-input or 16-input detection circuit with programmable filters is used. As another example, a discrete FFT can be performed to isolate individual frequency components from a returned signal.

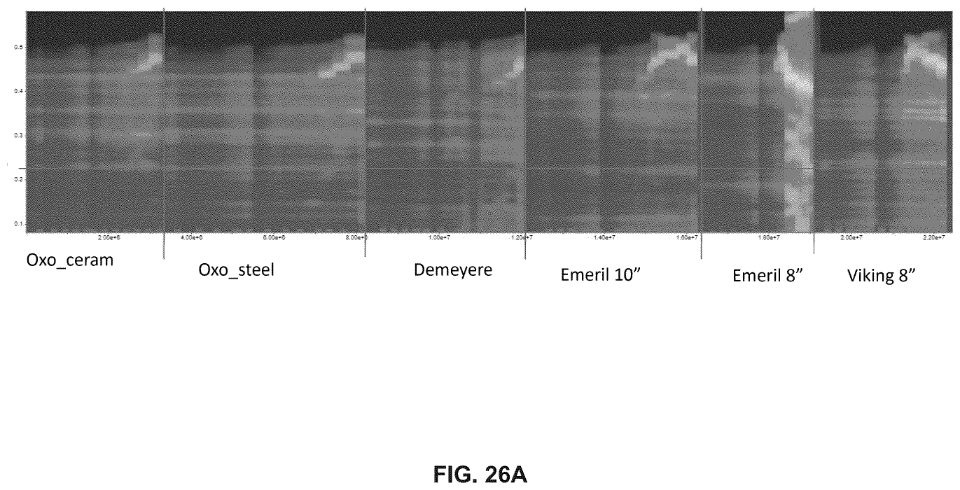

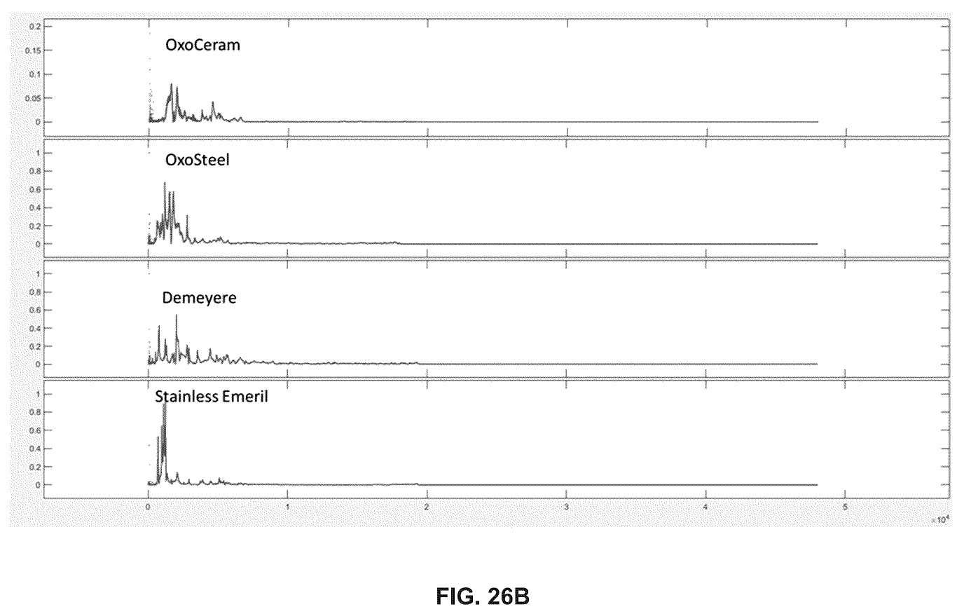

FIG. 26A illustrates an embodiment of patterns of frequency response for different cooking vessels with coil excitation and piezoelectric listening.

The use of the induction coil as an excitation component provides contactless transmission. Some factors to take into consideration is that the coil excitation mode may be dependent on positioning of the cookware, which can affect frequency. With respect to coil excitation, the placement of the cooking vessel relative to the induction coil can change the frequency response. For example, when the cooking vessel is moved, the cooking vessel's resonances at which the coil's energy is received is changed. While the peaks at certain frequencies are still present, the amounts of energy or amplitude of the response will be different. For example, if a cooking vessel is moved to the side, then a different main frequency will occur, which will in turn have different harmonics. In some embodiments, the frequency spectrum that is probed is constrained. The coil may also send out power at multiple frequencies, with modes excited by the coil-cooking vessel system.

In an alternative embodiment, coil excitation is performed to induce mechanical vibration of the cooking vessel as described above, where instead of using a contact transducer to perform the pickup of the response (e.g., the cooking vessel's response to the excitation), the coil is used to perform the pickup. For example, when currents are induced in the cooking vessel that is on the coil, the cooking vessel is effectively turned into a membrane. As the membrane, which may be slightly magnetized, starts to vibrate with the induction coil, the induction coil will also experience a back EMF that is measurable. The mechanical vibration of the cooking vessel is converted back into a change in the effective impedance of the coil, where the coil is experiencing reflected energy. In another embodiment, two separate coils are utilized, a first coil for excitation and a second coil for listening for a returned signal. In some embodiments, the second coil is configured to resonate at frequencies that are not the main drive frequency.

### Contact Acoustics—Transmission Mode

The following is an embodiment of a cooking vessel identification mode referred to as a transmission mode. In this example mode, separate transducers are used to perform excitation and pickup of the response to the excitation. For example, a first piezoelectric contact transducer (referred to in this example as a transmission contact transducer) is used to excite the cooking vessel, and a second piezoelectric contact transducer (referred to in this example as a receiver or listening/detection contact transducer) is used to pick up the response (e.g., mechanical vibration of the cooking vessel induced in response to the excitation by the transmission transducer).

For example, in this probing mode, a wave is launched at one location on the cooking vessel using the transmission transducer, and a wave through the cooking vessel is picked up at another location on the cooking vessel via a receiver or detection transducer. As the cooking vessel is excited, the listening transducer will be measuring multiple cycles worth of energy at a given frequency.

In some embodiments, the transmission transducer is actively controlled to generate an excitation signal (e.g., transducer movement that will strike the cooking vessel that is in contact with the transmission transducer, thereby inducing mechanical vibrations in the cooking vessel) that will have energy at one or more frequencies. In response, the cooking vessel will vibrate, where the vibration will be detected as a modulated version of the excitation signal. For example, suppose that the excitation signal has multiple frequency components, where each component has the same amplitude. As one example, the piezoelectric transmission transducer is driven with an oscillating electrical drive signal that has multiple frequency components, each with the same voltage peak (say, for example, 5V). This electrical driving signal is then converted into mechanical motion of the transducer corresponding to the frequency/amplitude of the driving signal. The mechanical motion of the transducer (e.g., compression and expansion of the piezoelectric material in response to the electrical driving signal is then transferred to the cooking vessel that the transmission transducer is in contact with, causing the cooking vessel to also mechanically vibrate in response.

While the excitation signal will be the same amplitude for every frequency, the raw signal (detected by the listening transducer) of the vibration of the cooking vessel in response to the excitation will have various different amplitudes at the excitation frequencies. For example, the returned signal is a modulated or altered version of the excitation signal, where the manner of modulation is based on the characteristics of the cooking vessel that is excited. There will be certain peaks in the spectra of the returned signal (picked up by the listening transducer) that correspond to resonances of the cooking vessel (where a resonance frequency is a frequency where there is mechanical amplification of that component in the excitation signal, due to the properties of the cooking vessel). For example, a resonant frequency is a frequency at which the cooking vessel “sings,” where if the cooking vessel is pushed by the contact transducer with a certain amount of energy or amplitude at the resonant frequency, the amplitude of that inputted frequency will be mechanically amplified (and have greater amplitude in the resulting returned signal). If the cooking vessel is pushed by the transducer at a non-resonant frequency, then the cooking vessel will not mechanically amplify that frequency, and the amplitude of that frequency in the returned signal is modulated to be lower. That is, some frequencies that the cooking vessel is excited with (e.g., mechanically pushed/struck at a frequency, given an AC signal with a certain voltage amplitude at that frequency applied to the transmission transducer) will be amplified in the returned signal, where other frequencies that the cooking vessel is excited with will be reduced or attenuated. That is, the envelope or shape of the returned signal in the frequency domain (spectral) will not be constant, and will have peaks and valleys. If there were no energy at a certain frequency in the excitation signal, then there will be no energy at the same frequency in the returned signal (because there is no energy being put into the cooking vessel at that frequency).

In some embodiments, the transmission transducer is controlled to produce vibrations at a select set of specific frequencies. The response of the cooking vessel to the excitation (picked up by the listening transducer) at those probed frequencies is determined. The pattern of response at the probed frequencies is used to identify which of the probed frequencies are resonant frequencies (as well as which ones are not probed frequencies). The pattern of which probed frequencies are resonant frequencies, and which probed frequencies are not resonant frequencies is used as a signature or identifier of the cooking vessel being probed.

In this example transmission approach, separate sender and receiver transducers are utilized. In some embodiments, the sending/transmitting transducer produces or puts out or emits modulated signals (which, for example, are a superposition of multiple frequency components), while the receiver detects or picks up the sum or aggregate of all of the various paths of vibrations that travel within the cooking vessel as a result of the transmitted signals.

In this example approach, the cooking vessel material and dimensions define certain resonances in which certain frequencies are amplified as compared to others, due to mechanical vibrations constructively and destructively interfering with one another. In some cases, the spectra for transmission mode measurements may have a low baseline and rise to the peak resonances.

In some embodiments, both the excitation/transmission and listening/pickup transducers are located in a central component in the center of the mounting top plate (on top of which the cooking vessel rests). In some embodiments, the transmission and detection transducers are separated or isolated from each other (e.g., by being placed within separate structures in an assembly to acoustically split the two transducers, utilizing a material such as rubber to isolate vibrations of the cooking vessel from the mounting plate, etc.). For example, a dual element transducer is utilized. The transmission and listening transducers can also be placed apart from each other on the intelligent cooking system.

Using embodiments of the transmission mode techniques described herein, known resonances can be reproducibly excited. Different patterns of detected resonant frequencies are used as signatures to identify and differentiate between different cooking vessels. For example, the cooking vessel is “hit” with the transmission transducer. In some embodiments, the transmission transducer is excited with a select, certain set of frequency bands. The pickup/listening transducer listens for the response. The response/returned signal is evaluated to identify resonant frequencies of the cooking vessel, which are used to form an identifier of the cooking vessel. As one example, a processor (e.g., digital signal processor performing an FFT) performs frequency spectrum analysis of the returned signal generated by the listening transducer (e.g., for the selected probed frequency bands, rather than an entire frequency band) to determine a pattern of frequency response to the probed input signal.

FIG. 26B illustrates an embodiment of patterns of frequency response using contact acoustics. In this example, utilization of cookware signatures is shown. Acoustic/electromagnetic excitation signatures of four different cooking pan designs are shown. As shown in this example, by evaluating frequency response, different signatures of different types and brands of cooking pans can be observed

In the above example, transmission and listening components are both piezoelectric transducers. In another embodiment, a piezoelectric transducer is used as the excitation/transmission component, where the induction coil is used as a listening component. For example, vibration of the cooking vessel is induced by a piezoelectric transducer, where the response of the cooking vessel at the cooking vessel's resonances or the perturbation to the induction coil is picked up as back EMF on the induction heating coil.

### Contact Acoustics—Impedance Mode

In this example mode, the same piezoelectric transducer performs both excitation of the cooking vessel and pickup/listening of the cooking vessel's response to the excitation. In this example, the piezoelectric transducer is used to excite the cooking vessel with a predetermined frequency. The impedance of the transducer at the excitation frequency is measured. If resonance occurs at the excitation frequency, then there will be a significant drop in impedance. In some embodiments, drops in impedance are monitored for. The frequencies corresponding to the impedance drops are recorded as part of the identifier for the cooking vessel.

As one example, the contact transducer is being driven to excite the cooking vessel by striking it in a manner that corresponds to an electrical driving signal. At the same time, the cooking vessel is mechanically vibrating due to being struck. The vibrating of the cooking vessel, which is in contact (or otherwise mechanically coupled) with the contact transducer, will impact the contact transducer's ability to compress and expand in response to the driving signal. The impact that the vibration of the cooking vessel has on the ability of the transducer to mechanically compress/expand in response to a driving signal is frequency dependent. For example, when the transducer is being driven at frequencies that correspond to resonant frequencies of the cooking vessel, the cooking vessel's vibrational response will pose less opposition or resistance to the transducer's ability to be displaced given the input electrical energy. In some embodiments, the impact of the cooking vessel's vibration on the transducer's ability to compress and expand in response to the electrical driving signal is determined by monitoring the impedance of the transducer.

In this example, a same contact acoustics transducer element (e.g., same piezoelectric transducer) is utilized for both excitation and pickup, which reduces the number of components needed for cooking vessel identification. In this example, piezo excitation is performed, where the pickup is of reflectance. As described above, one benefit of this mode is that only a single piezoelectric transducer is needed. Further, in this mode, there is direct excitation, with increased fidelity.

As one example, the transducer is electrically driven with an AC signal at a certain frequency and voltage amplitude to generate a mechanical vibration at that frequency and with an amount of mechanical movement that corresponds to the amplitude of the driving signal. If that frequency is a resonant frequency of the cooking vessel to which the transducer is contacted, then the cooking vessel will vibrate at the same frequency as the transducer. When this occurs, the impedance of the transducer will drop. Thus, drops in impedance of the transducer can be used to identify resonant frequencies of the cooking vessel. As one example, a discrete set of probe frequencies is tested. This includes driving the transducer (that is in contact with the cooking vessel) with an AC signal with a certain voltage and frequency. Suppose that first, a 5V signal at 1 kHz is used to drive the contact transducer. The transducer will convert the electrical driving signal to mechanical displacement that strikes or hits against the cooking vessel. The cooking vessel, in response, will vibrate against the contact transducer (that is also trying to move due to the electrical driving signal). The impedance of the transducer is measured at 1 kHz. The transducer is then driven with a 5V signal again, but with a different frequency (e.g., 2 kHz). The impedance of the transducer is measured at 2 kHz. Because the cooking vessel is directly in contact with the transducer, it loads or affects the ability of the transducer to mechanically move, thereby impacting its impedance.

In this example approach, a single transducer is used to both send/transmit a signal to the cooking vessel, and also to receive/detect the response. In this example, a reflectance approach is utilized with the single transducer. For example, the transducer is driven to excite the cooking vessel. However, the mechanical system responds out of phase (e.g., a time-delayed version of what was previously sent). The returned signal detected on the transmitter is thus not what is currently being driven by the system, but rather the sum or aggregate of the drive signal, as well as the time delayed (and thus frequency delayed, if a sweep excitation such as that described above were used) response of the system.

In this example approach, the cooking vessel material and dimensions define certain resonances in which certain frequencies are amplified as compared to others, due to mechanical vibrations constructively and destructively interfering with one another.

In this example, the transducer is driven with an electrical drive signal to mechanically push/strike the cooking vessel at certain frequencies (e.g., with different frequencies over time, or a signal that is a superposition of multiple signals at different probe frequencies).

The cooking vessel, if it is in resonance (where frequency of the transducer's pushing matches a resonant frequency of the cooking vessel), the cooking vessel will not push back. When the cooking vessel is not in resonance, the cooking vessel will push back. Thus, the voltage that is needed for the piezoelectric transducer to push the cooking vessel will change as a function of what frequency that piezoelectric transducer is being driven at. For example, in a piezoelectric transducer, electricity is turned into strain which is converted into mechanical displacement. The cooking vessel acts as a frequency dependent electromechanical load, where the cooking vessel, depending on its resonant frequencies, may inhibit the mechanical displacement of the transducer to varying degrees when it is driven. For example, if the transducer is driven or provided with an AC signal that has a certain voltage and current, it will be able to mechanically displace by a certain amount if not in contact with the cooking vessel. However, if the cooking vessel pushes back against the movement of the transducer, given the AC signal that is being applied, this will result in a back EMF and change in impedance.

The transducer's electrical impedance is determined based on the amount of voltage driving the transducer and the amount of current that passes through it. In some embodiments, the spectrum of the transducer's impedance is analyzed. At resonant frequencies of the cooking vessel, where there is little to no mechanical resistance to the transducer, the measured electrical impedance of the transducer will also drop. That is, the amount of mechanical resistance encountered when running or driving the transducer will be seen as an electrical impedance change on the transducer (due to electromechanical conversion), where mechanical mismatches have corresponding electrical effects.

In some embodiments, reflectance measurements are determined in part using impedance measurements. Examples of circuits to perform impedance measurements include those using comparators, oscillators, inverters, etc.

In some embodiments, the spectra of the impedance of the transducer is analyzed to identify resonant frequencies of the cooking vessel. As one example, in the impedance spectrum, the drops or valleys in impedance correspond to resonances of the cooking vessel. In the spectra for reflectance measurements, resonances correspond to valleys or troughs in the frequency response (in contrast to being at peaks), as energy is being pulled out of the transducer at resonances.

The following is an example of cooking vessel identification based on impedance measurements. As one example, excitation is performed at a discrete set of frequencies, such as 3 kHz, 5 kHz, 6 kHz, and 8 kHz. The impedance/reflectance is measured for each of the transmission frequencies. Valleys, drops, or troughs at any of the discrete set of frequencies indicate the resonant frequencies of the cooking vessel being propped. As one example, the resonant frequencies are encoded based on whether a drop in reflectance/impedance was measured for a given tested frequency. As one example, a bit-wise encoding is utilized. For example, for a given frequency, a bit value of “1” is assigned if an impedance drop was detected for that frequency. A bit value of “0” is assigned if no impedance drop was detected for that frequency. For example, if impedance drops were detected at 3 kHz, and 6 kHz, but not 5 kHz, and 8 kHz, then the following encoding would be generated:

3 kHz=1; 5 kHz=0; 6 kHz=1; 8 kHz=0

This results in a detected signature for the cookware (based on resonant frequencies) of 1010. A different cooking vessel with different resonances will have a different bit pattern (with different encodings of whether the probed frequency was or was not a resonant frequency for the particular cooking vessel) that uniquely identifies it. Other encoding schemes for generating signatures based on spectral analysis are described below.

The measured impedance may depend on the damping of the overall system. In some embodiments, clamping is taken into consideration. Resonances or the sensor may be overdamped. For example, the assembly of the contact transducer may influence the coupling of wave energy from the transducer into the cooking vessel. Further, the detected response may be not only be due to vibration of the cooking vessel, but also the vibration of the entire cooking device as well (e.g., where resonance of the entire mechanical system is being measured). In some embodiments, to address potential issues such as overdamping, In some embodiments, the frequency response for the entire assembly is characterized. In some embodiments, contact force is adjusted to maintain consistent contact. In some embodiments, optimization includes performing tuning, such as increasing sensitivity, reducing weight, reducing dampening effects, etc.

### Combination Mode

In some embodiments, a combination of induction coil excitation and contact acoustics is utilized. For example, a multi-stage identification is performed, in which a coarse identification is performed using a coarse identification mode, and then a more refined identification is subsequently performed. As one example, the induction coil is used to narrow down to major cookware types (e.g., smaller pan or bigger pan, thin material or thicker material, etc.). Subsequently, a contact acoustics-based mode such as that described above is used to detect a narrower range. For example, the coarse categorization is used to reduce the frequency bands that the contact-acoustics identification modes probe for responses over.

### Further Embodiments Regarding Active/Passive Excitation

The following are further embodiments regarding active control of excitation components (e.g., transmission/excitation contact acoustic transducers). In the above example transmission and impedance modes, a transducer is actively driven to produce a particular emitted signal to excite the cooking vessel. This includes generating a signal that will probe the cooking vessel at various frequencies. In some embodiments, the transducer is excited to emit a signal that has multiple frequency components. The multiple frequency components can be combined together (e.g., superimposed on one another), or individually probed.

As one example, the transducer is controlled to generate a signal that sweeps through a range of probe frequencies as a function of time. For example, the emitted signal (e.g., mechanical vibration of transducer) starts off at a low frequency, and becomes progressively higher frequency over time. The frequency of the mechanical vibration of the piezoelectric transducer is controllable by adjusting the oscillating electrical signal used to drive the transducer (e.g., by adjusting the AC voltage signal used to drive the transducer by adjusting voltage amplitude and frequency). In some embodiments, the signal, while varying in frequency over time, is constant in amplitude. In response to the excitation at varying frequencies, the cooking vessel will vibrate. The amplitude of the cooking vessel's responsive vibrations will be different at different frequencies (due to the characteristics of the cooking vessel). For example, the vibrations of the cooking vessel in response to the emitted probe signal will have a greater or lesser amplitude based on whether or not it is at a resonant frequency.

With respect to probing with a frequency sweep, there will be large swaths of emitted frequencies for which there will be no detectable response from the cooking vessel. However, driving the transducer to generate such frequencies still involves inputting of energy into the transducer for periods of time.

In some embodiments, the cooking vessel identification process involves generating a probe signal with a selected or discrete set of probe frequencies. As one example, suppose three different cooking vessels. Probing can be performed to excite the cooking vessels at five different frequencies, where the five different frequencies are selected to align with resonant frequencies for some cooking vessels, and non-resonant (or anti-resonant) frequencies for others. For example, discrete frequencies are selected that include known resonances and known non-resonances across a large variety of cooking vessels. A discrete blend of such frequencies is then used for probing. The response of the cooking vessel at those probed frequencies is determined from the detected returned signal. The pattern of responses to the probed frequencies (e.g., that a probed frequency is or is not a resonant frequency of the cooking vessel) is encoded as an identifier of the cooking vessel)

As described above, in one example, the amplitude responses to the particular probed frequencies (transmission mode), or transducer impedance drops at probed frequencies (impedance mode), can be used to generate a binary encoding that encodes whether or not a probed frequency is a resonant frequency of the cooking vessel. An example of such a binary encoding is described above. In another embodiment, for each probed frequency, how resonant that probed frequency is for the cooking vessel is encoded. For example, the ratio of the amplitude of a probed frequency to the highest detected amplitude in the detected response of the cooking vessel is computed (or in the impedance mode, the ratio of impedance drop of a probed frequency to a highest detected drop in the impedance spectra). This results in another type of signature in which further granularity is encoded to differentiate between cooking vessels. For example, rather than encoding resonant or non-resonant, an amount of resonance or non-resonance can also be encoded for each probed frequency in the returned signal (transmittance response or reflectance response) that had been probed. In some embodiments, the amount of resonance is indicated as a ratio of received amplitude at one frequency versus the received amplitude at another frequency. In some embodiments, the ratio is relative to the amplitude of the excitation. The returned signal can be in various units, such as Volts, Ohms, etc. The use of relative amplitude or ratios of amplitudes to perform normalization provides benefits over using absolute amplitudes, as there can be attenuation due to various factors.

The following are further examples of generating an excitation signal with a selected set of probe frequencies. As one example, an excitation signal is generated in which signals at each of the probe frequencies are superimposed on each other (e.g., via modulation). As another example, chirping is performed over time, where different pulse echoes are emitted over a span of time, with each pulse being at a different probe frequency. For example, pulse echoes with different probe frequencies are emitted sequentially over time. The emitted signal is provided with enough energy at a desired probe frequency to elicit a detectable resonant response in the cooking vessel (if the probe frequency is a resonant frequency of the cooking vessel).

In some embodiments, the detection transducers are configured to listen in a manner that corresponds to how the excitation signal is produced. For example, if a pulse echo with a different probe frequency is emitted every two seconds, this is akin to a form of time division multiplexing, and the detection transducer is configured to listen for the cooking vessel's response at the corresponding probe frequency for that window of time. In this example, a constantly shifting emitter frequency is paired with a constantly shifting pickup, where the detector and the emitter track each other (or are locked with each other) for what frequency is of interest and should be monitored for. In this way, the detector only listens for responses to the sounds that are being emitted, while allowing rejection of other sounds that are not relevant.

If the excitation signal produced by the transducer is a super position of multiple probe frequencies simultaneously, then in some embodiments, the detector circuit is configured to have multiple receivers/filters working in parallel that each individually pass a band around a particular probe frequency. For example, if a superimposed signal is generated with five probe frequencies, then five receivers are configured such that each receiver is locked to a specific probe frequency (e.g., to listen for returned sound at one of the five probe frequencies). The locking can be achieved, as the magnitude and the phase of the emitted signal is known (as it was actively created). In this example, excitation and listening are both actively controllable (due to, for example, always knowing the magnitude and phase of every frequency). This allows picking up select frequencies as desired (e.g., that correspond to frequencies that were actively and selectively included in the probe/excitation signal). For example, comparator circuits can be used to effectively lock the detector to track the excitation circuit, allow rejection of select frequencies, and pickup of select frequencies (e.g., listening for only frequencies in the returned signal that are in a known phase relationship and that are tracking). In other embodiments, an FFT is used to extract and analyze individual frequency components from returned signals (e.g., electrical signal corresponding to sensed mechanical vibration of cooking vessel, or impedance signal in impedance mode).

In the case of the coil mode, the excitation of most induction coils will be such that there is energy across a range of frequencies, and not only at a main frequency (e.g., at sidebands or side lobe frequencies as well). That is, there is a wide spectrum of power. As the coil is being excited across a range of frequencies, this will induce vibrations in the cooking vessel that are also across a range of frequencies. Some of the frequencies in the coil excitation will correspond to resonant frequencies of the cooking vessel, and given the inefficiency of the coil, will have sufficient power at those frequencies (even though they may not be a main frequency of coil excitation) to cause a detectable response in the cooking vessel at that frequency (if there were no energy at the frequency that was transmitted, then there will be no response from the cooking vessel at that frequency). In this case, the frequencies of the coil excitation are not necessarily actively controlled. For example, the coil excitation is uncontrolled, and the excitation is passive. The detector can still be configured to listen for the responses at a selected set of specific frequencies to generate an encoding for each frequency in the selected set of frequencies that is a measure of how much a given frequency is a resonant frequency of the cooking vessel.

The above contact acoustics-based cooking vessel identification modes are reproducible, where over multiple trials, the same cooking vessel will consistently exhibit the same frequency response to excitation.

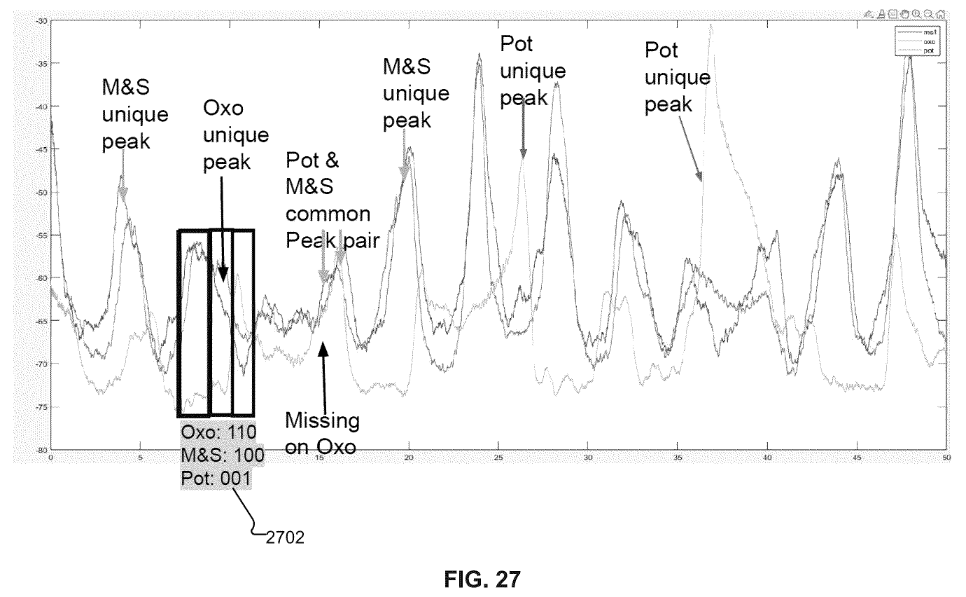

As described above, using the contact-acoustics based identification modes described above, cooking vessel discrimination and differentiation is facilitated. FIG. 27 illustrates an embodiment of cooking vessel discrimination based on frequency response. In this example, three probe frequencies were selected. The frequency responses for different cooking vessels with respect to the three probe frequencies are binary encoded (e.g., “1” if probe frequency is a resonant frequency, “0” if probe frequency is not a resonant frequency). An example of different binary encodings (from frequency response) usable to identify three different cooking vessels is shown at 2702. In some embodiments, as part of the identification process, a cooking vessel is probed multiple times. The raw response signals over the multiple probes are aggregated together, such as using coherence averaging. Identification is then performed on the aggregate frequency response.

The use of contact acoustics as described herein provides various benefits. For example, one alternative, as described above, is to use NFC/RFID tags in cookware for vessel identification. While the use of such tags is beneficial in identifying cookware, even with protection, they may degrade over time (e.g., due to high temperature, humidity, exposure, corrosion, etc.). As another example, the kitchen induction (KI) standard is not designed for regular cookware detection, and involves a coupling circuit within the coil/heating area of the cookware. While weight measurements can be used to facilitate cooking vessel identification, one scenario that a purely weight-based identification may have challenges in differentiating between cookware is if the cookware is pre-filled with an ingredient prior to identification (e.g., there is water already in a pot prior to the identification process being run). Similarly, while temperature measurements can also be used to facilitate identification of cooking vessels, identification based solely on temperature profiles may have difficulty differentiating cookware when ingredients are added to the cooking vessel prior to identification. Optical techniques (e.g., bar codes, unique color/patterns of color placed on the underside of a cooking vessel) can also be utilized, but may degrade over time due to cooking vessel pollution (e.g., blackening when using gas stove over time).

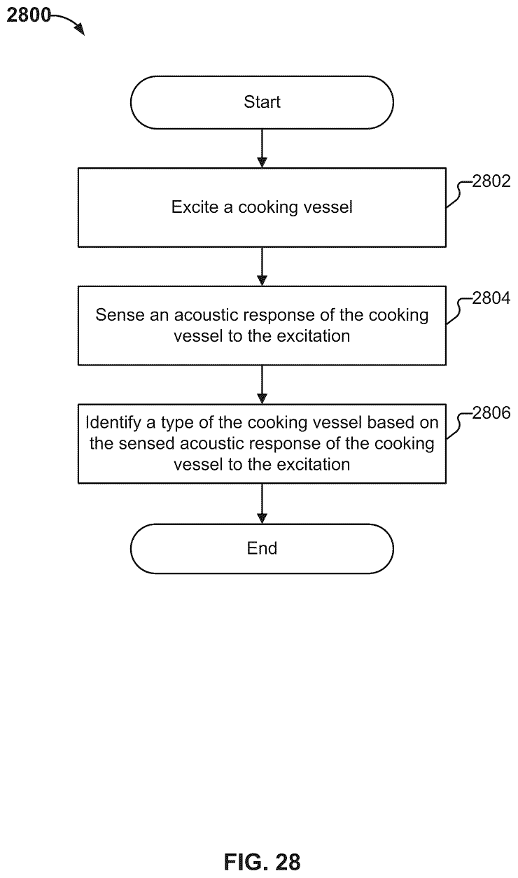

FIG. 28 is a flow diagram illustrating an embodiment of a process for acoustic sensing-based cookware identification. In some embodiments, process 2800 is executed by cooking vessel identification engine 2412. The process begins at 2802, when a cooking vessel is excited. For example, an excitation with energy at multiple frequency components is produced such that the cooking vessel is excited at one or more frequencies. The excitation is performed to induce vibration in the cooking vessel. The excitation is facilitated by driving an excitation component on top of which the cooking vessel is placed, such as an induction coil or a transducer (e.g., piezoelectric transducer). Other examples of excitation components include gas, resistive, or electrical components. The excitation component (such as in the case of a piezoelectric transducer) can be actively controlled to produce an excitation with a specific set of characteristics (e.g., energy at a specific set of probe frequencies). In some embodiments, multiple frequencies are included in the excitation that is used to induce a responsive mechanical vibration in the cooking vessel. For example, a selected discrete set of frequencies is superimposed on one another. As another example, a frequency sweep is used. As one example, a transmission transducer is excited with a sweep of frequencies as part of performing acoustic resonance spectroscopy

At 2804, an acoustic response of the cooking vessel to the excitation is sensed. For example, sounds or acoustic vibrations of the cooking vessel that are produced in response to the excitation (and that are propagated as acoustic waves) are sensed. In some embodiments, the response is detected using a detection component, such as an acoustic sensor (e.g., contact sensor and/or air-coupled acoustic sensor), or an induction coil in other embodiments. The acoustic response includes a returned signal that is based on how the cooking vessel responds (e.g., vibrates) in response to the excitation produced by the excitation component. As one example, a piezoelectric transducer picks up the response (mechanical vibration) of the cooking vessel that is produced in response to the excitation. The detection component can be the same or different from the excitation component.

In some embodiments, to reduce the amount of processing time and excitation energy, excitation is performed at a select number of probe frequencies (e.g., potential resonance frequencies or acoustic resonances), where modulation is performed. In some embodiments, more than two probe frequencies are utilized. In some embodiments, a fast Fourier transform (FFT), a series of narrow pass filters, etc. are used in a detection component/circuit to measure the amplitude and phase of the returned signal in each probe frequency band.

At 2806, a type of the cooking vessel is identified or determined based on the sensed/detected acoustic response of the cooking vessel to the excitation. In some embodiments, the acoustic response is detected or picked up using a sensor such as an acoustic sensor or transducer. The acoustic sensor may be in contact with the cooking vessel or air-coupled (and not in contact with the cooking vessel). An example of an acoustic transducer is a piezoelectric transducer. Examples of air-coupled transducers for use in non-contact pickup of acoustic responses are described above. In some embodiments, the piezoelectric transducer is located in contact with the cooking vessel. For example, the transducer picks up or detects the vibration of the cooking vessel induced by the excitation signal produced by the excitation component. As another example, with inductive excitation and listening, acoustic frequencies (sound vibrations) are picked up through an induction coil.

In some embodiments, identifying the cooking vessel includes determining a signature of the cooking vessel from evaluation of a signal that is based on the sensed vibrations. As one example, via the piezoelectric effect, the acoustic/mechanical vibrations from the cooking vessel that are sensed by the acoustic sensor are electromechanically converted into a corresponding electrical signal. The signature of the cooking vessel is determined by performing a frequency analysis of the spectrum of the electrical signal corresponding to the sensed acoustic vibrations (e.g., analysis of acoustic spectra). Another example of a signal that is based on the sensed vibrations is the impedance of the transducer. For example, the impedance of the transducer will vary depending on how the cooking vessel, which in some embodiments is in contact with the transducer, vibrates. The signature of the cooking vessel is determined by performing frequency analysis of the spectrum of the impedance (e.g., analysis of impedance spectra).

In some embodiments, identifying the cooking vessel includes determining resonant frequencies of the cooking vessel or amounts of resonances at certain frequencies based on evaluation of the returned signal (that is based on the mechanical vibration of the cooking vessel). In some embodiments, signals that are produced by contact transducers based on the response of the cooking vessel are analyzed in the frequency domain. For example, frequency spectrum analysis is performed on the returned acoustic spectrum or an impedance spectrum.

In some embodiments, an identifier of the cooking vessel is determined by encoding whether or not probe frequencies are resonant frequencies of the cooking vessel. The particular pattern of which probe frequencies are or are not resonances of the cooking vessel is used as an identifier of the cooking vessel. As another example, for each probe frequency an amount of resonance (or relative ratio) at the probe frequency is recorded. The patterns of the amounts of resonance at the probe frequencies is used as a barcode or other identifier for the cooking vessel.

For example, as described above, cooking vessel material and dimensions determine certain resonances, in which certain frequencies are amplified versus others, due to mechanical vibrations constructively and destructively interfering with one another. For example, a particular cooking vessel “rings” at a number of characteristic frequencies, corresponding to mechanical resonances (e.g., due to bending, torsion, flexing, circumferential, etc.). These frequencies are dependent on dimensions of the cooking vessel (e.g., thickness of metal, layering, angle of walls, height of walls, diameter, geometry, materials, etc.), such that different cooking vessels will have different patterns/combinations of resonance frequencies.

As one example, in a coil excitation or transmission mode, a returned signal is the electrical signal that corresponds to the detected mechanical vibration of the cooking vessel (and that is converted from the mechanical vibration of a listening transducer caused by the mechanical vibration of the cooking vessel in which the listening transducer is in contact). As one example, the resonant frequencies are identified as the probe frequencies at which peaks in amplitude in the spectra of the returned electrical signal are identified.

As another example, such as in an impedance mode, the returned signal that is evaluated is the impedance of the transducer. The spectrum of the transducer's impedance is evaluated, where probe frequencies at which drops in transducer impedance occur are identified as resonance frequencies of the cooking vessel.

Three example cooking vessel probing modes in which contact acoustics are utilized are described above.

In coil excitation mode, the induction heating coil is driven to excite the cooking vessel by inducing currents in the cooking vessel, which in turn causes mechanical vibrations of the cooking vessel.

In a transmission mode, a transmission transducer is driven to produce a transducer vibration, where the vibration of the transmission transducer (due to compression and expansion of a piezoelectric element) causes movement/vibrations in the cooking vessel that is in contact with the transmission transducer.

In coil mode and/or transmission mode, a separate listening transducer is used to perform pickup of the vibrations of the cooking vessel. The mechanical vibrations of the cooking vessel responsive to the excitation are picked up by a listening transducer, which generates an electrical signal corresponding to the picked up mechanical vibrations of the cooking vessel. A spectral analysis of the electrical signal is performed to identify resonant frequencies of the cooking vessel.

As one example, a frequency spectrum analysis is performed on the electrical signal to determine the amplitude/phase at various frequency components. For example, a frequency spectrum analysis is performed on the acoustic response to determine the amplitude/magnitude of individual frequency components in the acoustic response. For example, a Fast Fourier Transform (FFT) is performed to analyze individual frequency components. The frequencies at which peaks are present in the spectra are identified as the resonant frequencies of the cooking vessel.

In impedance mode, in which the same transducer is both transmitting the excitation signal and also picking up the induced mechanical vibrations from the cooking vessel, the impedance of the transducer is monitored as a function of frequency. The impedance of the transducer will vary based on how the cooking vessel interacts with the transducer (which is also exciting the cooking vessel). That is, the response (mechanical vibration) of the cooking vessel to the excitation in turn has an effect on the impedance of the transducer (that is being used to both perform the excitation and also pickup). For example, when the cooking vessel resonates with the excitation produced by the transducer (that is in contact with the cooking vessel), this is an effective reduction in mechanical load, where the cooking vessel is minimally resisting the ability of the piezoelectric transducer to be mechanically displaced given an electrical driving signal. This in turn corresponds to a drop in impedance of the transducer, which is frequency dependent. In some embodiments, the impedance of the transducer is monitored. Frequency spectrum analysis is performed on the monitored impedance. The frequency components for which drops or dips in transducer impedance are detected (e.g., relative to a baseline frequency response when the transducer is driven and not loaded by a cooking vessel) and are identified as the resonant frequencies of the cooking vessel. A signature for the cooking vessel is determined based on an encoding of whether a probed frequency is a resonant frequency or not, or an amount of resonance.

The type of the cooking vessel is detected can be used to facilitate various other types of processes, such as modulating cooking control, further embodiments of which are described above.

### Ingredient State/Stage Identification Based on Acoustic Sensing

Acoustic sensing can be used to facilitate the sensing of the state of content being cooked. As will be shown in the examples below, acoustic sensing may be used to detect browning, blackening, sauteing, etc. For example, over the course of cooking, different phenomena (e.g., browning, blackening, sauteing, etc.), as well as user interventions (e.g., adding of ingredients, flipping of spatula), will cause the cooking vessel to mechanically vibrate in various ways. In one embodiment, a listening contact acoustics transducer is coupled or otherwise in contact with the cooking vessel. The vibration of the cooking vessel in turn causes mechanical compression/expansion of the piezoelectric material of the transducer that is in contact with the cooking vessel, where the movement of the piezoelectric material is then converted into a corresponding electrical signal, whose acoustic spectra can be analyzed. In some embodiments, over the course of cooking, the acoustic spectra of the cooking vessel's behavior is monitored in real-time, and can be used to detect the state of the ingredients that are being cooked in a cooking vessel. For example, as will be described in further detail below, changes in amplitude of certain frequencies in the picked-up acoustic spectra are mapped or correlated to certain ingredient states, user interventions, etc.

In various embodiments, impedance reflectance spectra, acoustic emission spectra, acoustic response, mass changes, thermodynamic response, etc. are used to identify the condition of the cookware or its contents. The identification/detection of the state of the cookware and/or its contents can be performed through passive sound sensing. Active interrogation or probing via induction or acoustic excitation can also be used.

The following are embodiments of passive sound sensing of the state of ingredients or content being cooked. In some embodiments, passive acoustic sensing is used to detect the cooking state of food in a cooking vessel (e.g., pan, pot, etc.). For example, emitted sounds arise from the sound of water evaporation, and changing acoustic properties of the ingredients (including size, denaturation, browning, etc.). Such characteristics, if identified, facilitate the quantification of cooking state. The quantification and classification of cooking state can then be used to facilitate cooking intelligence, such as triggering of the cooking device described herein to adapt the applied cooking power to achieve a perfect final cooked state (e.g., caramelized onions, seared tuna with rare interior, perfect hard-crack sugar syrup, etc.).

Moreover, in various embodiments, the ability to automate cooking involves detection of when the user has conducted a specific operation or intervention (such as stirring). In some embodiments, if such an intervention is not detected at the appropriate time, then the heat can be reduced so as to ensure the food is not overcooked. One or a combination of the following can be used for ingredient state and user operation/intervention detection:
Air-coupled microphones/transducers that pick up atmospheric/environmental sounds, much like the human ear. Directional microphones can be used to reduce extraneous signals
Direct coupling of an acoustic transducer to the cooking vessel can be used to primarily pick up sounds coupled to the structure of the cooking vessel (e.g., contact acoustics, as described herein), and thus significantly improve signal to noise.
Use of back-EMF from the coil-cooking-vessel system can interrogate sounds which are integrated over the entire cooking vessel without the need for an additional sensor.

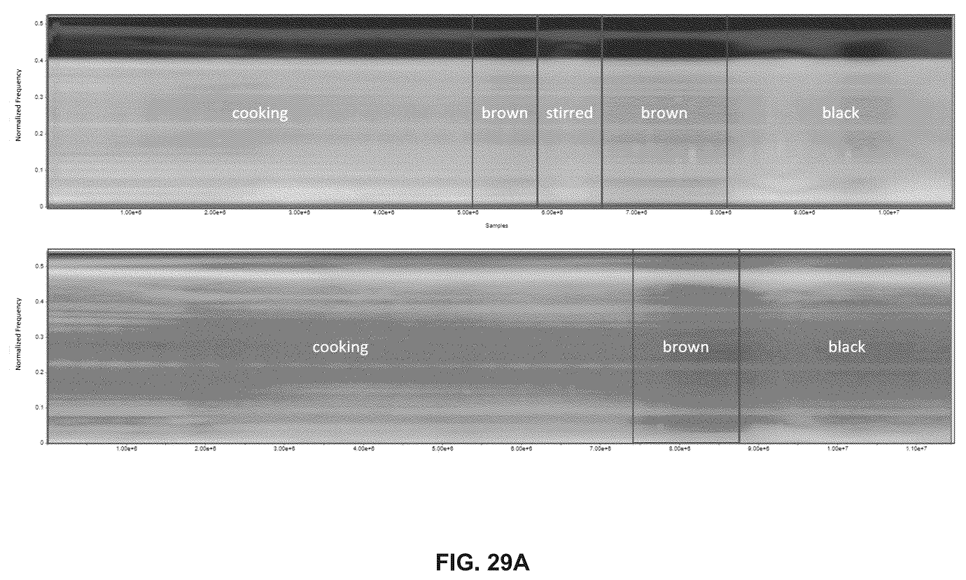

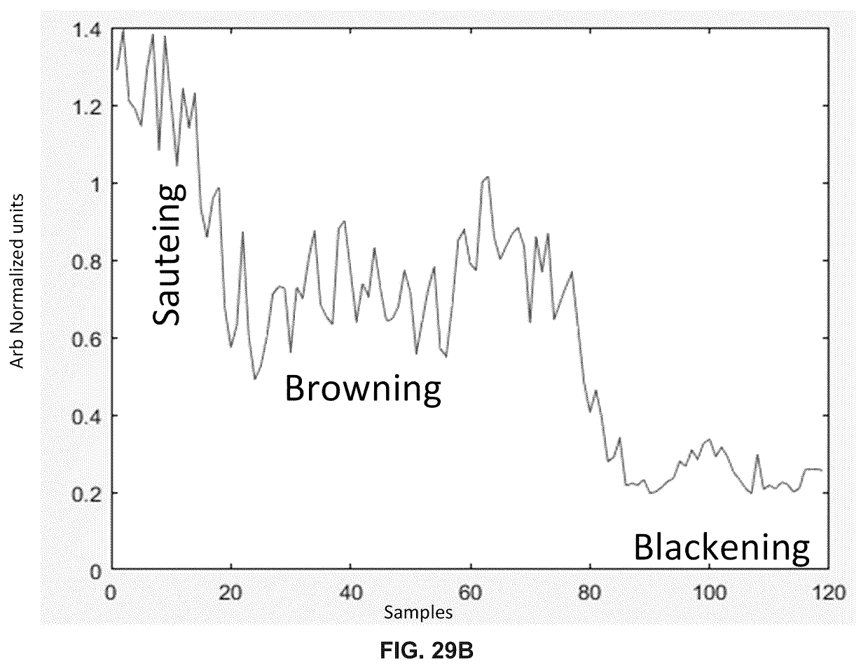

FIG. 29A illustrates an embodiment of passive sound sensing of the state of food being cooked in a cooking vessel. In this example, detection of various states of cooking of onions, as well as human interventions, are shown from analysis of the frequency response of cooking vessel signals detected by acoustic sensors. FIG. 29B illustrates an embodiment of passive sound sensing of the state of food being cooked in a cooking vessel. A signal or frequency of the sensed acoustic spectra at 10 kHz is shown in this example.

The following are further embodiments of ingredient state/cooking phase/user intervention detection using contact acoustics (e.g., acoustic transducer directly coupled to the cooking vessel). In some embodiments, the state of the ingredient will change over the course of the cooking process. The changes in the state of the ingredient are indicative of what phase of the cooking process the ingredient is in. For example, in the process of pan frying a protein such as chicken, the chicken (ingredient) will, over time, progress from becoming browned, and potentially to be being blackened. As another example, boiling of water in a pressure pot can be considered as a process in which water is an ingredient that is being cooked. The boiling process for water during pressure pot cooking has various stages as well, such as steam escaping, rolling boiling, etc.

In some embodiments, the contact transducer that is in contact with the cooking vessel detects or picks up mechanical vibrations of the cooking vessel and converts them into an output electrical signal that corresponds to the cooking vessel's mechanical vibrations (e.g., through the piezoelectric effect for a piezoelectric transducer, where the mechanical vibrations of the cooking vessel cause a mechanical displacement or mechanical stress on the piezoelectric material, which is converted into electricity (e.g., AC voltage and current signal)). In some embodiments, the electrical signal output by the transducer resulting from the mechanical stress on the transducer caused by the vibration/movement of the cooking vessel is analyzed. For example, a frequency spectrum analysis of the resulting electrical signal is performed. The amplitude/magnitude of certain select frequencies is evaluated or monitored over time (over the time of the cooking process). For example, changes in the amplitudes of certain frequencies are indicative of a cooking state or ingredient state being entered or left. As one example, consider browning. Browning is a consequence of the removal of water (due to heating) from an ingredient being cooked. When there is still water in an ingredient such as a protein (e.g., chicken), the presence of water prevents the temperature of the ingredient from increasing above a certain point (e.g., the boiling point of water). When a layer of water evaporates, the temperature of the ingredient will be able to rise, and the ingredient begins browning. That is, the evaporation or vaporization of water is indicative of the ingredient entering the browning stage. In some embodiments, this water vaporization phenomenon is acoustically detectable by monitoring an appropriate frequency. For example, when a sudden drop in amplitude at 5.5 kHz is detected, this is indicative that the layer of water vapor between the ingredient and the cooking vessel has evaporated (where the vaporization results in explosive effects that cause vibrations in the cooking vessel that are detected by the contact transducer), where the ingredient will then begin to brown.

Cooking processes can also involve user interventions, such as flipping of ingredients. In some embodiments, such user interventions are also identified from frequency analysis of sensed acoustic spectra. For example, the addition of an ingredient such as chicken will cause a sudden increase in amplitude at the 5.5 kHz frequency, due to the water in the ingredient interacting with the heated cooking vessel and vaporizing, where the explosions due to the vaporization are acoustically detectable. As described above, when the layer of water has vaporized more completely, the amplitude at that frequency will drop, indicating that browning is starting.

Changes or deltas in amplitude of other select frequencies are correlated and mapped or otherwise correspond to or are indicative of changes in ingredient state. The changes in amplitude/magnitude of such frequencies are measured/monitored over time. That is, different ingredient states are identifiable via unique acoustic signatures, where the acoustic signatures for ingredient states involve corresponding changes in amplitude of certain frequencies over the time of the cooking process. In some embodiments, the acoustic sensing system listens or monitors for (the sequence of) changes in magnitude of select frequencies. The changes in magnitude are used as flags or triggers to detect that a certain state of the ingredient, cooking process, or user intervention has been entered or occurred. In some embodiments, changes or deltas in the amplitude of monitored frequencies are measured. In some embodiments, the deltas are measured by tracking the magnitude or intensity over time as cooking progresses. The deltas can also be measured relative to a “clean” state of the pan. In some embodiments, baselines relative to which changes in amplitude are measured are updated (e.g., reset) in response to certain events occurring, such as turning on/off of the heating element while cooking, putting a lid or cover on the cooking vessel (which can result in condensation), etc.

Further embodiments of ingredient state and user intervention identification based on acoustic sensing are described below.

### Browning Level Detection

The following are embodiments of acoustic sensing for browning level detection. In some embodiments, and as described above, when detecting browning acoustically, a relevant or representative sound of browning is the evaporation or vaporization of water vapor that is in the ingredient (and that forms a layer between the ingredient being heated, and the cooking vessel surface that the ingredient is on). For example, browning is a result of removal of water. For example, a layer of water prevents the ingredient from heating beyond water's boiling point. When the water vapor is gone, the temperature of the ingredient will increase, and the ingredient will be able to brown. That is, there is a correlation between water vapor, amount of water, and the browning effect.

In some embodiments, the water vaporization can be tracked by tracking the magnitude or intensity of a particular corresponding frequency (e.g., 5.5 kHz). That is, by tracking the changes in magnitude of the 5.5 kHz component of the acoustic signal picked up by the transducer during cooking, water vaporization over time can be monitored, which in turn is indicative of browning level being detected. In some embodiments, by monitoring specific frequencies, such as the 5.5 kHz browning frequency, processing power is saved by not having to analyze the entire frequency spectrum of the signal generated by the transducer during listening (because many frequencies will not be relevant to detecting of ingredient state). Tracking of the state of water vapor is also efficient because all foods and ingredients contain some amount of water. By knowing the acoustic response with respect to water in various different forms, monitoring of browning or other effects can be performed for ingredients that contain water, which is a common element across most ingredients that are cooked.

One example way of determining and validating the 5.5 kHz frequency to monitor the effect of water vaporization is to wet a sponge, heat the wetted sponge, and analyze the spectrogram of what is detected by the contact transducer over time. For example, the various states of the water over time, such as sizzling and boiling are evaluated at 5.5 kHz to observe that changes in magnitude at that frequency over time correspond to the vaporization of the water in the sponge (which, for example, is otherwise inorganic).

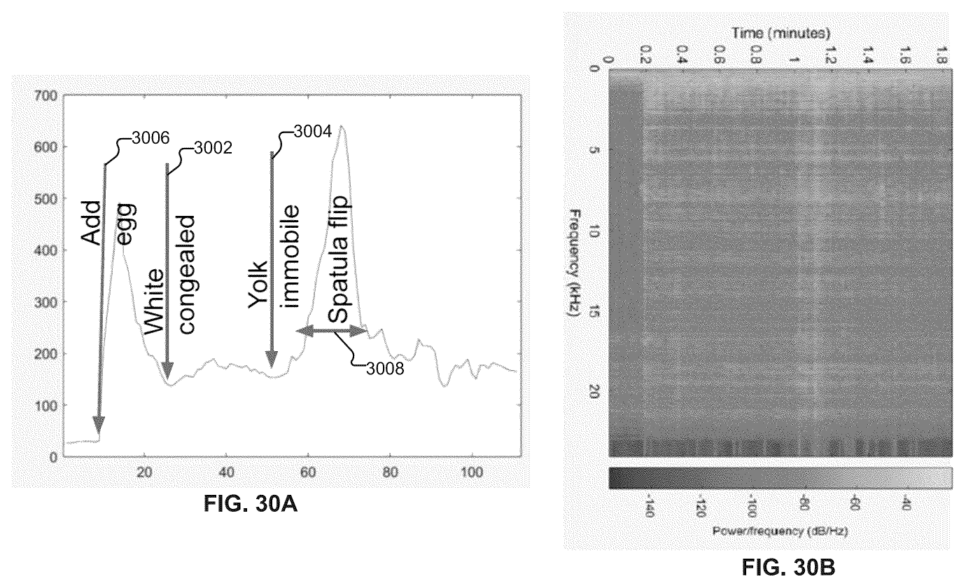

FIGS. 30A and 30B illustrate an embodiment of acoustics-based detecting of states of frying an egg. As shown in this example, eggs (ingredient) have a bimodal cooking behavior. For example, the egg sizzles initially. The white bottom surface congeals. There is a lower rumble corresponding to white thickness cooking. FIG. 30B illustrates an embodiment of a spectrogram of acoustic measurements over time when cooking an ingredient such as an egg. The spectrogram visually represents the spectrum of frequencies of the signal measured by the transducer, as it varies over time. FIG. 30A illustrates an embodiment of the amplitude or intensity of a particular select frequency over time. In this example, the amplitude of the 5.5 kHz frequency component over time is shown. As shown in this example, there are various peaks and valleys in the amplitude of the 5.5 kHz frequency component in the sensed acoustic measurements from the pickup transducer. The peaks and valleys in amplitude correspond to changes in magnitude of the frequency component over time. In this example, the peaks and valleys, over time, are indicative of different stages of frying an egg, including the state of the egg (e.g., white congealing (3002), immobile yolk (3004), etc.), as well as user interventions (e.g., adding the egg (3006), flipping a spatula (3008), etc.).

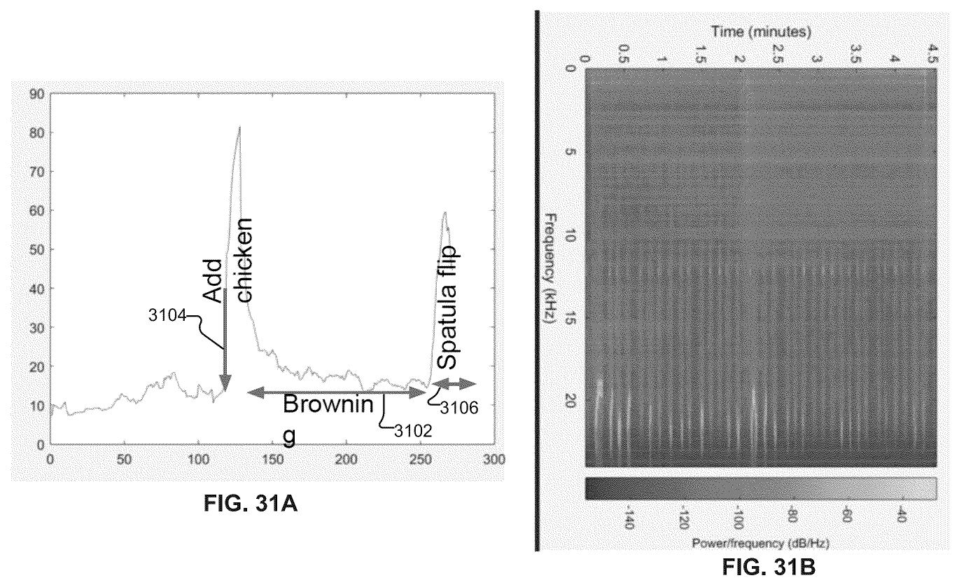

FIGS. 31A and 31B illustrate an embodiment of acoustics-based detecting of states of pan-frying chicken. FIG. 31A shows an example of the intensity of the 5.5 kHz frequency component over time. The 5.5 kHz frequency component is monitored over time, as changes in the 5.5 kHz component (which are a result of phenomena occurring with respect to the water in the chicken) correspond to changes in the state of the chicken. As shown in this example, chicken has exponential decay as water evaporates and the bottom of the chicken browns (3102). User interventions/events such as adding of the chicken (3104) and spatula flipping (3106) are also detected based on change in magnitude of the frequency component. FIG. 31B shows an example spectrogram over the course of the pan-frying of chicken.

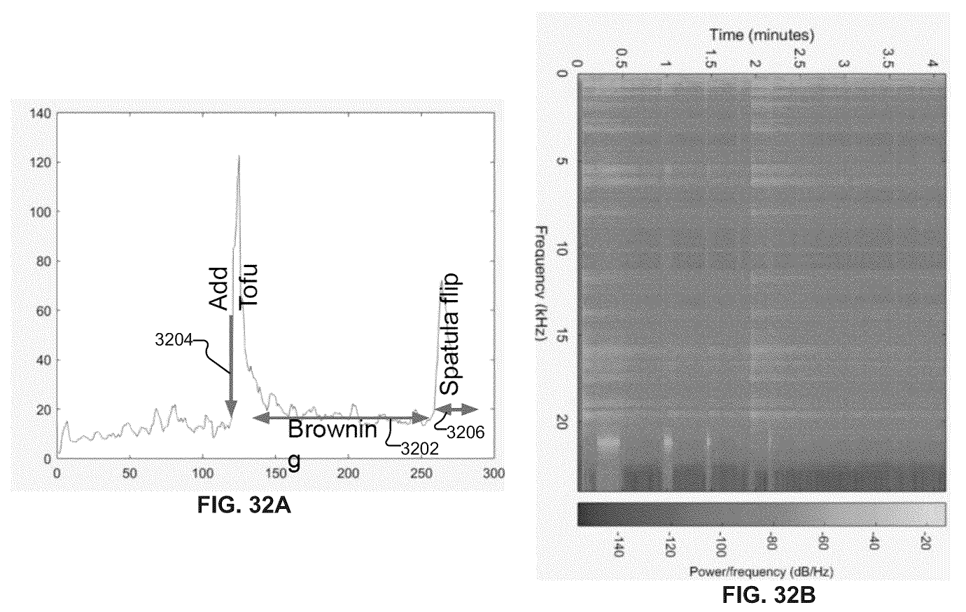

FIGS. 32A and 32B illustrate an embodiment of acoustics-based detecting of states of pan-frying tofu. FIG. 32A shows an example of the intensity of a select frequency component that is monitored over time to detect browning of the ingredient (tofu in this example). For example, the 5.5 kHz frequency is monitored. As shown in this example of FIG. 32A, pan-frying of tofu as a similar amplitude profile over time as pan-frying of chicken (as shown in the example of FIG. 31A). For example, tofu also has an exponential decay as water evaporates and the bottom of the tofu browns (3202). User interventions/events such as adding of the tofu (3204) and spatula flipping (3206) are also detected. A spectrogram of the process of pan-frying tofu is shown in the example of FIG. 32B.

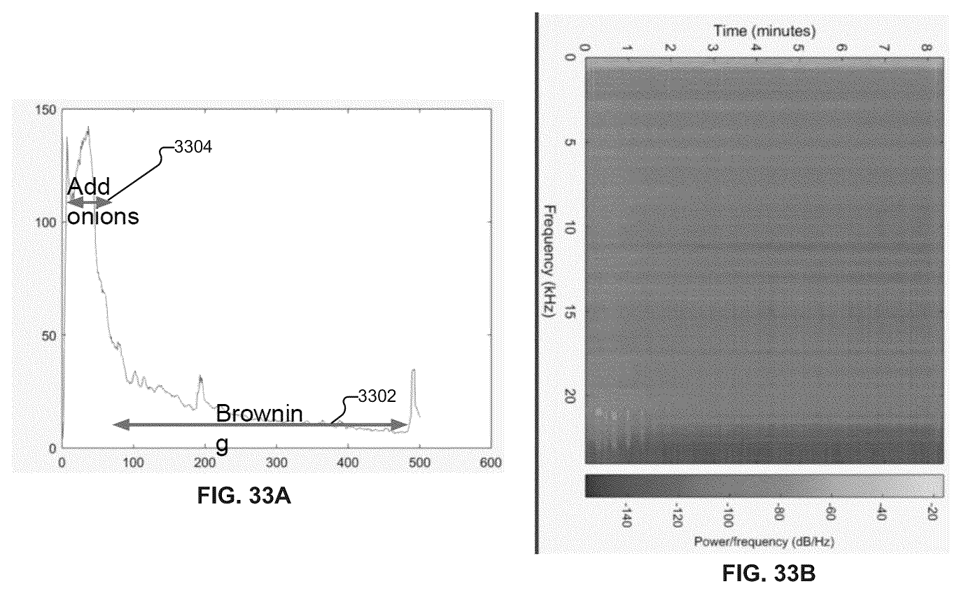

FIGS. 33A and 33B illustrate an embodiment of acoustics-based detecting of states of pan-frying onions. FIG. 33A shows an example of the intensity or magnitude of a select frequency component that is monitored over time to detect browning of the ingredient (onions in this example). For example, the 5.5 kHz frequency is monitored. While there are several “pops” or peaks in the amplitude of the 5.5 kHz component, corresponding to onions jumping on the pan, pan-frying of onions generally exhibits an exponential decay as water evaporates and the bottom browns (3302). A user intervention of adding the onions is also detected at 3304. A spectrogram of the process of pan-frying onions is shown in the example of FIG. 33B.

In some embodiments, control of the intelligent cooking system described herein can be adjusted based on the acoustics-based detection of browning level. For example, the induction coil or heating element can be controlled to control the temperature of the cooking vessel for browning.

In some embodiments, acoustics-based browning level detection is utilized to prevent undesired cooking outcomes, such as to prevent accidental overcooking. For example, suppose butter is to be melted, but it is not desired for the butter to brown. While temperature control can be used to ensure that the temperature of the cooking vessel (and/or the butter) does not exceed the temperature for melting, accidental browning can still be monitored for. If browning is acoustically detected, then the temperature can be reduced further to prevent further browning of the butter.

### Food Blackening Detection

In addition to monitoring the 5.5 kHz band to listen to water vapor as an indication of browning of ingredients, other frequencies correlated to or representative of other ingredient states can also be monitored. For example, the occurrence of blackening (and burning) of food when being heated is correlated with a low frequency, such as ˜500 Hz (0.5 kHz). For example, if the amplitude of the 0.5 kHz frequency of the acoustically sensed signal (that is generated in response to acoustically sensing the cooking vessel) increases, then this is indicative of the ingredient burning. For example, when food burns, a sort of “tar” is formed in the presence of fat and hydrocarbons burning at a certain temperature for too long. This results in a change in density of the ingredient that is in contact with the cooking vessel (or with a tar-like consistency, may attach to the pan, dampening its ability to vibrate), which in turn affects how the cooking vessel vibrates. This change in the cooking vessel vibration due to blackening corresponds to an increase in the amplitude of the lower frequency 0.5 kHz component detectable in the signal that is generated based on acoustic sensing. Thus, by monitoring different frequencies, browning and blackening can be acoustically distinguished and monitored for.

### Boiling Level Detection/Acoustic Signature of Pressure Pot Boil/Burn Detection

There are various types of boiling of water, such as slow simmering, simmering, rolling boil, etc. In some embodiments, changes in amplitude of specific frequency components of a measurement signal that is based on acoustic sensing of the cooking vessel are monitored to detect changes in magnitude over time that correlate to the various types of boiling.

As one example, changes in amplitude of the 400 Hz component of the acoustic measurement signal (e.g., generated by a contact transducer in direct contact with the are correlated with different types or stages or degrees of boiling.

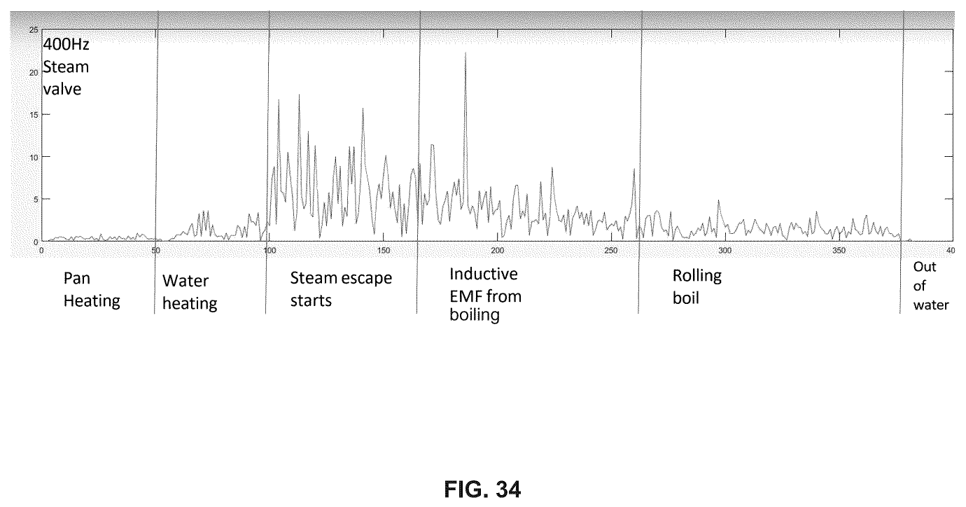

FIG. 34 illustrates an embodiment of detecting different stages of boiling via acoustic sensing. In this example, acoustic sensing of the process of water heating and boiling during pressure cooking is shown. In the context of pressure cooking, the pressure pot is closed by a lid. With the lid on, the contents of the pressure cooker cannot be directly observed. While the temperature of the pot or cooker can be measured from below (e.g., using the temperature probe in the center of the plate), the point at which pressure begins to build up can be difficult to determine from temperature alone, as the temperature is relatively constant. Also, whether pressure can build is based on whether the lid is properly closed, which is not always easily discernible.

Using the acoustic sensing described herein, acoustic signatures pertaining to pressure pot state can be detected. For example, when a pressure cooker is used, when the lid is closed and heating of water in the pot is occurring, steam will start to be generated. A valve allows the steam to escape. At some point, the valve will be closed, after which pressure within the pressure cooker will increase due to the steam building pressure. In some embodiments, closing of the valve is detected

In this example, an acoustic sensor is coupled to the pressure cooker. The contact transducer picks up vibrations from the pressure cooker that are felt by the transducer. The electrical signal converted from the mechanical stressing of the piezoelectric element caused by the vibration of the pressure cooker is evaluated in the frequency domain, where the magnitude of the 400 Hz frequency component of the electrical signal is monitored over time. In some embodiments, the sound of steam escaping is detected by evaluating a change in magnitude of the 400 Hz frequency component.

By providing the ability to detect different types of boiling, the intelligent cooking system also provides the ability to users to control or set how they would like their water to boil. For example, the induction coil can be controlled to regulate temperature to achieve and/or maintain a certain level of boiling based on the acoustically monitored boiling state.

In some embodiments, acoustic sensing is also used to detect burning in pressure cookers. For example, in pressure cookers, one potential issue is burning of the bottom of what is being cooked in the pot (e.g., burning of bottom of chili or porridge). In some embodiments, the logic for determining burning when in a pressure cooking mode includes data indicating what type of cooking phenomenon is expected to be occurring. For example, in a pressure-cooking mode, the intelligence system is configured to expect an acoustic signature that correlates to water boiling at a certain point in time or stage in the pressure cooking process. If water boiling is not detected from the acoustic measurements, then it is determined that burning or blackening is occurring instead. Automated remediation actions can then be taken (e.g., to reduce temperature, send an alert, etc.) This is one example application of being able to detect boiling stages of water (through the acoustic sensing described herein), where boiling state information is used to infer or determine what is occurring within the pressure cooker.

As shown in the examples above, the state of ingredients can be identified from detecting correlated or corresponding acoustic signatures in the spectra of what is acoustically sensed by a transducer that is coupled to a cooking vessel in which the ingredients are being cooked. This includes monitoring a set of frequencies, where changes in the amplitudes of the monitored frequencies over time are correlated or mapped to ingredient state, user interventions, etc. In the above examples, the intensity of specific frequency components at 400 Hz, 500 Hz, and 5.5 kHz were monitored over time to detect different types of ingredient states. In some embodiments, a band about monitored frequencies is passed for evaluation (e.g., 200 Hz band around a frequency component). In some embodiments, the selected individual frequency components/bands are extracted or isolated using an FFT. As another example, the detection circuit coupled to the transducer includes multiple receivers, each configured to detect one of the bands of interest (e.g., through the use of filters).

As described above, certain frequencies in the signal that is based on acoustic sensing are monitored for over time, where changes in magnitude of those frequencies are used as flags or triggers to indicate to the logic of the intelligent cooking system logic that a certain ingredient state has been detected or entered. In some embodiments, what frequencies to monitor for is determined based on cooking mode. Further, the type of event or classification of ingredient state that is to be monitored for/detected is based on the cooking mode.

As one example, a subset of the candidate/available frequencies that can be listened to is selected based on the cooking mode that is currently being utilized. Suppose, for example, that the system maintains mappings for five different bands, each corresponding to detection of a type of ingredient state and/or user intervention. Suppose that of the five, only three are relevant to pressure cooking. In this example, based on the cooking mode or technique that is selected, only the frequency bands that are relevant to the cooking mode are monitored. This provides more efficient performance (by reducing computational load), as not all possible bands need be monitored. For example, when in pan frying mode, the 5.5 kHz band is listened to for browning, and the 500 Hz band is listened to for blackening. When in pressure-cooker mode, the 400 Hz band is listened to (but the 5.5 kHz and 500 Hz bands need not be). In some embodiments, the type of ingredient state classifications that are made based on acoustic sensing are also based on the cooking mode. For example, the pan-frying mode is associated with a certain set of possible states, while the pressure-cooking mode is associated with its own respective set of possible states that is different from that of the pan-frying mode (e.g., pressure-cooking mode includes monitoring for rolling boil, which is not monitored for in pan-frying mode).

In some embodiments, frequencies of interest that are correlated to phase changes (of ingredients) are determined by performing a test type of cooking, acoustically monitoring the cooking over time with a contact transducer, and determining the spectrogram for the sensor readings/measurement signal from the contact transducer. The spectrogram plots intensity of frequency components in the spectra of the measured signal over time. Frequencies with changes in intensity or other activity in the frequency domain that correlate to phase changes in ingredients in time (e.g., via matching of timestamps between what is occurring in the spectra outputted by the contact acoustics sensor and what is observed over the course of cooking) are identified as frequencies of interest that are usable as signatures to determine ingredient state/phase changes. Analyses such as FFTs can then be performed to single out individual frequencies for further analysis and testing. In some embodiments, frequencies of interest are identified as those whose changes in magnitude correlate to sub-components that are common across or within a large number of ingredients. As described above, water is one such example. In some embodiments, water is subjected to various types of scenarios (e.g., pan frying, pressure cooking, hot plates, etc.), where the acoustic response of water under the various situations is characterized to identify signatures or features in the spectra of the acoustic response that correlate to ingredient state, cooking phenomena, etc.

Another example component contained in many ingredients is fat, which is common in many ingredients that are cooked. In some embodiments, the acoustic response of fat or other such sub-components is determined with respect to different types of cooking to identify those frequencies whose activity over time (e.g., changes in amplitude), if monitored, would be indicative of changes in the phase or state of fat (and thus some cooking effect or phenomena for an ingredient that includes fat).

While acoustic ingredient state detection has been described in the context of induction coil heating for illustrative purposes, in various embodiments the acoustic ingredient state detection techniques described herein may be variously adapted to accommodate other types of heating elements, such as gas stoves, electric stoves, ovens, etc. The techniques described herein for listening to the cooking of ingredients can be performed in various other contexts other than induction cooking, such as in an oven (e.g., radiative, convective from gas/electric/microwave, etc.). While acoustic sensing using contact transducers has been described herein for illustrative purposes, other types of acoustic sensors may be utilized. Air-coupled sensors may also be used to perform the ingredient state detection.

The measured acoustic spectra can be combined with other sensor measurements to further improve the classification of ingredient state. For example, sensor fusion can be used to integrate contact acoustics measurements, camera measurements, etc. to improve the fidelity of the estimation of ingredient state. As one example, weight and temperature measurements can be combined with acoustic sensor measurements to further improve the confidence of the ingredient state/phase determination. For example, suppose that the monitoring system is determining whether vigorous boiling is occurring or blackening is occurring. Vigorous boiling coincides with a large weight change, while blackening does not. If a weight change is determined to be occurring at the time of interest, then it is determined that it is more likely that vigorous boiling has occurred. That is, further sensor information can be used to augment the acoustic sensor measurements to identify the ingredient state.

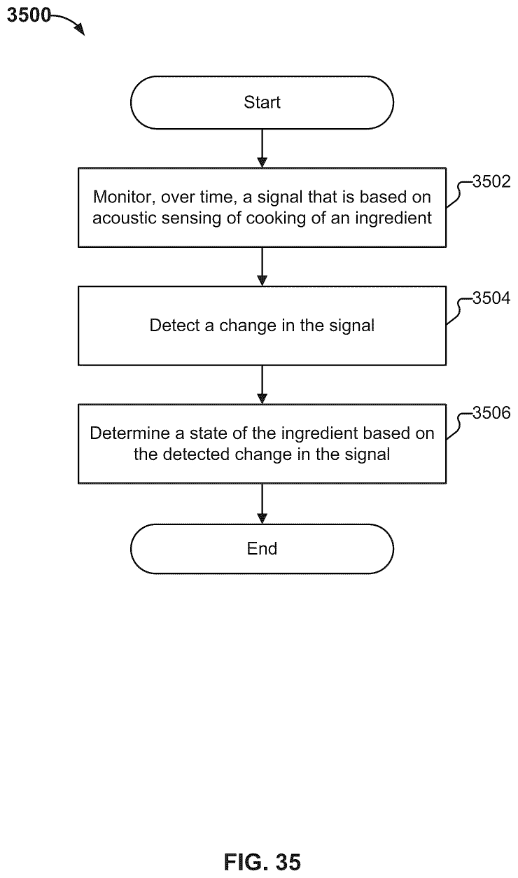

FIG. 35 is a flow diagram illustrating an embodiment of acoustically sensing ingredient state. In some embodiments, process 3500 is executed by ingredient state detection engine 2414. The process begins at 3502, when a signal that is based on acoustic sensing of cooking of an ingredient is monitored. For example, sounds or vibrations pertaining to cooking of an ingredient in a cooking vessel are acoustically sensed. As one example, an acoustic sensor in contact with the cooking vessel senses or picks up sounds or vibrations that are coupled to the structure of the cooking vessel. The acoustic sensor measurements are monitored over time. For example, a frequency is monitored over time with respect to cooking of an ingredient in a cooking vessel. In some embodiments, the spectrum of the acoustic vibrations (or the corresponding electrical signal that the acoustic vibrations are converted to via electromechanical conversion of the piezoelectric effect) over time are monitored. In some embodiments, select frequencies within the spectrum are monitored over time.

For example, a magnitude of a particular frequency is monitored over time. In some embodiments, the monitoring of the magnitude of the frequency is based on acoustic sensing of the movement (e.g., vibrations) of the cooking vessel when cooking the ingredient. For example, a piezoelectric transducer in contact with the cooking vessel is used to perform the acoustic sensing. The particular frequency that is monitored can be isolated as part of performing spectral analysis on the acoustic measurements. At 3504, a change in the monitored signal is detected. For example, a change in the magnitude or amplitude of a representative frequency (frequency whose behavior is correlated to states of the ingredient) is detected. At 3506, a state of the ingredient that is being cooked is determined based on the detected change in the signal (e.g., detected change in magnitude of the frequency being monitored).

The following are further embodiments of sound isolation. Multiplexing in the time domain and the frequency domain is described above. Parallel processing of bands and decomposition are also described above. The following are examples of mechanical techniques for sound isolation. For example, spatial location of transducers can capture nodal and anti-nodal vibration locations on the bottom of the cooking vessel. In other embodiments, mechanically tuned acoustic filters (which low or high-pass frequency filter the sounds/vibrations propagated to the sensor) are used, or mechanically/electrically tuned acoustic sensors are used, where the sensor's bandwidth narrower, and each sensor picks up a different band of frequency.

The above described examples of acoustics-based cooking intelligence facilitate various applications and benefits. One example benefit is improved heating control, such as based on improved characterization of a cooking vessel. For example, with such improved heating control, temperature overshoot can be reduced, and cooking temperature precision and accuracy can also be improved.

As another example benefit, improved cookware identification via acoustic sensing provides an improved user experience, such as by facilitating contextual digital user interfaces such as those described above (e.g., where the cooking system presents specific menu options, such as a cooking mode that is specific to the cookware that has been identified as being in use).

As another example benefit, the improved ingredient state detection based on the acoustic sensing described herein facilitates higher levels of cooking automation on specific cookware. As one example, automatic pressure cooking is facilitated with a specific stove top pressure cooker, in which the development of pressure in the pressure cooker can be sensed, potential burning of highly viscous ingredients can be sensed, etc. The improved accuracy of content state detection provided via embodiments of the acoustic sensing described herein further facilitates more intelligent guided cooking. For example, as shown above, the system can detect the current cooked stage of ingredients in the cookware (e.g., is burned, overcooked, optimally cooked, etc.).

As another example benefit, the acoustic sensing described herein does not require adding fragile components in the cookware (e.g., electronics in cookware such as electronic circuits, electronic identification tags, electronic sensors, etc.) that can degrade over time. By avoiding addition of such components, cookware lifetime can be extended, while still achieving similar performance with respect to cookware identification, ingredient state detection, and other forms of cooking intelligence.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A cookware identification system, comprising:
an excitation component configured to excite a cooking vessel;
a sensor configured to sense an acoustic response of the cooking vessel to the excitation; and
one or more processors configured to determine a type of the cooking vessel based at least in part on the acoustic response of the cooking vessel to the excitation that is sensed via the sensor.

2. The cookware identification system of claim 1, wherein the sensor comprises an acoustic transducer.

3. The cookware identification system of claim 1, wherein the sensor is in contact with the cooking vessel.

4. The cookware identification system of claim 1, wherein the excitation component comprises an induction coil.

5. The cookware identification system of claim 1, wherein the excitation component comprises a piezoelectric transducer.

6. The cookware identification system of claim 1, wherein determining the type of the cooking vessel comprises determining a signature of the cooking vessel from an acoustic spectrum.

7. The cookware identification system of claim 1, wherein determining the type of the cooking vessel comprises determining a signature of the cooking vessel from an impedance spectrum.

8. The cookware identification system of claim 1, wherein the excitation causes vibration of the cooking vessel that is sensed by the sensor.

9. The cookware identification system of claim 1, wherein the excitation component is configured to excite the cooking vessel at a set of probe frequencies.

10. A method for cookware identification, comprising:
exciting a cooking vessel using an excitation component;
sensing an acoustic response of the cooking vessel to the excitation using a sensor; and
determining a type of the cooking vessel based at least in part on the acoustic response of the cooking vessel to the excitation that is sensed via the sensor.

11. An ingredient state detection system, comprising:
an acoustic sensor configured to sense vibrations pertaining to cooking of an ingredient in a cooking vessel; and
one or more processors configured to:
monitor, over time, a signal that is based on the vibrations sensed by the acoustic sensor; and
based on detecting a change in the signal that is based on the vibrations sensed by the acoustic sensor, determine a state of the ingredient.

12. The ingredient state detection system of claim 11, wherein the acoustic sensor is in contact with the cooking vessel.

13. The ingredient state detection system of claim 11, wherein the acoustic sensor comprises a piezoelectric transducer.

14. The ingredient state detection system of claim 11, wherein the monitoring comprises monitoring one or more frequencies of the signal over time.

15. The ingredient state detection system of claim 14, wherein an ingredient state is determined in response to detecting a change in amplitude of a frequency.

16. The ingredient state detection system of claim 14, wherein browning of the ingredient is determined based on detecting a change in amplitude of a first frequency.

17. The ingredient state detection system of claim 14, wherein blackening of the ingredient is determined based on detecting a change in amplitude of a second frequency.

18. The ingredient state detection system of claim 14, wherein the one or more frequencies comprise a subset of frequencies that are selected for monitoring monitored.

19. The ingredient state detection system of claim 18, wherein the subset of frequencies is selected based on a mode of cooking being performed.

20. A method for ingredient state detection, comprising:
sensing, using an acoustic sensor, vibrations pertaining to cooking of an ingredient in a cooking vessel;
monitoring, over time, a signal that is based on the vibrations sensed by the acoustic sensor; and
based on detecting a change in the signal that is based on the vibrations sensed by the acoustic sensor, determining a state of the ingredient.
